(19) United States
(12) Patent Application Publication
(10) Pub. No.: US 2021/0136407 A1
(43) Pub. Date: May 6, 2021

(54) VIDEO CODING APPARATUS AND VIDEO DECODING APPARATUS

(71) Applicant: SHARP KABUSHIKI KAISHA, Sakai City, Osaka (JP)

(72) Inventors: TOMOKO AONO, Sakai City, Osaka (JP); TOMOHIRO IKAI, Sakai City, Osaka (JP); TAKESHI CHUJOH, Sakai City, Osaka (JP)

(21) Appl. No.: 16/757,236

(22) PCT Filed: Oct. 15, 2018
(86) PCT No.: PCT/JP2018/038362

§ 371 Date: Apr. 17, 2020

(30) Foreign Application Priority Data
Oct. 20, 2017 (JP) 2017-203697

(51) Int. Cl. H04N 19/563; H04N 19/57

(52) U.S. Cl. CPC H04N 19/563; H04N 19/57

(57) ABSTRACT

A slice or a tile can be decoded in a single picture, without reference to information outside of a target slice or outside of a target tile. However, there are problems in that in order to decode some regions of a video in a sequence, the entire video needs to be reconstructed, and in that the slice and the tile coexist in the single picture, and the slices include an independent slice and dependent slice, causing the coding structure to be complex. In the present invention, a flag indicating whether a shape of a slice is rectangular or not is decoded, and in a case that the flag indicates that the shape of the slice is rectangular, a position and a size of the slice that is rectangular are not changed in a period of time of referring to a same SPS. The slice that is rectangular is decoded independently without reference to information of another slice. As described above, introducing the slice that is rectangular instead of the tile can simplify the coding structure that is complex.

### TECHNICAL FIELD

The embodiments of the present invention relate to a video decoding apparatus and a video coding apparatus.

### BACKGROUND ART

A video coding apparatus (image coding apparatus) which generates coded data by coding a video, and a video decoding apparatus (image decoding apparatus) which generates decoded images by decoding the coded data are used to transmit or record a video efficiently.

For example, specific video coding schemes include schemes proposed in H.264/AVC and High-Efficiency Video Coding (HEVC).

In such a video coding scheme, images (pictures) constituting a video are managed by a hierarchy structure including slices obtained by partitioning images, Coding Tree Units (CTUs) obtained by partitioning slices, coding units (also sometimes referred to as Coding Units (CUs)) obtained by partitioning coding tree units, and Prediction Units (PUs) which are blocks obtained by partitioning coding units, and Transform Units (TUs), and are coded/decoded for each CU.

In such a video coding scheme, usually, prediction images are generated based on local decoded images obtained by coding/decoding input images, and prediction residuals (also sometimes referred to as “difference images” or “residual images”) obtained by subtracting the prediction images from the input images (original images) are coded. Examples of generation methods of prediction images include an inter-picture prediction (an inter prediction) and an intra-picture prediction (an intra prediction) (NPL 1).

In recent years, with the evolution of processors such as a multi-core CPU and a GPU, configurations and algorithms that are easy to perform parallel processing have been employed in video coding and decoding processing. As an example of a configuration that is easy to be parallel, a picture partitioning unit of a slice (Slice) and a tile (Slice) has been introduced. A slice is a set of multiple continuous CTUs, with no constraints on shape. A tile is different from a slice and is a rectangular region into which a picture is partitioned. In both, in a single picture, a slice or a tile is decoded without reference to information (a prediction mode, an MV, a pixel value) outside of the slice or outside of the tile. Therefore, a slice or a tile can be decoded independently in a single picture (NPL 2). However, for a slice or a tile, in a case of referring to a different picture (a reference picture) that has been already decoded, for an inter prediction, the information (a prediction mode, an MV, a pixel value) to which a target slice or a target tile refers on a reference picture is not always information of the same position as the target slice or the target tile on the reference picture, so the entire video is required to be regenerated even in a case of regenerating only some regions of the video (one slice or tile, or a limited number of slices or tiles).

In addition, in recent years, high resolution of videos has been advanced, which is represented by 4K, 8K, or VR, or videos that take up the 360 degree omnidirectional orientation such as 360 degree video. In a case of viewing these images by a smartphone or a Head Mount Display (HMD), a portion of the high resolution video is cut out and displayed on the display. In a smartphone or an HMD, the capacity of the battery is not large, so a mechanism is expected to be able to view the video with minimal decoding processing, with some regions necessary for display being extracted.

### CITATION LIST

### Non Patent Literature

NPL 1: “Algorithm Description of Joint Exploration Test Model 6”, JVET-F1001, Joint Video Exploration Team (JVET) of ITU-T SG 16 WP 3 and ISO/IEC JTC 1/SC 29/WG 11, 31 March-April 2017
NPL 2: ITU-T H.265 (April/2015) SERIES H: AUDIOVISUAL AND MULTIMEDIA SYSTEMS Infrastructure of audiovisual services—Coding of moving video High efficiency video coding

### SUMMARY OF INVENTION

### Technical Problem

Meanwhile, a slice and a tile coexist in a single picture, and there is a case that the slice is further partitioned into tiles and a CTU is included in a tile of the tiles, or a case that the tile is further partitioned into slices and a CTU is included in a slice of the slices. The slices further include an independent slice and a dependent slice, causing the coding structure to be complex.

The slice and the tile have a common advantage and disadvantage, except that they differ in shape. For example, decoding can be performed in parallel without reference to information outside of a target slice or outside of a target tile in the single picture, but there is a problem in that the entire video needs to be reconstructed to decode some regions of the video (one slice or tile, or a limited number of slices or tiles) as a sequence.

There is also a problem in that the code amount of intra pictures required for random access is very large.

There is also a problem in that only the tile requested from an application or the like cannot be extracted with reference only to a NAL unit header.

Therefore, the present invention has been made in view of the above problems, and an object thereof is to introduce a rectangular slice including the slice and the tile put together to simplify the coding structure. This reduces unnecessary information related to a slice boundary or the like.

The present invention provides a mechanism for ensuring independent decoding of the rectangular slice or a set of the rectangular slices in the spatial direction and the temporal direction while suppressing a decrease of the coding efficiency.

The present invention reduces the maximum code amount per picture by differently configuring an intra picture insertion timing or period of the slice that can independently be decoded for each slice sequence. By signalling the insertion period as coded data, random access is facilitated.

The present invention facilitates the bitstream of independent slices by providing an extended region in a NAL unit header and signalling a slice identifier SliceId.

### Solution to Problem

A video coding apparatus according to an aspect of the present invention includes: in coding of slices into which a picture is partitioned, a first coder unit configured to code a sequence parameter set including information related to multiple pictures, a second coder unit configured to code information indicating a position and a size of a slice on the picture; a third coder unit configured to code the picture in slice units, and a fourth coder unit configured to code a NAL header unit, wherein the first coder unit codes a flag indicating whether a shape of a slice is rectangular or not, a position and a size of rectangular slices with a same slice ID is not changed in a period of time in which each picture refers to a same sequence parameter set in a case that the flag indicates that a shape of a slice is rectangular, and the rectangular slices are coded independently without reference to information of other slices within a picture and without reference to information of other rectangular slices among pictures.

A video decoding apparatus according to an aspect of the present invention includes: in decoding of slices into which a picture is partitioned, a first decoder unit configured to decode a sequence parameter set including information related to multiple pictures; a second decoder unit configured to decode information indicating a position and a size of a slice on the picture; a third decoder unit configured to decode the picture in slice units, and a fourth decoder unit configured to decode a NAL header unit, wherein the first decoder unit decodes a flag indicating whether a shape of a slice is rectangular or not, a position and a size of rectangular slices with a same slice ID is not changed in a period of time in which each picture refers to a same sequence parameter set in a case that the flag indicates that a shape of a slice is rectangular, and the rectangular slices are decoded without reference to information of other slices within a picture and without reference to information of other rectangular slices among pictures.

### Advantageous Effects of Invention

According to an aspect of the invention, a scheme is introduced that simplifies the hierarchy structure of coded data and also ensures independence of coding and decoding of each rectangular slice for each individual tool. Accordingly, each rectangular slice can be independently coded and decoded while suppressing a decrease in the coding efficiency. By controlling the intra insertion timing, the maximum code amount per picture can be reduced and the processing load can be suppressed. As a result, the region required for display or the like can be selected and decoded, so that the amount of processing can be greatly reduced.

### BRIEF DESCRIPTION OF DRAWINGS

FIG. 1 is a schematic diagram illustrating a configuration of an image transmission system according to the present embodiment.

FIG. 2 is a diagram illustrating a hierarchy structure of data of a coding stream according to the present embodiment.

FIG. 3 is a conceptual diagram illustrating an example of reference pictures and reference picture lists.

FIG. 4 is a diagram illustrating general slices and rectangular slices.

FIG. 5 is a diagram illustrating shapes of rectangular slices.

FIG. 6 is a diagram illustrating a rectangular slice.

FIG. 7 is a syntax table related to rectangular slice information and the like.

FIG. 8 is a diagram illustrating a syntax of a general slice header.

FIG. 9 is a syntax table related to insertion of an I slice.

FIG. 10 is a diagram illustrating reference of rectangular slices in the temporal direction.

FIG. 11 is a diagram illustrating a syntax of a rectangular slice header.

FIG. 12 is a diagram illustrating a temporal hierarchy structure.

FIG. 13 is a diagram illustrating an insertion interval of an I slice.

FIG. 14 is another diagram illustrating an insertion interval of an I slice.

FIG. 15 is a block diagram illustrating configurations of a video coding apparatus and a video decoding apparatus according to the present invention.

FIG. 16 is a flowchart illustrating operations related to an insertion of an I slice.

FIG. 17 is a syntax table related to a NAL unit and a NAL unit header.

FIG. 18 is a diagram illustrating a configuration of a slice decoder according to the present embodiment.

FIG. 19 is a diagram illustrating intra prediction modes.

FIG. 20 is a diagram illustrating rectangular slice boundaries and a positional relationship between a target block and a reference block.

FIG. 21 is a diagram illustrating a prediction target block and an unfiltered/filtered reference image.

FIG. 22 is a block diagram illustrating a configuration of an intra prediction image generation unit.

FIG. 23 is a diagram illustrating a CCLM prediction process.

FIG. 24 is a block diagram illustrating a configuration of a LM predictor.

FIG. 25 is a diagram illustrating a boundary filter.

FIG. 26 is a diagram illustrating reference pixels of a boundary filter at a rectangular slice boundary.

FIG. 27 is another diagram illustrating a boundary filter.

FIG. 28 is a diagram illustrating a configuration of an inter prediction parameter decoder according to the present embodiment.

FIG. 29 is a diagram illustrating a configuration of a merge prediction parameter derivation unit according to the present embodiment.

FIG. 30 is a diagram illustrating an ATMVP process.

FIG. 31 is a diagram illustrating a prediction vector candidate list (merge candidate list).

FIG. 32 is a flowchart illustrating operations of the ATMVP process.

FIG. 33 is a diagram illustrating an STMVP process.

FIG. 34 is a flowchart illustrating operations of the STMVP process.

FIG. 35 is a diagram illustrating an example of positions of blocks referred to for derivation of a motion vector of a control point in an affine prediction.

FIG. 36 is a diagram illustrating a motion vector spMvLX [xi][yi] for each of subblocks constituting a PU, which is a target for predicting a motion vector.

FIG. 37 is a flowchart illustrating operations of the affine prediction.

FIG. 38 is a diagram for describing Bilateral matching and Template matching. (a) is a diagram for describing Bilateral matching. (b) and (c) are diagrams for describing Template matching.

FIG. 39 is a flowchart illustrating operations of a motion vector derivation process in a matching mode.

FIG. 40 is a diagram illustrating a search range of a target block.

FIG. 41 is a diagram illustrating an example of a target subblock and an adjacent block of OBMC prediction.

FIG. 42 is a flowchart illustrating a parameter derivation process of OBMC prediction.

FIG. 43 is a diagram illustrating a bilateral template matching process.

FIG. 44 is a diagram illustrating a configuration of an AMVP prediction parameter derivation unit according to the present embodiment.

FIG. 45 is a diagram illustrating an example of pixels used for derivation of a prediction parameter of LIC prediction.

FIG. 46 is a diagram illustrating a configuration of an inter prediction image generation unit according to the present embodiment.

FIG. 47 is a block diagram illustrating a configuration of a slice coder according to the present embodiment.

FIG. 48 is a schematic diagram illustrating a configuration of an inter prediction parameter coder according to the present embodiment.

FIG. 49 is a diagram illustrating configurations of a transmitting apparatus equipped with a video coding apparatus and a receiving apparatus equipped with a video decoding apparatus according to the present embodiment. (a) illustrates the transmitting apparatus equipped with the video coding apparatus, and (b) illustrates the receiving apparatus equipped with the video decoding apparatus.

FIG. 50 is a diagram illustrating configurations of a recording apparatus equipped with the video coding apparatus and a regeneration apparatus equipped with the video decoding apparatus according to the present embodiment. (a) illustrates the recording apparatus equipped with the video coding apparatus, and (b) illustrates the regeneration apparatus equipped with the video decoding apparatus.

### DESCRIPTION OF EMBODIMENTS

### First Embodiment

Hereinafter, embodiments of the present invention are described with reference to the drawings.

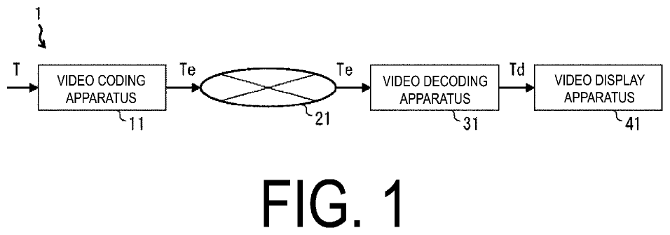

FIG. 1 is a schematic diagram illustrating a configuration of an image transmission system 1 according to the present embodiment.

The image transmission system 1 is a system configured to transmit a coding stream of a coding target image that has been coded, decode the transmitted codes, and display an image. The image transmission system 1 includes a video coding apparatus (image coding apparatus) 11, a network 21, a video decoding apparatus (image decoding apparatus) 31, and a video display apparatus (image display apparatus) 41.

The video coding apparatus 11 codes an input image T and outputs the coded input image T to the network 21.

The network 21 transmits a coding stream Te generated by the video coding apparatus 11 to the video decoding apparatus 31. The network 21 is the Internet (internet), a Wide Area Network (WAN), a Local Area Network (LAN), or combinations thereof. The network 21 is not necessarily a bidirectional communication network, but may be a unidirectional communication network configured to transmit broadcast wave such as digital terrestrial television broadcasting and satellite broadcasting. The network 21 may be substituted by a storage medium that records the coding stream Te, such as a Digital Versatile Disc (DVD) and a Blue-ray Disc (BD: trade name).

The video decoding apparatus 31 decodes each of the coding streams Te transmitted by the network 21, and generates one or multiple decoded images Td.

The video display apparatus 41 displays all or part of one or multiple decoded images Td generated by the video decoding apparatus 31. For example, the video display apparatus 41 includes a display device such as a liquid crystal display and an organic Electro-luminescence (EL) display. Configurations of the display include stationary, mobile, and HMD.

### Operator

Operators used herein will be described below.

>> is a right bit shift, << is a left bi tshift, & is a bitwise AND, | is a bitwise OR, and |= is an OR assignment operator.

x ? y:z is a ternary operator to take y in a case that x is true (other than 0), and take z in a case that x is false (0).

Clip3 (a, b, c) is a function to clip c in a value equal to or greater than a and equal to or less than b, and is a function to return a in a case that c is less than a (c<a), return b in a case that c is greater than b (c>b), and return c otherwise (however, a is equal to or less than b (a<=b)).

abs (a) is a function to return an absolute value of a.

Int (a) is a function to return an integer value of a.

floor (a) is a function to return a maximum integer of a or less.

a/d represents the division of a by d (rounding off decimal point).

a % b is the remainder of a.

### Structure of Coding Stream Te

Prior to the detailed description of the video coding apparatus 11 and the video decoding apparatus 31 according to the present embodiment, the data structure of the coding stream Te generated by the video coding apparatus 11 and decoded by the video decoding apparatus 31 will be described.

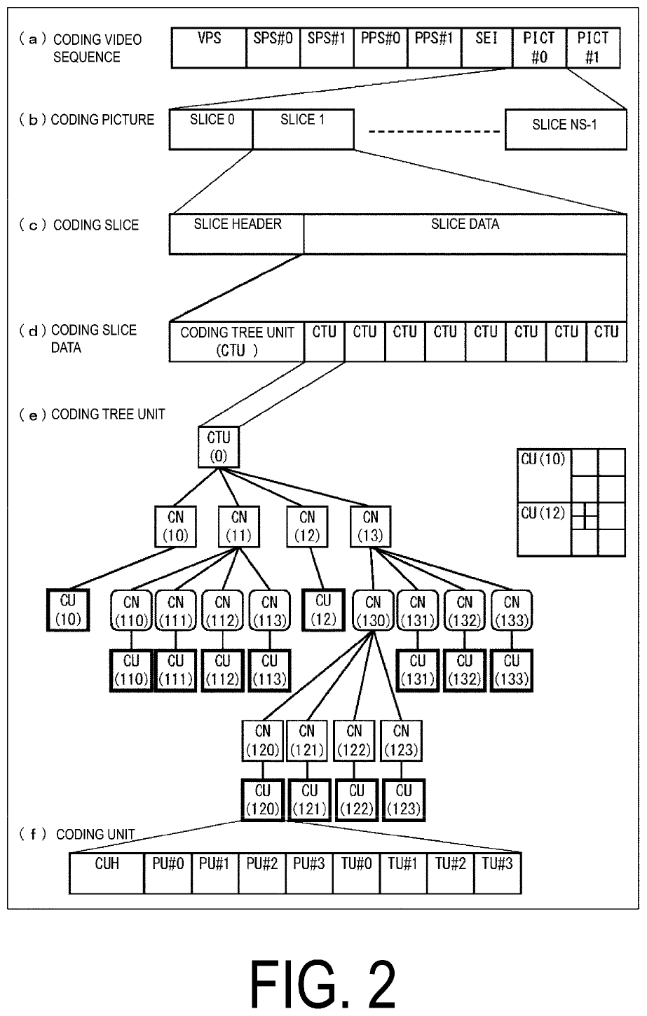

FIG. 2 is a diagram illustrating the hierarchy structure of data in the coding stream Te. The coding stream Te includes a sequence and multiple pictures constituting a sequence illustratively. (a) to (f) of FIG. 2 are diagrams indicating a coding video sequence prescribing a sequence SEQ, a coding picture prescribing a picture PICT, a coding slice prescribing a slice S, a coding slice data prescribing slice data, a coding tree unit included in the coding slice data, and Coding Units (CUs) included in the coding tree unit, respectively.

### Coding Video Sequence

In the coding video sequence, a set of data referred to by the video decoding apparatus 31 to decode a sequence SEQ of a processing target is prescribed. As illustrated in (a) of FIG. 2, the sequence SEQ includes a Video Parameter Set VPS, a Sequence Parameter Set SPS, a Picture Parameter Set PPS, a picture PICT, and Supplemental Enhancement Information SEI. Here, the numbers after # indicate the numbers of the parameter sets or the pictures.

In the video parameter set VPS, in a video including multiple layers, a set of coding parameters common to multiple videos and a set of coding parameters associated with multiple layers and individual layers included in a video are prescribed.

In the sequence parameter set SPS, a set of coding parameters referred to by the video decoding apparatus 31 to decode a target sequence is prescribed. For example, the width and the height of a picture are prescribed. Note that multiple SPSs may exist. In that case, any of multiple SPSs is selected from PPSs.

In the picture parameter set PPS, a set of coding parameters referred to by the video decoding apparatus 31 to decode each picture in a target sequence is prescribed. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each slice header in a target sequence.

### Coding Picture

In the coding picture, a set of data referred to by the video decoding apparatus 31 to decode the picture PICT of a processing target is prescribed. As illustrated in (b) of FIG. 2, the picture PICT includes slices S0 to S_{NS-1} (NS is the total number of slices included in the picture PICT). Slices include rectangular slices having a rectangular shape and general slices with no constraint on shape, and there is only one type of them in one coding sequence. Details will be described below.

Note that in a case that it is not necessary to distinguish the slices S0 to S_{NS-1}, subscripts of reference signs may be omitted and described below. The same applies to other data included in the coding stream Te described below and described with an added subscript.

### Coding Slice

In the coding slice, a set of data referred to by the video decoding apparatus 31 to decode the slice S of a processing target is prescribed. As illustrated in (c) of FIG. 2, the slice S includes a slice header SH and a slice data SDATA.

The slice header SH includes a coding parameter group referred to by the video decoding apparatus 31 to determine a decoding method of a target slice. Slice type specification information (slice_type) to specify a slice type is one example of a coding parameter included in the slice header SH.

Examples of slice types that can be specified by the slice type specification information include (1) an I (intra) slice using only an intra prediction in coding, (2) a P slice using a unidirectional prediction or an intra prediction in coding, and (3) a B slice using a unidirectional prediction, a bidirectional prediction, or an intra prediction in coding, and the like. Note that an inter prediction is not limited to a uni-prediction or a bi-prediction, and a greater number of reference pictures may be used to generate a prediction image. Hereinafter, in a case of being referred to as a P or B slice, such slice refers to a slice that includes a block that may employ an inter prediction.

Note that, the slice header SH may include a reference (pic_parameter_set_id) to the picture parameter set PPS included in the coding video sequence.

### Coding Slice Data

In the coding slice data, a set of data referred to by the video decoding apparatus 31 to decode the slice data SDATA of a processing target is prescribed. As illustrated in (d) of FIG. 2, the slice data SDATA includes Coding Tree Units (CTUs, CTU blocks). Such CTU is a block of a fixed size (for example, 64×64) constituting a slice, and may be referred to as a Largest Coding Unit (LCU).

### Coding Tree Unit

In (e) of FIG. 2, a set of data referred to by the video decoding apparatus 31 to decode a coding tree unit of a processing target is prescribed. A coding tree unit is partitioned by recursive quad tree partitioning (QT partitioning) or binary tree partitioning (BT partitioning) into Coding Units (CUs), each of which is a basic unit of coding processing. A tree structure obtained by recursive quad tree partitioning or binary tree partitioning is referred to as a Coding Tree (CT), and nodes of a tree structure are referred to as Coding Nodes (CNs). Intermediate nodes of a quad tree or a binary tree are coding nodes, and the coding tree unit itself is also prescribed as the highest coding node.

### Coding Unit

As illustrated in (f) of FIG. 2, a set of data referred to by the video decoding apparatus 31 to decode a coding unit of a processing target is prescribed. Specifically, the coding unit includes a prediction tree, a transform tree, and a CU header CUH. In the CU header, a prediction mode, a partitioning method (a PU partitioning mode), and the like are prescribed.

In the prediction tree, a prediction parameter (a reference picture index, a motion vector, and the like) of each prediction unit (PU) where the coding unit is partitioned into one or multiple is prescribed. In another expression, the prediction units are one or multiple non-overlapping regions constituting the coding unit. The prediction tree includes one or multiple prediction units obtained by the above-mentioned partitioning. Note that, in the following, a unit of prediction where the prediction unit is further partitioned is referred to as a “subblock”. The subblock includes multiple pixels. In a case that the sizes of the prediction unit and the subblock are the same, there is one subblock in the prediction unit. In a case that the prediction unit is larger than the size of the subblock, the prediction unit is partitioned into subblocks. For example, in a case that the prediction unit is 8×8, and the subblock is 4×4, the prediction unit is partitioned into four subblocks formed by horizontal partitioning into two and vertical partitioning into two.

The prediction processing may be performed for each of these prediction units (subblocks).

Generally speaking, there are two types of predictions in the prediction tree, including a case of an intra prediction and a case of an inter prediction. The intra prediction is a prediction in the same picture, and the inter prediction refers to a prediction processing performed between mutually different pictures (for example, between display times).

In a case of an intra prediction, the partitioning method includes 2N×2N (the same size as the coding unit) and N×N.

In a case of an inter prediction, the partitioning method is coded by a PU partitioning mode (part_mode) of the coded data.

In the transform tree, the coding unit is partitioned into one or multiple transform units TUs, and a position and a size of each transform unit are prescribed. In another expression, the transform units are one or multiple non-overlapping regions constituting the coding unit. The transform tree includes one or multiple transform units obtained by the above-mentioned partitioning.

Partitioning in the transform tree include those to allocate a region that is the same size as the coding unit as a transform unit, and those by recursive quad tree partitioning similar to the above-mentioned partitioning of CUs.

A transform processing is performed for each of these transform units.

### Prediction Parameter

A prediction image of Prediction Units (PUs) is derived by a prediction parameter attached to the PUs. The prediction parameter includes a prediction parameter of an intra prediction or a prediction parameter of an inter prediction. The prediction parameter of an inter prediction (inter prediction parameters) will be described below. The inter prediction parameter is constituted by prediction list utilization flags predFlagL0 and predFlagL1, reference picture indexes refIdxL0 and refIdxL1, and motion vectors mvL0 and mvL1. The prediction list utilization flags predFlagL0 and predFlagL1 are flags to indicate whether or not reference picture lists referred to as L0 list and L1 list respectively are used, and a corresponding reference picture list is used in a case that the value is 1. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive an inter prediction parameter included in a coded data include a PU partitioning mode part_mode, a merge flag merge_flag, a merge index merge_idx, an inter prediction indicator inter_pred_idc, a reference picture index ref_idx_lX (refIdxLX), a prediction vector index mvp_lX_idx, and a difference vector mvdLX.

### Reference Picture List

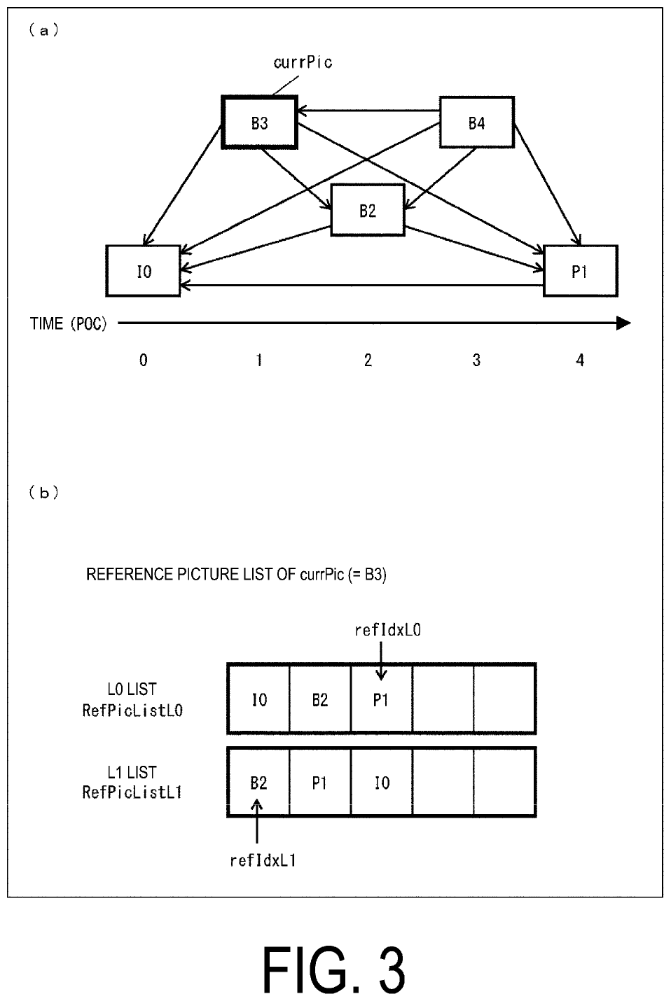

A reference picture list is a list constituted by reference pictures stored in a reference picture memory 306. FIG. 3 is a conceptual diagram illustrating an example of reference pictures and reference picture lists. In FIG. 3(a), a rectangle indicates a picture, an arrow indicates a reference relationship of pictures, a horizontal axis indicates time, each of I, P, and B in the rectangle indicates an intra picture, a uni-prediction picture, and a bi-prediction picture, and the number in the rectangle indicates a decoding order. As illustrated, the decoding order of the pictures is I0, P1, B2, B3, and B4, and the display order is I0, B3, B2, B4, and P1. FIG. 3(b) illustrates an example of reference picture lists. The reference picture list is a list to represent a candidate of a reference picture, and one picture (slice) may include one or more reference picture lists. In the illustrated example, a target picture B3 includes two reference picture lists, i.e., a L0 list RefPicList0 and a L1 list RefPicList1. In a case that a target picture is B3, the reference pictures are 10, P1, and B2, the reference pictures includes these pictures as elements. For an individual prediction unit, which picture in a reference picture list RefPicListX (X=0 or 1) is actually referred to is specified with a reference picture index refIdxLX. The diagram indicates an example where reference pictures P1 and B2 are referred to by refIdxL0 and refIdxL1. Note that LX is a description method used in a case of not distinguishing the L0 prediction and the L1 prediction, and hereinafter parameters for the L0 list and parameters for the L1 list are distinguished by replacing LX with L0 or L1.

Merge Prediction and AMVP Prediction Decoding (coding) methods of a prediction parameter include a merge prediction (merge) mode and an Adaptive Motion Vector Prediction (AMVP) mode, and the merge flag merge_flag is a flag to identify these. The merge mode is a mode to use to derive from a prediction parameter of a neighbor PU that has been already processed, without including a prediction list utilization flag predFlagLX (or an inter prediction indicator inter_pred_idc), a reference picture index refIdxLX, and a motion vector mvLX in a coded data. The AMVP mode is a mode to include an inter prediction indicator inter_pred_idc, a reference picture index refIdxLX, and a motion vector mvLX in a coded data. Note that, the motion vector mvLX is coded as a prediction vector index mvp_lX_idx identifying a prediction vector mvpLX and a difference vector mvdLX.

The inter prediction indicator inter_pred_idc is a value indicating types and the number of reference pictures, and takes any value of PRED_L0, PRED_L1, and PRED_B1. PRED_L0 and PRED_L1 indicate to uses reference pictures managed in the reference picture list of the L0 list and the L1 list respectively, and indicate to use one reference picture (uni-prediction). PRED_B1 indicates to use two reference pictures (bi-prediction BiPred), and use reference pictures managed in the L0 list and the L1 list. The prediction vector index mvp_lX_idx is an index indicating a prediction vector, and the reference picture index refIdxLX is an index indicating a reference picture managed in a reference picture list.

The merge index merge_idx is an index to indicate to use which prediction parameter as a prediction parameter of a decoding target PU among prediction parameter candidates (merge candidates) that have been derived from PUs of which the processing has been completed.

### Motion Vector

The motion vector mvLX indicates a gap (shift) quantity between blocks in two different pictures. A prediction vector and a difference vector related to the motion vector mvLX is referred to as a prediction vector mvpLX and a difference vector mvdLX respectively.

### Intra Prediction

Next, intra prediction parameters will be described.

The intra prediction parameters are parameters used for a prediction process of a CU with the information in the picture, for example, is an intra prediction mode IntraPredMode, and a luminance intra prediction mode IntraPredModeY and a chrominance intra prediction mode IntraPredModeC may be different from each other. There are 67 types of intra prediction modes, for example, and include a planar prediction, a DC prediction, an Angular (direction) prediction. The chrominance prediction mode IntraPredModeC uses, for example, any of a planar prediction, a DC prediction, an Angular prediction, a direct mode (a mode in which a prediction mode for luminance is used), and an LM prediction (a mode of linearly predicting from a luminance pixel).

The luminance intra prediction mode IntraPredModeY include a case of deriving by using a Most Probable Mode (MPM) candidate list consisting of intra prediction modes estimated to have a high probability of being applied to the target block, or a case of deriving from an REM, which is a prediction mode not included in the MPM candidate list. Which method is used is signalled with the flag prev_intra_luma_pred_flag, and in the former case, an index mpm_idx and an MPM candidate list derived from an intra prediction mode of an adjacent block is used to derive IntraPredModeY. In the latter case, an intra prediction mode is derived by using the flag rem_selected_mode_flag and the modes rem_selected_mode and rem_non_selected_mode.

The chrominance intra prediction mode IntraPredModeC includes a case of deriving by using the flag not_lm_chroma_flag for indicating whether or not to use an LM prediction, a case of deriving by using the flag not_dm_chroma_flag for indicating whether or not to use a direct mode, or a case of deriving by using the index chroma_intra_mode_idx for directly specifying the intra prediction mode applied to the chrominance pixel.

### Loop Filter

A loop filter is a filter provided in the coding loop, and is a filter to remove block distortion or ringing distortion to improve image quality. The loop filter primarily includes a deblocking filter, a Sample Adaptive Offset (SAO), and an Adaptive Loop Filter (ALF).

The deblocking filter performs image smoothing in the vicinity of a block boundary by performing a deblocking process on the pixels of the luminance and the chrominance components for the block boundary, in a case that a difference in pre-deblock pixel values of pixels of luminance components adjacent to each other over the block boundary is less than a predetermined threshold value.

The SAO is a filter that is applied after a deblocking filter, and has the effect of removing ringing distortion and quantization distortion. The SAO is a process in a CTU unit, and is a filter that classifies pixel values into several categories to add or subtract an offset to or from the pixel value in a pixel unit for each category. An edge offset (EO) processing of the SAO determines a offset value to add to a pixel value in accordance with the magnitude relationship between a target pixel and an adjacent pixel (a reference pixel).

The ALF generates a post-ALF decoded image by applying an adaptive filter process to a pre-ALF decoded image by using an ALF parameter (a filter coefficient) decoded from the coding stream Te.

The filter coefficients are signalled immediately after the slice header and stored in the memory. For a slice or a picture using a subsequent inter prediction, other than signalling filter coefficients itself, filter coefficients that have been signalled in the past and stored in the memory are specified by the index to reduce the amount of bits required to code the filter coefficients by not signalling the filter coefficient themselves. For each rectangular slice described below, an adaptive filter process may be performed by using filter coefficients specified by the index in a subsequent rectangular slice with the same SliceId (slice_pic_parameter_set_id).

Entropy Coding Entropy coding includes a scheme of performing variable length coding to a syntax by using context (probability model) that is adaptively selected depending on the type of the syntax or the surrounding situation, and a scheme for performing variable length coding to the syntax by using a predetermined table or a calculation equation. In the former Context Adaptive Binary Arithmetic Coding (CABAC), an updated probability model for each coded or decoded picture is stored in the memory. Then, for a P picture or a B picture using a subsequent inter prediction, the initial state of the context of a target picture is used for a coding or decoding process by selecting a probability model of a picture using a quantization parameter of the same slice type or the same slice level among the probability models stored in the memory. For each rectangular slice, the probability model may be stored in the memory in a rectangular slice unit. Then, for a subsequent rectangular slice with the same SliceId, the initial state of the context may select the probability model of a decoded rectangular slice with a quantization parameter of the same slice type or the same slice level.

### Rectangular Slice

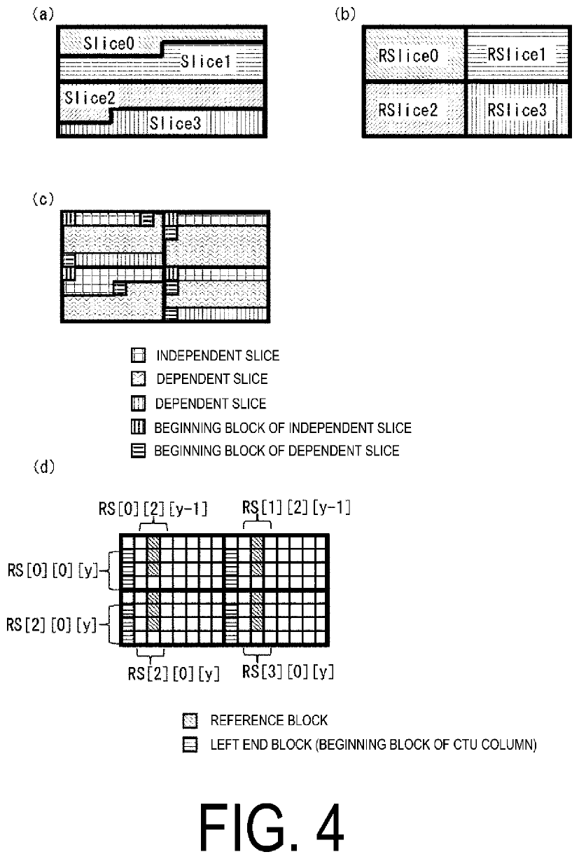

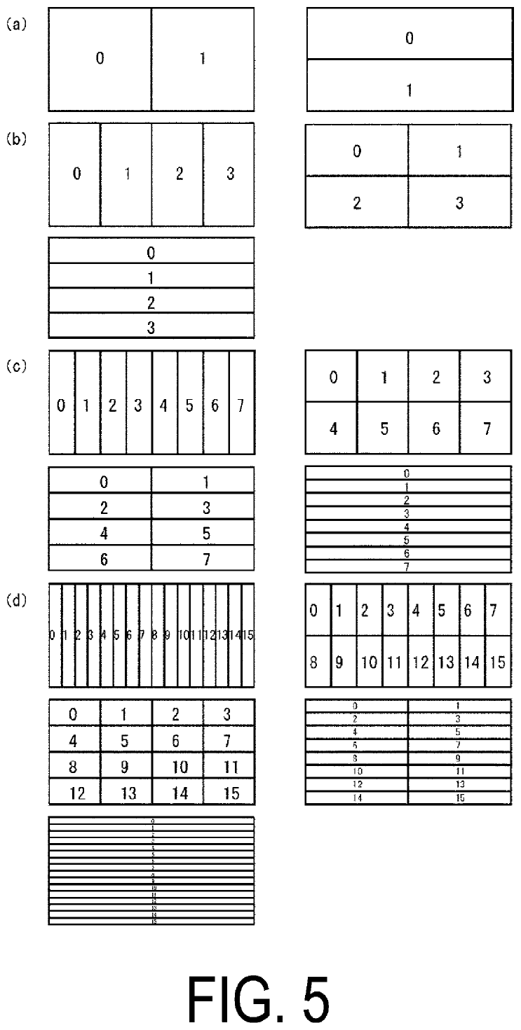

There are two types of slices including rectangular slices in which a picture is partitioned into rectangles as illustrated in FIG. 4(b), and general slices that have no constraints on shape as illustrated in FIG. 4(a). FIG. 4 is an example of partitioning one picture into four slices. FIG. 5 is an example of partitioning a picture into various numbers of rectangular slices. FIG. 5(a) is an example in which a picture is partitioned horizontally and vertically into two regions. FIG. 5(b) is an example in which a picture is partitioned into four regions in the horizontal direction, in the shape of a two-by-two grid (2×2 partitioning), and the vertical direction. FIG. 5(c) is an example in which a picture is partitioned into eight regions in the horizontal direction, in the shape of a two-by-two grid (4×2 partitioning and 2×4 partitioning), and in the vertical direction. FIG. 5(d) is an example in which a picture is partitioned into 16 regions in the horizontal direction, in the shape of a two-by-two grid (8×2 partitioning, 4×4 partitioning, and 2×8 partitioning), and in the vertical direction. The numbers in the rectangular slices are SliceIds. In the following, the rectangular slices will be described in detail.

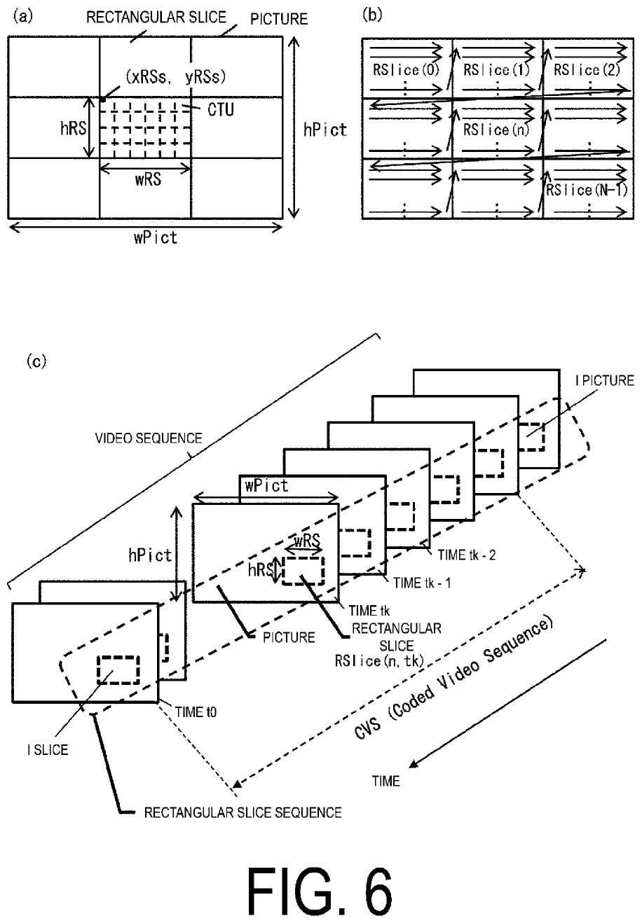

FIG. 6(a) is a diagram illustrating an example of partitioning a picture into N rectangular slices (rectangles of solid lines, the diagram is an example of N=9). The rectangular slices are further partitioned into multiple CTUs (rectangles of dashed lines). The upper left coordinate of the central rectangular slice of FIG. 6(a) is denoted as (xRSs, yRSs), with wRS as the width and hRS as the height. The width and the height of the picture are denoted as wPict and hPict. Note that information related to the number of partitioning and the size of the rectangular slice is referred to as rectangular slice information, and the details will be described later.

FIG. 6(b) is a diagram illustrating the coding or decoding order of CTUs in a case of the picture partitioned into rectangular slices. The numbers in ( ) set forth in each rectangular slice are SliceIds (the identifiers of the rectangular slices in the picture), which are assigned in the raster scan order from the upper left to the lower right for the rectangular slices in the picture, and the rectangular slices are processed in the order of SliceId. In other words, the coding or decoding process is performed in the ascending order of SliceId. The CTUs are processed in the raster scan order from the upper left to the lower right in each rectangular slice, and after processing in one rectangular slice is finished, CTUs in the next rectangular slice is processed.

In a general slice, the CTUs are processed in the raster scan order from the upper left to the lower right of the picture, so that the processing order of CTUs is different in a rectangular slice and a general slice.

FIG. 6(c) is a diagram illustrating continuous rectangular slices in the temporal direction. As illustrated in FIG. 6(c), the video sequence is comprised of multiple continuous pictures in the temporal direction. The rectangular slice sequence is comprised of rectangular slices of one or more times continuous in the temporal direction. Note that a Coded Video Sequence (CVS) in the diagram is a group of pictures from a picture that refers to a certain SPS to a picture immediately prior to a picture that refers to a different SPS.

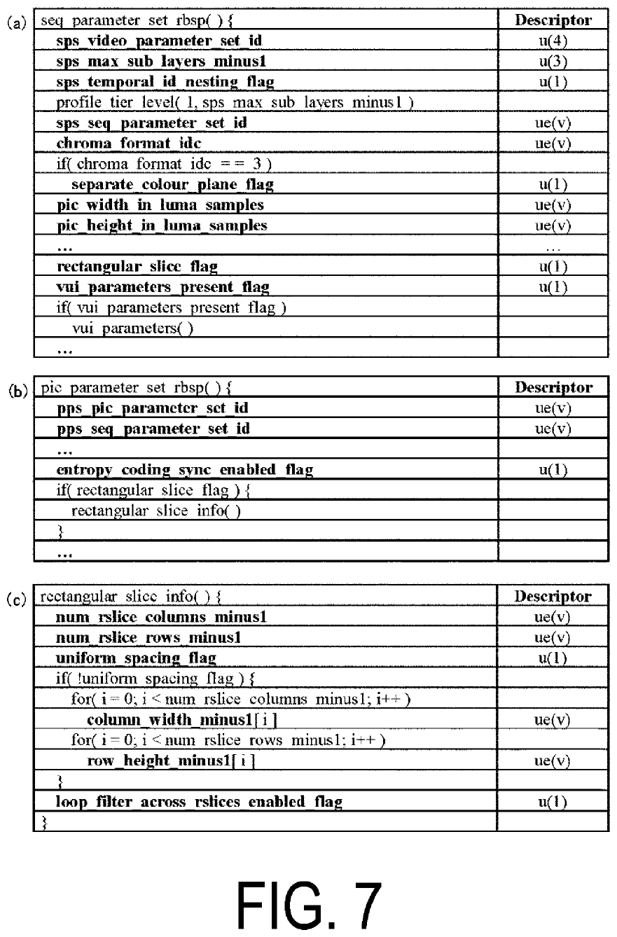

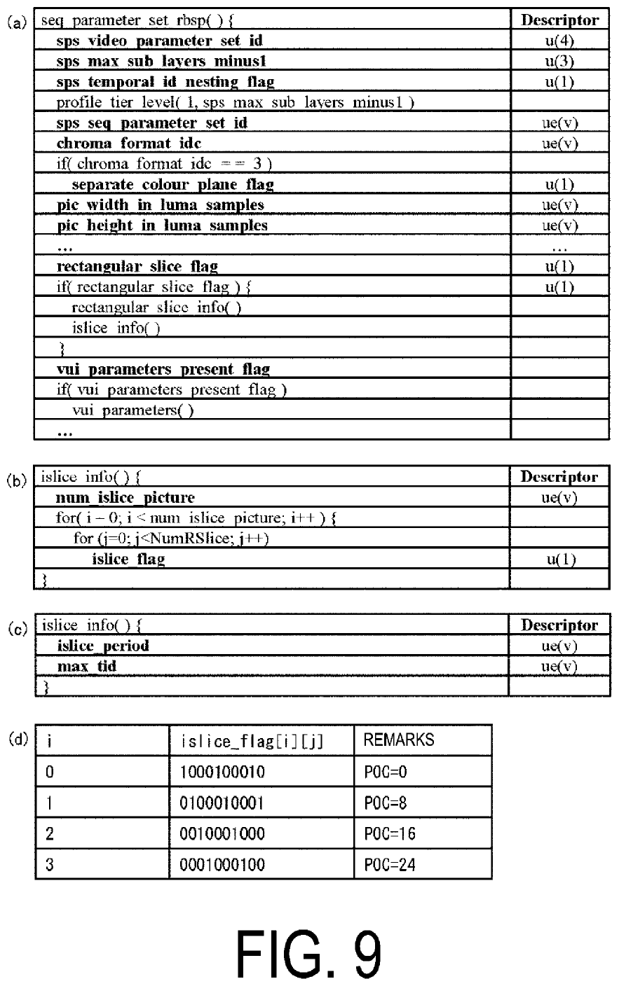

FIG. 7 and FIG. 9 are examples of the syntax related to the rectangular slices.

The rectangular slice information may be represented by num_rslice_columns_minus1, num_rslice_rows_minus1, uniform_spacing_flag, column_width_minus1 [ ], row_height_minus1 [ ], for example, as illustrated in FIG. 7(c), and is signalled with rectangular_slice_info ( ) of a PPS, for example, as illustrated in FIG. 7(b). Alternatively, as illustrated in FIG. 9(a), rectangular_slice_info ( ) may be signalled by a SPS. Here, num_rslice_columns_minus1 and num_rslice_rows_minus1 are values obtained by subtracting 1 from the number of rectangular slices in the horizontal and vertical directions in the picture, respectively. uniform_spacing_flag is a flag for indicating whether or not the picture is evenly partitioned into rectangular slices. In a case that the value of uniform_spacing_flag is 1, the width and the height of each rectangular slice of the picture are configured to be the same and may be derived from the number of rectangular slices in the horizontal and vertical directions in the picture.

wRS=wPict/(num_rslice_columns_minus1+1)

hRS=hPict/(num_rslice_rows_minus1+1) (Equation RSLICE-1)

In a case that the value of uniform_spacing_flag is 0, the width and the height of each rectangular slice of the picture may not be configured to be the same, and the width column_width_minus1 [i] in a CTU unit and the height row_height_minus1 [i] in a CTU unit of each rectangular slice are coded for each rectangular slice.

wRS=(column_width_minus1[i]+1)<<CtbLog2SizeY

hRS=(row_height_minus1[i]+1)<<CtbLog2SizeY (Equation RSLICE-2)

### Rectangular Slice Boundary Limitation

A rectangular slice is signalled by setting the value of rectangular_slice_flag of seq_parameter_set_rbsp ( ) illustrated in FIG. 7(a) to 1. In this case, in a case that the rectangular slice information does not change throughout the CVS, that is, in a case that the value of rectangular_slice_flag is 1, the value of num_rslice_columns_minus1, num_rslice_rows_minus1, uniform_spacing_flag, column_width_minus1 [ ], row_height_minus1 [ ], loop_filter_across_rslices_enabled_flag (on or off of the loop filter at the rectangular slice boundary) signalled with a PPS is the same throughout the CVS. In other words, in the case that the value of rectangular_slice_flag is 1, in a CVS, for rectangular slices with the same SliceId, the rectangular slice position (the upper left coordinate, the width, and the height of the rectangular slice) on a picture is not changed even in pictures where the display orders (Picture Order Count (POC)) are different. In a case that the value of rectangular_slice_flag is 0, that is, in a case of a general slice, the rectangular slice information is not signalled (FIG. 7(b) and FIG. 9(a)).

FIG. 7(a) is a syntax table that extracts a part of the sequence parameter set SPS. The rectangular slice flag rectangular_slice_flag is a flag for indicating whether or not it is a rectangular slice as described above, as well as for indicating whether or not the sequence to which the rectangular slice belongs can be independently coded or decoded in the temporal direction in addition to in the spatial direction. In a case that the value of rectangular_slice_flag is 1, it means that the rectangular slice sequence can be coded or decoded independently. In this case, the following constraints may be imposed on the coding or decoding of the rectangular slice and the syntax of the coded data.

(Constraint 1) The rectangular slice does not refer to information of a rectangular slice with a different SliceId.

(Constraint 2) The number of rectangular slices in the horizontal and vertical directions, the width of the rectangular slices, and the height of the rectangular slices in the pictures signalled by a PPS are the same throughout the CVS. Within the CVS, the rectangular slices with the same SliceId do not change the rectangular slice position (the upper left coordinate, the width, and the height) of the rectangular slice on the pictures, even in pictures with different display orders (POC).

The above (Constraint 1) “the rectangular slice does not refer to information of a rectangular slice with a different SliceId” will be described in detail.

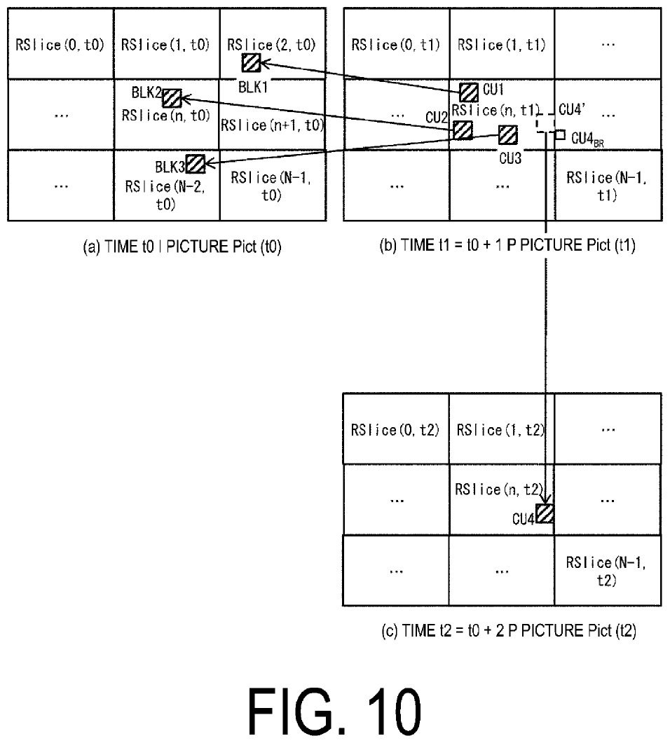

FIG. 10 is a diagram illustrating a reference to a rectangular slice in a temporal direction (between different pictures). FIG. 10(a) is an example of partitioning an intra picture Pict (t0) at time t0 into N rectangular slices. FIG. 10(b) is an example of partitioning an inter picture Pict (t) at time t1=t0+1 into N rectangular slices. Pict (t1) refers to Pict (t0). FIG. 10(c) is an example of partitioning an inter picture Pict (t2) at time t2=t0+2 into N rectangular slices. Pict (t2) refers to Pict (t1). In the diagram, RSlice (n, t) represents a rectangular slice with SliceId=n (n=0 . . . N−1) at time t. From (Constraint 2) described above, at any time, the upper left coordinate, the width, and the height of the rectangular slices with SliceId=n are the same.

In FIG. 10(b), CU1, CU2, and CU3 in the rectangular slice RSlice (n, t1) refer to blocks BLK1, BLK2, and BLK3 of FIG. 10(a). RSlice (n, t1) represents a rectangular slice with SliceId=n at time t1. In this case, BLK1 and BLK3 are blocks that are included in rectangular slices different from the rectangular slice RSlice (n, t0), and thus to refer to these requires not only RSlice (n, t0) but also decoding the entire Pict (t0) at time t0. That is, decoding the rectangular slice sequence corresponding to SliceId=n at times t0 and t1 is not enough to decode the rectangular slice RSlice (n, t1), and in addition to SliceId=n, decoding of rectangular slice sequences other than SliceId=n is also necessary. Thus, in order to independently decode a rectangular slice sequence, reference pixels in a reference picture referred to in motion compensation image derivation of CUs in the rectangular slice is required to be included in a collocated rectangular slice (a rectangular slice at the same position on the reference picture).

In FIG. 10(c), CU4 adjacent to the boundary of the right end of the rectangular slice RSlice (n, t2) refers to a lower right block CU4BR of CU4′ (the block indicated by the dashed line) in the picture at time t1 illustrated in FIG. 10(b) as a prediction vector candidate in the temporal direction, and the motion vector of CU4BR is stored as a prediction vector candidate in a prediction vector candidate list (a merge candidate list). However, in a CU on the right end of the rectangular slice, CU4BR is located outside of the collocated rectangular slice, so that to refer to CU4BR requires decoding of not only RSlice (n, t1) but also at least RSlice (n+1, t1) at time t1. That is, the rectangular slice RSlice (n, t2) cannot be decoded by simply decoding the rectangular slice sequence of SliceId=n. Thus, in order to independently decode the rectangular slice sequence, a block on a reference picture referred to as a prediction vector candidate in the temporal direction needs to be included in a collocated rectangular slice. A specific implementation method of the above-described constraints will be described in the following video decoding apparatus and video coding apparatus.

In a case that the value of rectangular_slice_flag is 0, it means that the slice is not a rectangular slice, and may not be able to be independently decoded in the temporal direction.

### Configuration of Slice Header

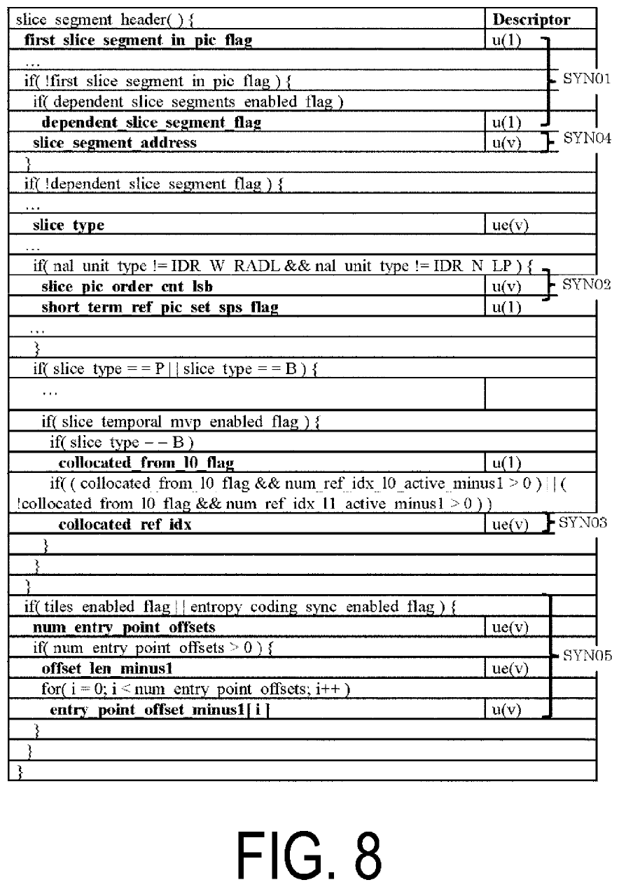

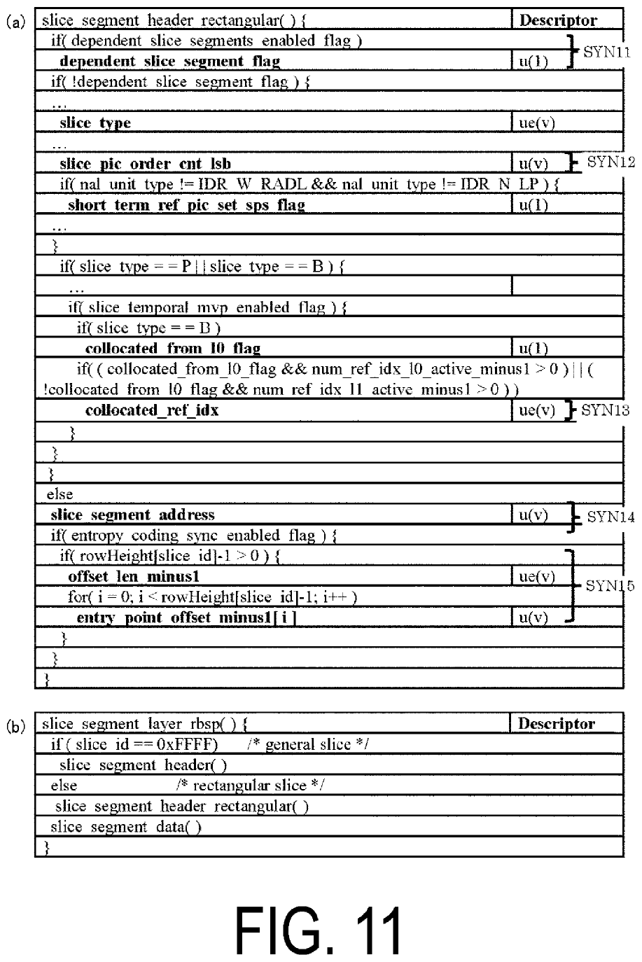

FIG. 8 and FIG. 11(a) are examples of the syntax related to a slice header. The syntax of a slice header of a general slice is FIG. 8, and the syntax of a slice header of a rectangular slice is FIG. 11(a). The differences in the syntax in FIG. 8 and FIG. 11(a) will be described.

In the general slice illustrated in FIG. 8, the flag first_slice_segment_in_pic_flag for indicating whether or not it is the first slice of the picture at the beginning of the slice header is first decoded. In a case that it is not the first slice of the picture, dependent_slice_segment_flag for indicating whether or not the current slice is a dependent slice is decoded (SYN01). In the case that it is not the first slice of the picture, the CTU address slice_segment_address at the beginning of the slice is decoded (SYN04). In a general slice, the POC is reset in an Instantaneous Decoder Refresh (IDR) picture, so that the information slice_pic_order_cnt_Isb for deriving the POC is not signalled in the IDR picture (SYN02).

On the other hand, in the rectangular slice illustrated in FIG. 11(a), the syntax slice_id for indicating the SliceId is signalled in the NAL unit header, so the slice position information is not signalled but derived from the SliceId and the rectangular slice information. For example, in a case of uniform_spacing_flag=1, the coordinate (sRSs, yRSs) of the first CTU of the slice is derived in the following equation.

SliceId=slice_id

(xRSs,yRSs)=((SliceId % (num_rslice_columns_minus1+1))*wRS,(SliceId/(num_rslice_columns_minus1+1)*hRS) (Equation RSLICE-3)

Then, dependent_slice_segment_flag for indicating whether or not the current slice header is a dependent slice is decoded (SYN11). In a rectangular slice, SliceId is assigned in a rectangular slice unit, so that an independent slice and a dependent slice included in one rectangular slice have the same SliceId. The coordinate of the first CTU of an independent slice (the vertical line block in FIG. 4(c)) is (sRSs, yRSs) derived in (Equation RSLICE-3), while the information related to the coordinate of the first CTU of a dependent slice (the horizontal line block in FIG. 4(c)) is derived by decoding slice_segment_address (SYN14). In a rectangular slice, the POC is not always reset with an Instantaneous Decoder Refresh (IDR) picture, so that information slice_pic_order_cnt_lsb for deriving the POC is always signalled (SYN12).

Independent slices and dependent slices in a case that one picture is partitioned into four rectangular slices is illustrated in FIG. 4(c). In each rectangular slice, an independent slice is a region of a rectangular pattern, followed by zero or more dependent slices after the independent slice. In a slice header of a dependent slice, only a part of the syntax of the slice header is signalled, so that the header size is smaller than an independent slice. Compared to a general slice, a rectangular slice is limited in shape to rectangular, so that code amount control per slice is difficult. A slice coder 2012 codes a rectangular slice by partitioning one rectangular slice into two or more NAL units by inserting a dependent slice header prior to exceeding a prescribed code amount. In a transmission scheme with limited data amount, such as a packet adaptive scheme for use in network transmission, a dependent slice is used to allow flexible code amount control in accordance with an application while suppressing the overhead of the slice header.

By using Wavefront Parallel Processing (WPP) in addition to parallel processing for each rectangular slice, the degree of parallel processing can be further increased. FIG. 4(d) is a diagram illustrating WPP. WPP is a process in a CTU column unit in a slice, and the beginning address of the left end CTU of each slice on the coding stream is signalled in the slice header other than the first column of the slice. A slice decoder 2002 derives the beginning address of each CTU column with reference to entry_point_offset_minus1 of the slice header described in FIG. 8 or FIG. 11(a) (adds 1 to entry_point_offset_minus1). Returning to FIG. 4(d), for the rectangular slice of SliceId=sid, the CTU at the position (x, y) is represented by RS [sid] [x] [y]. The CTU (RS [0] [0][1]) at position (0,1) with SliceId=0 sets the CABAC context of oft-th CTU (RS [0] [oft][0]) from the left of the one-upper CTU column as the CABAC context. In the example of FIG. 4(d), oft is equal to 2 so that the slice decoder 2002 sets the CABAC context of RS [0] [2] [0] for the CABAC context of RS [0] [0] [1]. In FIG. 4(d), a block with horizontal lines is a left end block of each rectangular slice, and a block with diagonal lines is a block that refers to the CABAC context from the left end block. The slice decoder 2002 may perform a decoding process in parallel in a unit of CTU rows from the beginning address of each CTU column on the coding stream. This further allows parallel decoding in a unit of CTU rows in addition to parallel decoding in a unit of rectangular slices.

Note that in a rectangular slice, the number of CTU columns for each slice is known (for example, row_height_minus1 [ ]), so that notification of num_entry_point_offset (SYN05) illustrated in FIG. 8 is not necessary in FIG. 11(a) (SYN15).

As described above, by introducing a rectangular slice instead of a tile and switching a general slice and a rectangular slice in a unit of CVS, a complex coding structure such as further partitioning a slice into tiles or further partitioning a tile into slices can be simplified.

### Intra Slice Control and Notification Thereof

In order to allow random access, conventionally, an intra (Intra Random Access Point (IRAP) picture is inserted that ensures independent decoding in a picture unit. Specifically, the prediction is reset with the IRAP picture, and playback of pictures from the middle of the sequence, or special playback such as fast forward, and the like is performed. However, the code amount is concentrated in the IRAP pictures, so that there is a problem in that the amount of processing of each picture is imbalance and the processing is delayed.

A temporal independent slice is independent in not only the spatial direction but also in the temporal direction, so by not inserting an IRAP in which all slices are intra slices but by inserting I slices distributed in multiple pictures for each rectangular slice sequence, imbalance in the amount of processing or delay due to the code amount being concentrated in a single picture can be avoided. The following describes the method of inserting an I slice in a rectangular slice sequence and its notification method.

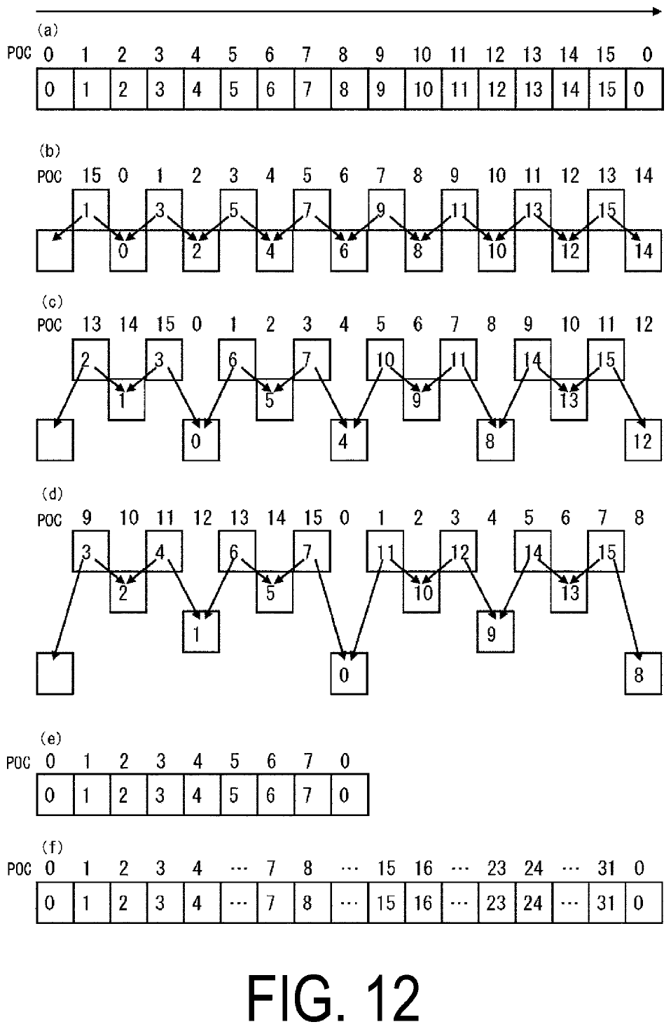

FIG. 12 is a diagram illustrating a temporal hierarchy structure. FIGS. 12(a) to (d) are cases that the insertion interval of I slices is 16, FIG. 12(e) is a case that the insertion interval of I slices is 8, and FIG. 12(f) is a case that the insertion interval of I slices is 32. The squares in the figures indicate the pictures and the numbers in the squares indicate the decoding order of the pictures. The upper side numerical values of the squares indicate the POC (the display order of the pictures). FIGS. 12(a), (e), and (f) are cases that the temporal hierarchy identifier Tid (TemporalID) is 0, FIG. 12(b) is a case that the temporal hierarchy identifier Tid (TemporalID) is 0 or 1, FIG. 12(c) is a case that the temporal hierarchy identifier Tid (TemporalID) is 0, 1, or 2, and FIG. 12(d) is a case that the temporal hierarchy identifier Tid (TemporalID) is 0, 1, 2, or 3. The temporal hierarchy identifier is derived from the syntax nuh_temporal_id_plus1 signalled by nal_unit_header. The arrows in the figures indicate the reference directions of the pictures. For example, the picture of POC=3 in FIG. 12(b) uses the pictures of POC=2 and POC=4 for prediction. Accordingly, in FIG. 12(b), the decoding order and the output order of the pictures are different from each other. In FIGS. 12(c) and (d), the decoding order and the output order of the pictures are different from each other as well. In a case that the maximum Tid (maxTid) is 0, i.e., the decoding order and the output order of the pictures are the same, the insertion positions of the I slices are optional in the rectangular slice sequence. However, in a case that the decoding order and the output order of the pictures are different from each other, the insertion positions of the I slices are limited to the pictures of Tid=0. This is because, in a case that an I slice is inserted into a picture other than those, a problem may occur in which a coding stream of an I slice has not received at a time of decoding a picture that utilizes the I slice for prediction.

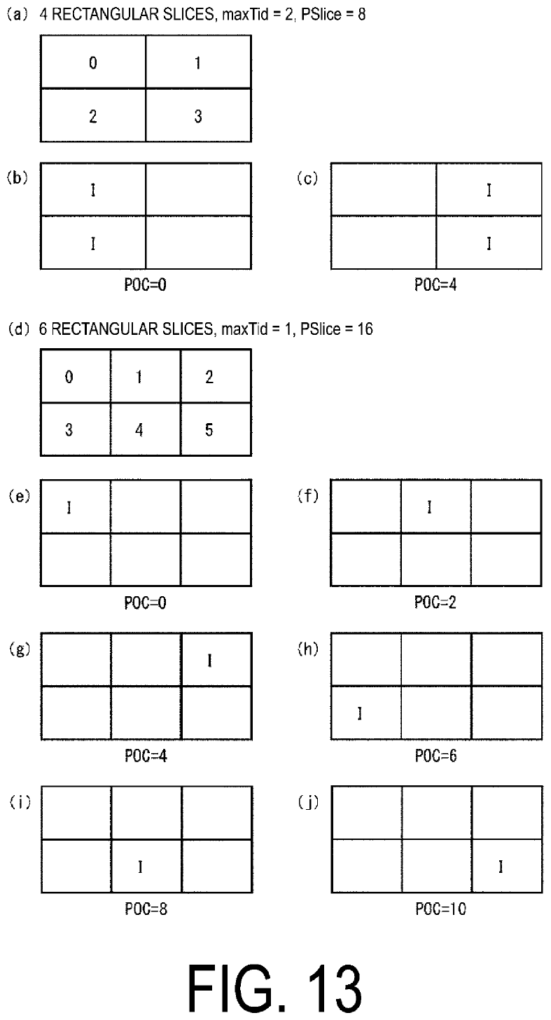

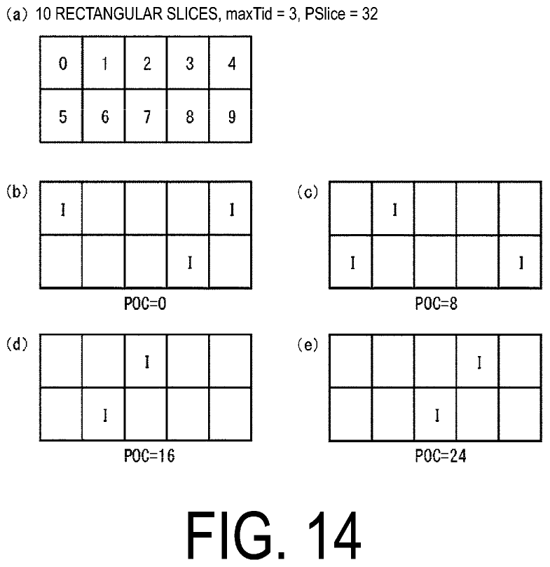

FIGS. 13 and 14 are diagrams illustrating the insertion positions of I slices in rectangular slices. The numerical values in FIGS. 13(a) and (d) and FIG. 14(a) indicate SliceIds, and “I” in FIGS. 13(b), (c), and (e) to (j), and FIGS. 14(b) to 14(e) indicates I slices. FIG. 13(a) is a case that one picture is partitioned into four rectangular slices, and is a case that the insertion period (PIslice) of an I slice in each rectangular slice is 8, with maxTid=2. maxTid=2 denotes the coding structure of FIG. 12(c). In POC=0 (FIG. 13(b)) and POC=4 (FIG. 13(c)) with Tid=0, each of SliceId=0 and 2 and SliceId=1 and 3 is coded with I slices. That is, as illustrated in FIG. 13(a), in the case of four rectangular slices, maxTid=2, PIslice=8, the IRAP picture, which is a conventional key frame, is partitioned into substantially two, and half of a picture is coded as an I slice at a time. Therefore, since an I slice having a large code amount is partitioned into two pictures, it is possible to avoid concentrating the code amount to one picture. A rectangular slice sequence does not refer to a rectangular slice sequence with a different SliceId, and thus random access can be performed at the time of all rectangular slices coded with the I slices (POC=4 in FIG. 12(c)) beginning from POC=0.

FIG. 13(d) is a case that one picture is partitioned into six rectangular slices, and is a case of maxTid=1 and PIslice=16. maxTid=1 denotes the coding structure of FIG. 12(b). In POC=0, 2, 4, 6, 8, and 10 with Tid=0 (FIGS. 13(e) to (j)), each of SliceId=0, 1, 2, 3, 4, and 5 is coded with I slices. That is, as illustrated in FIG. 13(d), in a case of six rectangular slices, maxTid=1, and PIslice=16, the IRAP picture, which is a conventional key frame, is partitioned into substantially six, and ⅙ of a picture is coded as an I slice at a time. Therefore, since an I slice having a large code amount is partitioned into six pictures, it is possible to avoid concentrating the code amount to one picture. A rectangular slice sequence does not refer to a rectangular slice sequence with a different SliceId, and thus random access can be performed at the time of all rectangular slices coded with the I slices (POC=10 in FIG. 12(b)) beginning from POC=0.

FIG. 14(a) is a case that one picture is partitioned into 10 rectangular slices, and is a case of maxTid=3 and PIslice=32. maxTid=3 denotes the coding structure of FIG. 12(d). In POC=0, 8, 16, 24 with Tid=0 (FIGS. 14(b) to (e)), each of SliceId=0, 4, and 8 (FIG. 14(b)), SliceId=1, 5, and 9 (FIG. 14(c)), SliceId=2 and 6 (FIG. 14(d)), and SliceId=3 and 7 (FIG. 14(e)) is coded with I slices. That is, as illustrated in FIG. 14(a), in a case of 10 rectangular slices, maxTid=3, and PIslice=32, the IRAP picture, which is a conventional key frame, is partitioned into substantially four, and approximately ¼ of a picture is coded as an I slice at a time. Therefore, since an I slice having a large code amount is partitioned into approximately four pictures, it is possible to avoid concentrating the code amount to one picture. A rectangular slice sequence does not refer to a rectangular slice sequence with a different SliceId, and thus random access can be performed at the time of all rectangular slices coded with the I slices (POC=24) beginning from POC=0.

FIG. 13 and FIG. 14 are examples of combinations of the number of rectangular slices, the maximum value maxTid of Tid, and the insertion period PIslice of I slices, and the POC for inserting I slices can be expressed, for example, by the following equation.

TID2=2\hat{ }maxTid (Equation POC-1)

POC(SliceId)=(SliceId*TID2) % PIslice (Equation POC-2)

Here, POC (SliceId) is the POC for coding the rectangular slice of SliceId with an I slice. “2\hat{ }a” indicates a power of 2 (2 to the power of a).

As another example, the POC for inserting I slices can be expressed as the following equation.

THPI=floor(PIslice/TID2) (Equation POC-3)

POC(SliceId)=(SliceId*TID2) % PIslice (THPI>=2)

POC(SliceId)=(SliceId*TID2*THPI) % PIslice (other than above)

In (Equation POC-3), in a case that the period of inserting I slices is long, the I slices are inserted being more distributed than (Equation POC-2), so the concentration of the code amount to a particular picture can be further reduced. However, the I slices are gradually decoded, so it takes time to gather the entire picture. In a case of shortening the time involved in random access, maxTid may be smaller, and the insertion interval of I slices may be shortened.

The insertion interval of the I slices described above is signalled, for example, in a sequence parameter set SPS. FIGS. 9(b) and (c) are examples of the syntax related I slices.

In FIG. 9(b), in a case of rectangular_slice_flag=1, information islice ( ) related to I slice insertion is signalled. Specific examples of islice ( ) are illustrated in FIGS. 9(b) and (c). In FIG. 9(b), in the insertion period of one I slice, the number of pictures num_islice_picture including I slices and information islice_flag for indicating which slices are I slices in each picture including the I slices are signalled. Here, NumRSlice is the number of rectangular slices in the picture, and is derived by the following equation from num_rslice_column_minus1 and num_rslice_rows_minus1 of rectangular_slice_info ( ) illustrated in FIG. 7(c).

NumRSlice=(num_rslice_column_minus1+1)*(num_rslice_rows_minus1+1) (Equation POC-4)

In the case of FIG. 14(a), the pictures including the I slices are POC=0, 8, 16, and 24, which are pictures of Tid=0, so num_islice_picture is 4. In a case that i=0, 1, 2, and 3 correspond to POC=0, 8, 16, and 24, respectively, islice_flag [i] [ ] is determined as illustrated in FIG. 9(d). Here, islice_flag [i] [j]=1 indicates that the rectangular slice of SliceId=j in the i-th picture of Tid=0 is an I slice, and islice_flag [i] [j]=0 indicates that the rectangular slice of SliceId=j in the i-th picture of Tid=0 is not an I slice. In FIG. 14(b), for the 0-th picture (POC=0) of Tid=0, rectangular slices of the SliceId=0, 4, and 8 are I slices, and the other rectangular slices are not I slices, so that islice_flag [0][ ] is {1,0,0,0,1,0,0,0,1,0} as illustrated in FIG. 9(d).

In FIG. 9(c), the insertion period (PIslice) islice_period of I slices in each rectangular slice and the maximum value of Tid max_tid are signalled in islice_info ( ). By substituting them into (Equation POC-1) to (Equation POC-3), the positions of the I slices in each rectangular slice are derived.

In a case of utilizing rectangular slices, information related to the I slice insertion cannot be changed in the CVS. In a case of changing the timing of the I slice insertion for scene changes or other reasons, the CVS needs to be terminated and information islice ( ) related to I slice insertion needs to be signalled by a new SPS.

### Configuration of Video Decoding Apparatus

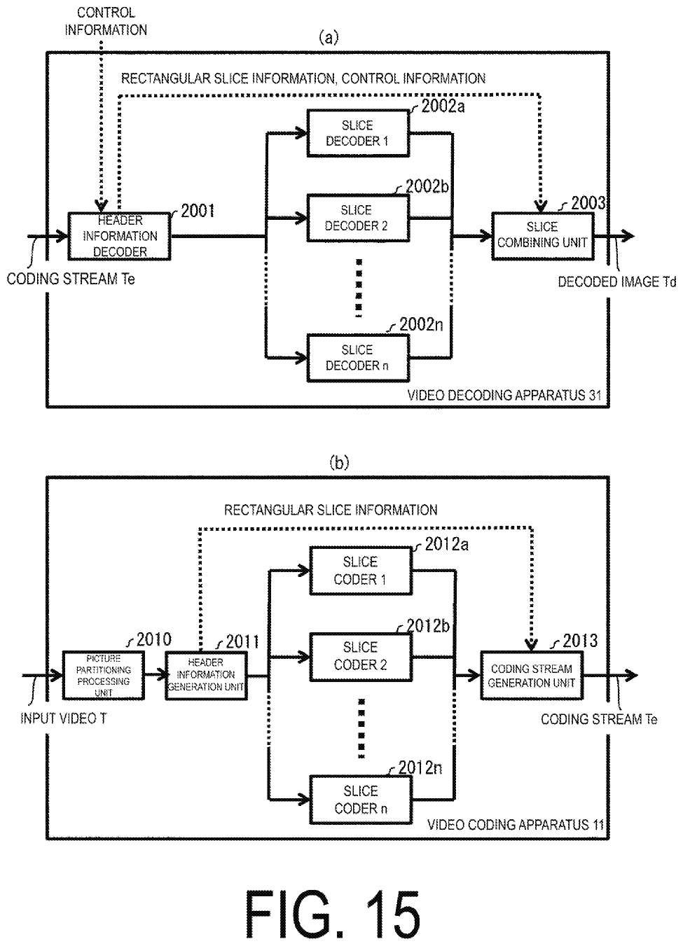

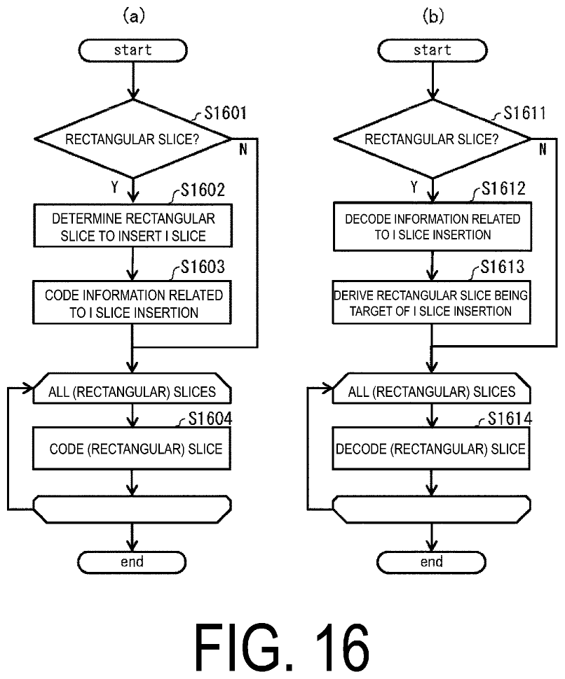

FIG. 15(a) illustrates the video decoding apparatus (image decoding apparatus) 31 according to the present invention. The video decoding apparatus 31 includes a header information decoder 2001, slice decoders 2002a to 2002n, and a slice combining unit 2003. FIG. 16(b) is a flowchart of the video decoding apparatus 31.

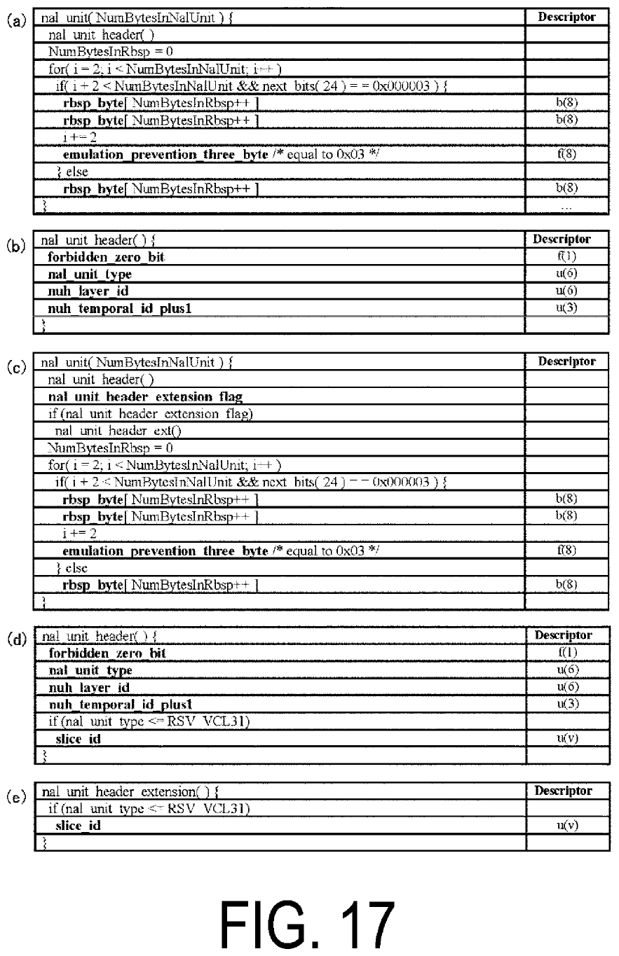

The header information decoder 2001 decodes header information (SPS/PPS or the like) from a coding stream Te input from the outside and coded in units of a network abstraction layer (NAL) unit. Here, the NAL unit and a NAL unit header will be described in FIG. 17.

### Extension of NAL Unit Header

FIGS. 17(a) and (b) are the syntax indicating a NAL unit and a NAL unit header of a general slice. The NAL unit includes a NAL unit header and subsequent coded data in a unit of byte (such as a parameter set, coded data of slice data or lower, and the like). The NAL unit header notifies the identifier nal_unit_type for indicating the type of NAL unit, nul_layer_id for indicating the layer to which NAL belongs, and nuh_temporal_id_plus1 for indicating the temporal hierarchy identifier Tid. Tid described above is derived by the following equation.

Tid=nuh_temporal_id_plus1−1

For a rectangular slice, the syntax of the NAL unit of FIG. 17(a) and the NAL unit header of FIG. 17(d), for example, is used. The difference from a general slice is to signal slice_id in the NAL unit header in a rectangular slice. In a case that video coded data of the slice layer or lower is transmitted in the NAL unit (nal_unit_type<=RSV_VCL31), data of the NAL unit includes a slice header and notifies the syntax slice_id for indicating the SliceId. The NAL unit header is desirably fixed in length, so slice_id is fixed length coded with v bit. Note that in a case that slice_id is not signalled, 0xFFFF is set to slice_id.

As another example, the syntax of the NAL unit of FIG. 17(c), the NAL unit header of FIG. 17(b), and the extended NAL unit header of FIG. 17(e) is used to signal slice_id. In FIG. 17(c), the extended NAL unit header is signalled in a case that nal_unit_header_extension_flag is true, but instead of nal_unit_header_extension_flag, the extended NAL unit header may be signalled in a case that the NAL unit includes video coded data of slices or lower (nal_unit_type is RSV_VCL31 or less). For the extended NAL unit header of FIG. 17(e), slice_id is signalled in a case that the NAL unit includes video coded data of slices or lower (nal_unit_type is RSV_VCL31 or less). In a case that slice_id is not signalled, slice_id is set to xFFFF for indicating that it is not a rectangular slice. The slice_id notification by the NAL unit header and rectangular_slice_flag signalled by the SPS need to be linked. That is, in a case that slice_id is signalled, rectangular_slice_flag is 1.

Position information for a target slice is derived in combination of slice_id and the rectangular slice information signalled by the SPS or the PPS. Since nal_unit_type for indicating the type of NAL unit (whether or not the current slice is an IRAP) is also signalled in the NAL unit header, the video decoding apparatus can know the information required for random access and the like in advance at the time of decoding the NAL unit header and a relatively higher parameter set.

In a case that the decoding target is a rectangular slice (S1611), the header information decoder 2001 derives the rectangular slices (SliceId) required for display from the control information input from the outside, indicating the image region to be displayed on a display or the like. The header information decoder 2001 also decodes the information related to the I slice insertion from the SPS/PPS (S1612), and derives a rectangular slice for inserting an I slice (S1613). The header information decoder 2001 extracts the coding rectangular slices TeS required for display from the coding stream Te and transmits the coding rectangular slices TeS to the slice decoders 2002a to 2002n. The header information decoder 2001 also decodes the SPS/PPS and transmits the rectangular slice information (the information related to partitioning of the rectangular slices) and the like to the rectangular slice combining unit 2003. By signalling slice_id in the NAL unit header or its extended portion, the derivation of the rectangular slices needed for display can be simplified.

The slice decoders 2002a to 2002n decode each coded slice from the coded rectangular slice TeS and the I slice insertion position (S1614), and transmit the decoded slice to the slice combining unit 2003. In a case that the coding stream TeS is comprised of general slices, there is no control information or rectangular slice information, and the entire picture is decoded. As illustrated in FIG. 1(b), for a general slice, with slice_id=0xFFFF at the time of decoding the NAL unit header, the slice header is decoded according to the syntax of FIG. 8. For a rectangular slice, with other than slice_id!=0xFFFF, the slice header is decoded according to the syntax of FIG. 11(a).

Here, in a case of rectangular_slice_flag=1, the slice decoders 2002a to 2002n performs decoding processing on the rectangular slice sequence as one independent video sequence, and thus do not refer to prediction information between rectangular slice sequences temporally nor spatially in a case of performing the decoding processing. That is, the slice decoders 2002a to 2002n do not refer to a rectangular slice of another rectangular slice sequence (with a different SliceId) in a case of decoding a rectangular slice in a picture. There are no such constraints in the case of rectangular_slice_flag=0, i.e., in the case of a general slice.

Thus, in the case of rectangular_slice_flag=1, the slice decoders 2002a to 2002n decode each of the rectangular slices, so that decoding processing can be performed in parallel on multiple rectangular slices, or only one rectangular slice may be decoded independently. As a result, by the slice decoders 2002a to 2002n, the decoding processing can be performed efficiently, such as performing only the minimum necessary decoding processing to decode the images required for display.

In the case of rectangular_slice_flag=1, the slice combining unit 2003 refers to the rectangular slice information transmitted from the header information decoder 2001 and the SliceId of the rectangular slice to be decoded, and the rectangular slice decoded by the slice decoders 2002a to 2002n, to generate and output decoded images Td required for display. There are no such constraints in the case of rectangular_slice_flag=0, i.e., in the case of a general slice, and the entire picture is displayed.

### Configuration of Slice Decoder

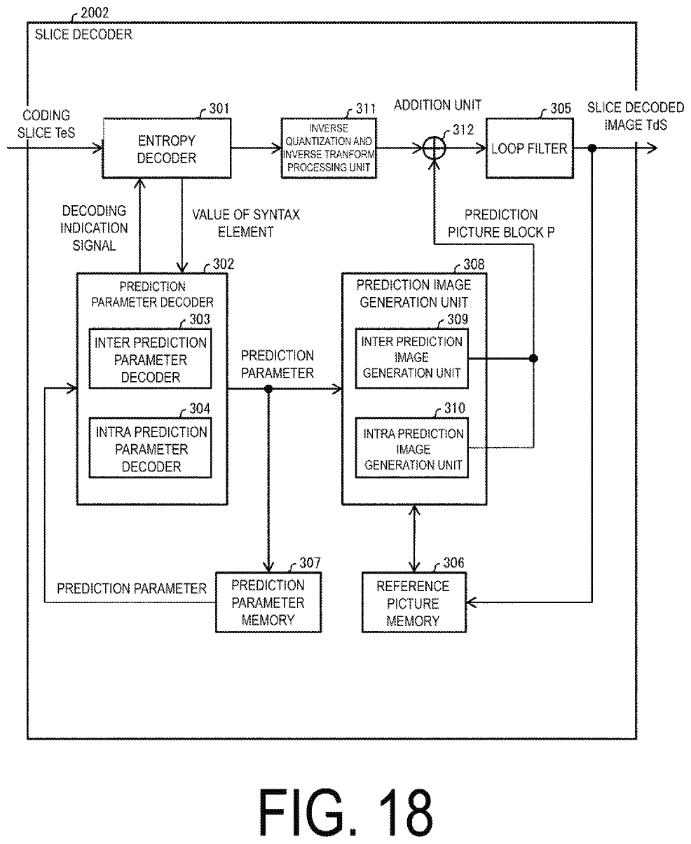

The configuration of the slice decoders 2002a to 2002n will be described. As an example below, the configuration of the slice decoder 2002a will be described with reference to FIG. 18. FIG. 18 is a block diagram illustrating the configuration of 2002, which is one of the slice decoders 2002a to 2002n. The slice decoder 2002 includes an entropy decoder 301, a prediction parameter decoder (a prediction image decoding apparatus) 302, a loop filter 305, a reference picture memory 306, a prediction parameter memory 307, a prediction image generation unit (a prediction image generation apparatus) 308, an inverse quantization and inverse transform processing unit 311, and an addition unit 312. Note that there is a configuration in which the loop filter 305 is not included in the slice decoder 2002, in accordance with the slice coder 2012 described below.

The prediction parameter decoder 302 includes an inter prediction parameter decoder 303 and an intra prediction parameter decoder 304. The prediction image generation unit 308 includes an inter prediction image generation unit 309 and an intra prediction image generation unit 310.

Examples in which CTUs, CUs, PUs, and TUs are used as the units of processing are described below, but the present invention is not limited to these examples, and may be processed in CU units instead of TU or PU units. Alternatively, the CTUs, CUs, PUs, and TUs are interpreted as blocks, and the present invention may be processed in block units.

The entropy decoder 301 performs entropy decoding on the coding stream TeS input from the outside, and separates and decodes individual codes (syntax elements). The separated codes include a prediction parameter to generate a prediction image and residual information to generate a difference image and the like.

The entropy decoder 301 outputs a part of the separated codes to the prediction parameter decoder 302. For example, the part of the separated codes includes a prediction mode predMode, a PU partitioning mode part_mode, a merge flag merge_flag, a merge index merge_idx, an inter prediction indicator inter_pred_ide, a reference picture index ref_idx_lX, a prediction vector index mvp_lX_idx, and a difference vector mvdLX. The control of which code to decode is performed based on an indication of the prediction parameter decoder 302. The entropy decoder 301 outputs a quantization transform coefficient to the inverse quantization and inverse transform processing unit 311. This quantization transform coefficient is a coefficient obtained by performing a frequency transform such as a Discrete Cosine Transform (DCT), a Discrete Sine Transform (DST), a Karyhnen Loeve Transform (KLT), and the like on a residual signal to quantize in the coding processing.

The inter prediction parameter decoder 303 decodes an inter prediction parameter with reference to a prediction parameter stored in the prediction parameter memory 307, based on a code input from the entropy decoder 301. The inter prediction parameter decoder 303 also outputs the decoded inter prediction parameter to the prediction image generation unit 308, and also stores the decoded inter prediction parameter in the prediction parameter memory 307. Details of the inter prediction parameter decoder 303 will be described later.

The intra prediction parameter decoder 304 decodes an intra prediction parameter with reference to a prediction parameter stored in the prediction parameter memory 307, based on a code input from the entropy decoder 301. The intra prediction parameter decoder 304 outputs the decoded intra prediction parameter to the prediction image generation unit 308, and also stores the decoded intra prediction parameter in the prediction parameter memory 307.

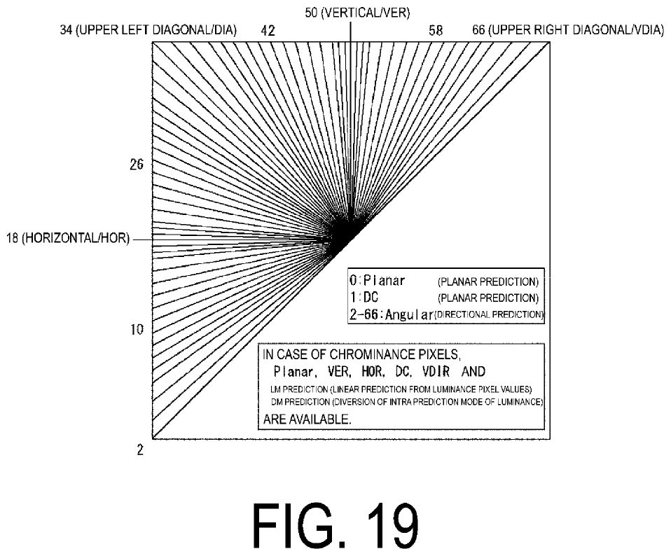

The intra prediction parameter decoder 304 decodes a luminance prediction mode IntraPredModeY as a prediction parameter of luminance, and decodes a chrominance prediction mode IntraPredModeC as a prediction parameter of chrominance. The intra prediction parameter decoder 304 decodes the flag for indicating whether or not the chrominance prediction is an LM prediction, and in a case that the flag indicates an LM prediction, the intra prediction parameter decoder 304 decodes information related to an LM prediction (information for indicating whether or not it is a CCLM prediction, or information for specifying a downsampling method). Here, the LM prediction will be described. The LM prediction is a prediction scheme using a correlation between a luminance component and a color component, and is a scheme for generating a prediction image of a chrominance image (Cb, Cr) by using a linear model, based on a decoded luminance image. LM predictions include a Cross-Component Linear Model prediction (CCLM) prediction and a Multiple Model ccLM (MMLM) prediction. The CCLM prediction is a prediction scheme using one linear model for predicting chrominance from luminance for one block. The MMLM prediction is a prediction scheme using two or more linear models for predicting chrominance from luminance for one block. In a case that the chrominance format is 4:2:0, the luminance image is downsampled to the same size as the chrominance image to create a linear model. In a case that the flag indicates that it is a different prediction from an LM prediction, either a planar prediction, a DC prediction, an Angular prediction, or a DM prediction is decoded as IntraPredModeC. FIG. 19 is a diagram illustrating intra prediction modes. The directions of the straight lines corresponding to 2 to 66 in FIG. 19 represent the prediction directions, and more accurately, indicate the directions of the pixels on the reference regions R (described later) to which a prediction target pixel refers.

The loop filter 305 applies a filter such as a deblocking filter, a sample adaptive offset (SAO), and an adaptive loop filter (ALF) on a decoded image of a CU generated by the addition unit 312. Note that in a case that the loop filter 305 is paired with the slice coder 2012, the loop filter 305 need not necessarily include the three types of filters described above, and may be, for example, a configuration with only a deblocking filter.

The reference picture memory 306 stores a decoded image of a CU generated by the addition unit 312 in a predetermined position for each picture and CTU or CU of a decoding target. Pictures stored in the reference picture memory 306 is managed in association with the POC (display order) on the reference picture list. For a picture in which the whole picture is I slices such as an IRAP picture, the POC is set to 0, and all of the pictures stored in the reference picture memory are discarded. However, in a case that the picture is rectangular slices and a part of the picture is coded with I slices, the pictures stored in the reference picture memory needs to be retained.

The prediction parameter memory 307 stores a prediction parameter in a predetermined position for each picture and prediction unit (or a subblock, a fixed size block, and a pixel) of a decoding target. Specifically, the prediction parameter memory 307 stores an inter prediction parameter decoded by the inter prediction parameter decoder 303, an intra prediction parameter decoded by the intra prediction parameter decoder 304, and the like. For example, inter prediction parameters stored include a prediction list utilization flag predFlagLX (the inter prediction indicator inter_pred_ide), a reference picture index refIdxLX, and a motion vector mvLX.

To the prediction image generation unit 308, a prediction mode predMode input from the entropy decoder 301 is input, and a prediction parameter is input from the prediction parameter decoder 302. The prediction image generation unit 308 reads a reference picture from the reference picture memory 306. The prediction image generation unit 308 generates a prediction image of a PU (block) or a subblock by using a prediction parameter input and a reference picture (a reference picture block) read, with a prediction mode indicated by the prediction mode predMode.

Here, in a case that the prediction mode predMode indicates an inter prediction mode, the inter prediction image generation unit 309 generates a prediction image of a PU (block) or a subblock by an inter prediction by using an inter prediction parameter input from the inter prediction parameter decoder 303 and a read reference picture (a reference picture block).

For a reference picture list (an L0 list or an L1 list) where a prediction list utilization flag predFlagLX is 1, the inter prediction image generation unit 309 reads a reference picture block from the reference picture memory 306 in a position indicated by a motion vector mvLX, based on a decoding target PU, from reference pictures indicated by the reference picture index refIdxLX. The inter prediction image generation unit 309 performs an interpolation based on the read reference picture block and generates a prediction image (an interpolation image or a motion compensation image) of a PU. The inter prediction image generation unit 309 outputs the generated prediction image of the PU to the addition unit 312. Here, the reference picture block refers to a set of pixels (referred to as a block because it is normally rectangular) on a reference picture, and is a region that is referred to for generating a prediction image of a PU or a subblock.

### Rectangular Slice Boundary Padding

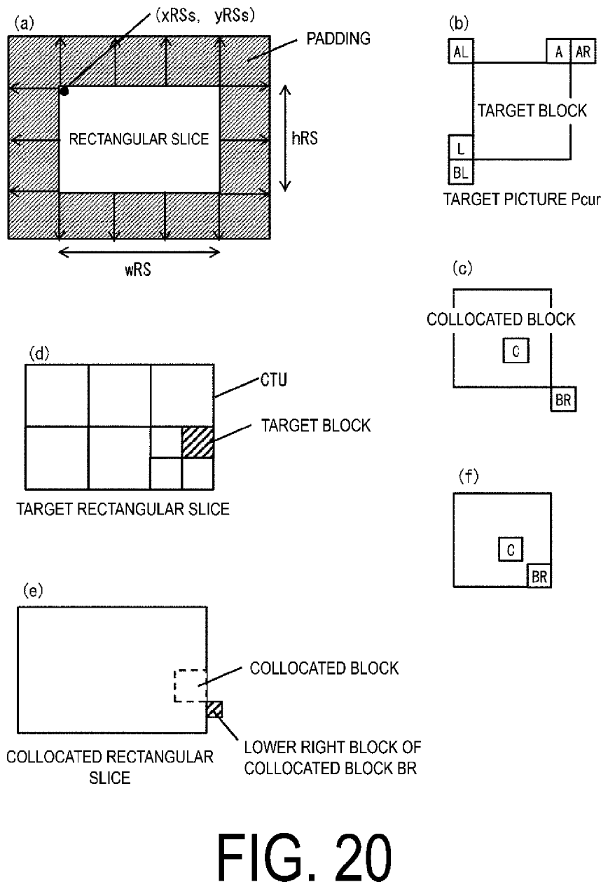

For a reference picture list of the prediction list utilization flag predFlagLX=1, the reference picture block (reference block) is a block on a reference picture indicated by the reference picture index refIdxLX, at the position indicated by the motion vector mvLX, based on the position of the target CU (block). As previously described, there is no guarantee that the pixels of the reference block are located within a rectangular slice (collocated rectangular slice) on a reference picture with the same SliceId as the target rectangular slice. Thus, as an example, in the case of rectangular_slice_flag=1, the reference block may be read without reference to pixel values outside of the collocated rectangular slice by padding (making up with pixel values of the rectangular slice boundary) the outside of each rectangular slice as illustrated in FIG. 20(a) in a reference picture.

Rectangular slice boundary padding (rectangular slice outside padding) is achieved by using the pixel value refImg [xRef+i] [yRef+j] at the following position (xRef+i, yRef+j) as the pixel value at the position (xIntL+i, yIntL+j) of the reference pixel in motion compensation by a motion compensation unit 3091 described below. That is, this is achieved by clipping the reference positions at the positions of the upper, lower, left, and right boundary pixels of the rectangular slice in reference to reference pixels.

xRef+i=Clip3(xRSs,xRSs+wRS−1,xIntL+i)

yRef+j=Clip3(yRSs,yRSs+hRS−1,yIntL+j) (Equation PAD-1)

Here, (xRSs, yRSs) is the upper left coordinate of the target rectangular slice at which the target block is located, and wRS and hRS are the width and the height of the target rectangular slice.

Note that, assuming that the upper left coordinate of the target block relative to the upper left coordinate of the picture is (xb, yb) and the motion vector is (mvLX [0], mvLX [1]), xIntL and yIntL may be derived by:

xIntL=xb+(mvLX[0]>>log 2(M))

yIntL=yb+(mvLX[1]>>log 2(M)). (Equation PAD-2)

Here, M indicates that the accuracy of the motion vector is 1/M pel.

By reading the pixel value of the coordinate (xRef+i, yRef+j), the padding of FIG. 20(a) can be achieved.

In the case of rectangular_slice_flag=1, by padding the rectangular slice boundary in this way, even in a case that the motion vector points outside of the collocated rectangular slice for an inter prediction, the reference pixels are replaced by using the pixel values within the collocated rectangular slice, so that the rectangular slice sequence can be decoded independently by using an inter prediction.

Rectangular Slice Boundary Motion Vector Limitation Limiting methods other than the rectangular slice boundary padding include rectangular slice boundary motion vector limitation. In the present processing, in the case of rectangular_slice_flag=1, for motion compensation by the motion compensation unit 3091 described below, the motion vector is limited (clipped) so that the position (xIntL+i, yIntL+j) of the reference pixel is within the collocated rectangular slice.

In the present processing, in a case that the upper left coordinate of the target block (the target subblock or the target block) is (xb, yb), the size of the block is (W, H), the upper left coordinate of the target rectangular slice is (xRSs, yRSs), and the width and the height of the target rectangular slice are wRS and hRS, the motion vector mvLX of the block is input and a limited motion vector mvLX is output.

The left end posL, the right end posR, the upper end posU, and the lower end posD of the reference pixels in the generation of the interpolation image of the target block are the following. Note that NTAP is the number of taps of the filter used for the generation of the interpolation image.

posL=xb+(mvLX[0]>>log 2(M))−NTAP/2+1

posR=xb+W−1+(mvLX[0]>>log 2(M))+NTAP/2

posU=yb+(mvLX[1]>>log 2(M))−NTAP/2+1

posD=yb+H−1+(mvLX[1]>>log 2(M))+NTAP/2 (Equation CLIP1)

The limitations for the above reference pixels to enter into the collocated rectangular slice are as follows.

posL>=xRSs

posR<=xRSs+wRS−1

posU>=yRSs

posD<=yRSs+hRS−1. (Equation CLIP2)

The limitations of the motion vector can be derived from the following equation by transforming (Equation CLIP1) and (Equation CLIP2).

MvLX[0]=Clip3(vxmin,vxmax,mvLX[0])

MvLX[1]=Clip3(vymin,vymax,mvLX[1]) (Equation CLIP4)

Here

vxmin=(xRSs−xb+NTAP/2−1)<<log 2(M)

vxmax=(xRSs+wRS−xb−W−NTAP/2)<<log 2(M)

vymin=(yRSs−yb+NTAP/2−1)<<log 2(M)

vymax=(yRSs+hRS−yb−H−NTAP/2)<<log 2(M) (Equation CLIP5)

In the case of rectangular_slice_flag=1, by limiting the motion vector in this manner, the motion vector can always point inside of the collocated rectangular slice for an inter prediction. In this configuration as well, a rectangular slice sequence can be decoded independently by using an inter prediction.

In a case that the prediction mode predMode indicates an intra prediction mode, the intra prediction image generation unit 310 performs an intra prediction by using an intra prediction parameter input from the intra prediction parameter decoder 304 and read reference pixels. Specifically, the intra prediction image generation unit 310 reads an adjacent PU, which is a picture of a decoding target, in a predetermined range from the decoding target PU, among PUs already decoded, from the reference picture memory 306. The predetermined range is, for example, any of adjacent PUs in left, upper left, upper, and upper right in a case that the decoding target PU moves in order of so-called raster scan sequentially, and varies according to intra prediction modes. The order of the raster scan is an order to move sequentially from the left end to the right end in each picture for each row from the upper end to the lower end.

The intra prediction image generation unit 310 performs a prediction by a prediction mode indicated by the intra prediction mode IntraPredMode, based on a read adjacent PU, and generates a prediction image of a PU. The intra prediction image generation unit 310 outputs the generated prediction image of the PU to the addition unit 312.

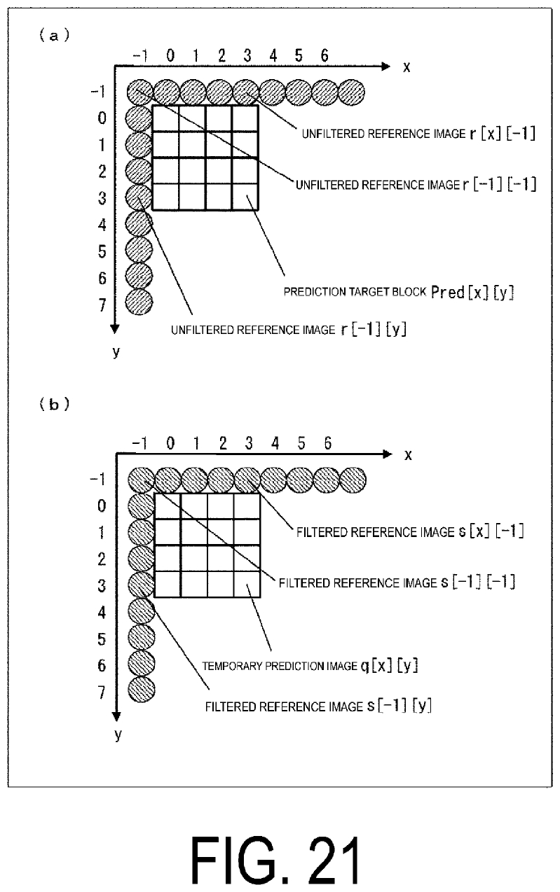

In a Planar prediction, a DC prediction, and an Angular prediction, the peripheral region that has been decoded and is adjacent to (proximate to) the prediction target block is configured as the reference region R. Schematically, these prediction modes are prediction schemes for generating a prediction image by extrapolating pixels on the reference region R in a particular direction. For example, the reference region R can be configured as an inverse L-shaped region (for example, the region indicated by the diagonal rounded pixel of FIG. 21) including left and upper (or even upper left, upper right, lower left) of the prediction target block.

### Detail of Prediction Image Generation Unit

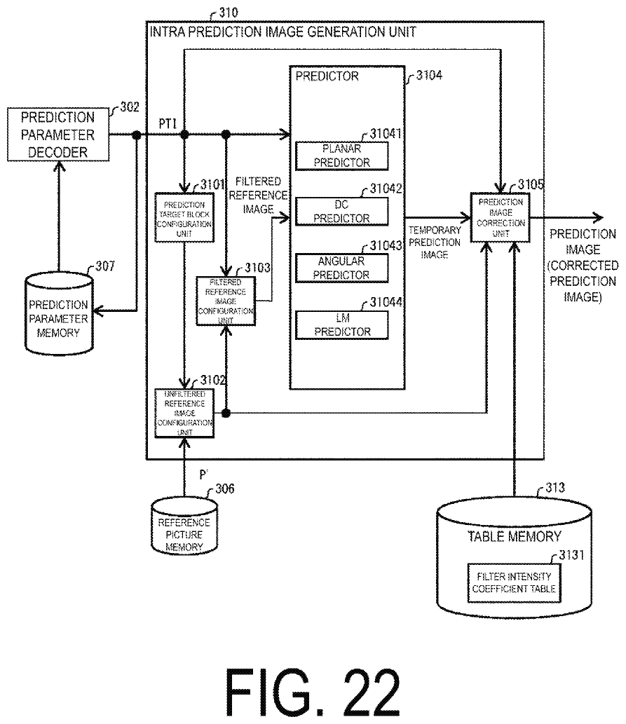

Next, the configuration of the intra prediction image generation unit 310 will be described in detail with reference to FIG. 22.

As illustrated in FIG. 22, the intra prediction image generation unit 310 includes a prediction target block configuration unit 3101, an unfiltered reference image configuration unit 3102 (a first reference image configuration unit), a filtered reference image configuration unit 3103 (a second reference image configuration unit), a predictor 3104, and a prediction image correction unit 3105 (a prediction image correction unit, a filter switching unit, or a weighting coefficient change unit).

The filtered reference image configuration unit 3103 applies a reference pixel filter (a first filter) to each reference pixel (an unfiltered reference image) on the input reference region R to generate a filtered reference image and outputs the filtered reference image to the predictor 3104. The predictor 3104 generates a temporary prediction image (pre-correction prediction image) of the prediction target block, based on the input intra prediction mode, the unfiltered reference image, and the filtered reference image, and outputs the generated image to the prediction image correction unit 3105. The prediction image correction unit 3105 corrects the temporary prediction image in accordance with the input intra prediction mode, and generates a prediction image (corrected prediction image). The prediction image generated by the prediction image correction unit 3105 is output to the summer 15.

Hereinafter, each unit included in the intra prediction image generation unit 310 will be described.

### Prediction Target Block Configuration Unit 3101

The prediction target block configuration unit 3101 configures the target CU to the prediction target block, and outputs information related to the prediction target block (prediction target block information). The prediction target block information includes at least an index for indicating the prediction target block size, the prediction target block position, and whether the prediction target block is luminance or chrominance.

### Unfiltered Reference Image Configuration Unit 3102

The unfiltered reference image configuration unit 3102 configures a peripheral region adjacent to the prediction target block to the reference region R, based on the prediction target block size and the prediction target block position of the prediction target block information. Subsequently, each pixel value in the reference region R (the unfiltered reference image, the boundary pixels) is set with each decoded pixel value at the corresponding position on the reference picture memory 306. In other words, the unfiltered reference image r [x] [y] is configured by the following equation by using the decoded pixel value u [ ] [ ] of the target picture expressed in terms of the upper left coordinate of the target picture.

r[x][y]=u[xB+x][yB+y] (INTRAP-1)

x=−1, y=−1 . . . (BS*2−1), and x=0 . . . (BS*2−1), y=−1

Here, (xB, yB) denotes the upper left coordinate of the prediction target block, and BS denotes the larger value of the width W or the height H of the prediction target block.

In the above equation, as illustrated in FIG. 21(a), the line r [x] [−1] of the decoded pixels adjacent to the prediction target block upper side and the column r [−1] [y] of the decoded pixels adjacent to the prediction target block left side are the unfiltered reference images. Note that, in a case that a decoded pixel value corresponding to the reference pixel position does not exist or cannot be referred to, a prescribed value (for example, 1<<(bitDepth−1) in a case that the pixel bit depth is bitDepth) may be configured as an unfiltered reference image, or a decoded pixel value that can be referred to as being present in the vicinity of the corresponding decoded pixel value may be configured as an unfiltered reference image. “y=−1 . . . (BS*2−1)” indicates that y may take (BS*2+1) values from −1 to (BS*2−1), and “x=0 . . . (BS*2−1)” indicates that x may take (BS*2) values from 0 to (BS*2−1).

In the above equation, as described below with reference to FIG. 21(a), the decoded images included in the row of the decoded pixels adjacent to the prediction target block upper side and the decoded images included in the column of the decoded pixels adjacent to the prediction target block left side is unfiltered reference images.

### Filtered Reference Image Configuration Unit 3103

The filtered reference image configuration unit 3103 applies (performs) a reference pixel filter (a first filter) to the input unfiltered reference image in accordance with an intra prediction mode, to derive and output a filtered reference image s [x] [y] at each position (x, y) on the reference region R (FIG. 21(b)). Specifically, the filtered reference image configuration unit 3103 applies a low pass filter to the unfiltered reference image at position (x, y) and its surroundings to derive a filtered reference image. Note that the low pass filter need not necessarily be applied to the all intra prediction modes, but the low pass filter may be applied to at least some of intra prediction modes. Note that, a filter that is applied to the unfiltered reference image on the reference region R at the filtered reference pixel configuration unit 3103 before entering the predictor 3104 in FIG. 22 is referred to as a “reference pixel filter (a first filter)”, while a filter that corrects the temporary prediction image derived by the predictor 3104 by using the unfiltered reference pixel value at the prediction image correction unit 3105 described later is referred to as a “boundary filter (a second filter)”.

For example, as in an intra prediction of HEVC, in a case of a DC prediction or in a case that the prediction target block size is 4×4 pixels, an unfiltered reference image may be used as is as a filtered reference image. A flag decoded from the coded data may switch between applying and not applying the low pass filter. Note that in the case that the intra prediction mode is an LM prediction, an unfiltered reference image is not directly referred to in the predictor 3104, and thus a filtered reference pixel value s [x] [y] may not be output from the filtered reference pixel configuration unit 3103.

### Configuration of Intra Predictor 3104

The intra predictor 3104 generates a temporary prediction image (a temporary prediction pixel value, a pre-correction prediction image) of the prediction target block, based on the intra prediction mode, the unfiltered reference image, and the filtered reference image, and outputs the generated image to the prediction image correction unit 3105. The predictor 3104 includes a Planar predictor 31041, a DC predictor 31042, an Angular predictor 31043, and an LM predictor 31044 therein. The predictor 3104 selects a specific predictor in accordance with the input intra prediction mode, and inputs an unfiltered reference image and a filtered reference image. The relationships between the intra prediction modes and the corresponding predictors are as follows.

| | |
|---|---|
| Planar prediction | Planar predictor 31041 |
| DC prediction | DC predictor 31042 |
| Angular prediction | Angular predictor 31043 |
| LM prediction | LM predictor 31044 |

The predictor 3104 generates a prediction image of the prediction target block (a temporary prediction image q [x] [y]), based on a filtered reference image in an intra prediction mode. In another intra prediction mode, the predictor 3104 may generate a temporary prediction image q [x] [y] by using an unfiltered reference image. The predictor 3104 may also have a configuration in which the reference pixel filter is turned on in a case that a filtered reference image is used, and the reference pixel filter is turned off in a case that an unfiltered reference image is used.

In the following, an example is described in which a temporary prediction image q [x] [y] is generated by using a unfiltered reference image r [ ] [ ] in a case of an LM prediction, and a temporary prediction image q [x] [y] is generated by using a filtered reference image s [ ] [ ] in a case of a Planar prediction, a DC prediction, or an Angular prediction, but the selection of an unfiltered reference image or a filtered reference image is not limited to this example. For example, which of an unfiltered reference image or a filtered reference image to use may be switched depending on a flag that is explicitly decoded from the coded data, or may be switched based on a flag derived from other coding parameters. INTRA PREDICTION MODE For example, in the case of an Angular prediction, an unfiltered reference image (the reference pixel filter is turned off) may be used in a case that difference between the intra prediction mode of the prediction target block and the intra prediction mode number of a vertical prediction or a horizontal prediction is small, and a filtered reference image (the reference pixel filter is turned on) may be used otherwise.

### Planar Prediction

The Planar predictor 31041 generates a temporary prediction image by linearly adding multiple filtered reference images in accordance with the distance between the prediction target pixel position and the reference pixel position, and outputs the prediction image to the prediction image correction unit 3105. For example, the pixel value q [x] [y]of the temporary prediction image is derived from the following equation by using the filtered reference pixel value s [x] [y] and the width W and the height H of the prediction target block previously described.

q[x][y]=((W−1−x)*s[−1][y]+(x+1)*s[W][−1]+(H−1−y)*s[x][−1]+(y+1)*s[−1][H]+max(W,H))>>(k+1) (INTRAP-2)

Here, x=0 . . . W−1, y=0>>H−1, and k=log 2 (max (W, H)) is defined.

### DC Prediction

The DC predictor 31042 derives an DC prediction value corresponding to the average value of the input filtered reference image s [x] [y], and outputs a temporary prediction image q [x] [y], with the derived DC prediction value as the pixel value.

### Angular Prediction

The Angular predictor 31043 generates a temporary prediction image q [x] [y] by using a filtered reference image s [x] [y] in the prediction direction (the reference direction) indicated by the intra prediction mode, and outputs the generated image to the prediction image correction unit 3105.

### LM Prediction

The LM predictor 31044 predicts a pixel value of chrominance, based on the pixel value of luminance.

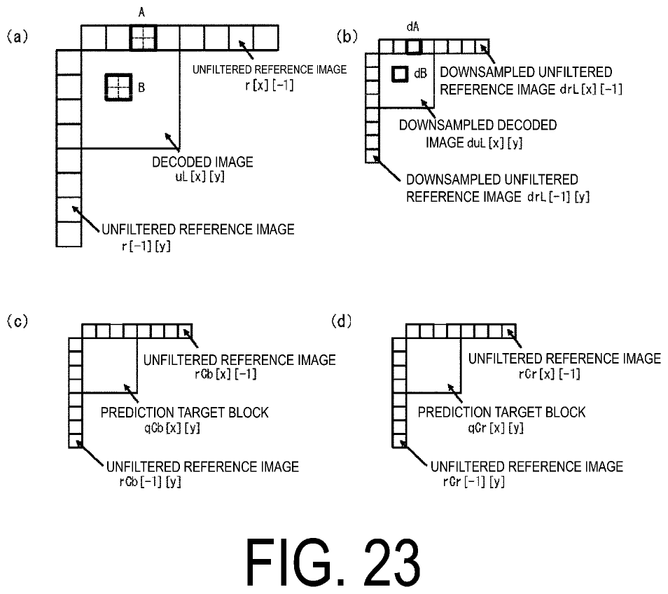

The CCLM prediction process will be described with reference to FIG. 23. FIG. 23 is a diagram illustrating a situation in which the decoding processing for the luminance components has ended and the prediction processing of the chrominance components is performed in the target block. FIG. 23(a) is a decoded image uL [ ] [ ] of luminance components of the target block, and (c) and (d) are temporary prediction images of Cb and Cr components qCb [ ] [ ], and qCr [ ] [ ]. In FIGS. 23(a), (c), and (d), the regions rL [ ] [ ], rCb [ ] [ ], and rCr [ ] [ ] of the outside of each of the target blocks are an unfiltered reference image adjacent to each of the target blocks. FIG. 23(b) is a diagram in which the target block and the unfiltered reference image of the luminance components illustrated in FIG. 23(a) are downsampled, and duL [ ] [ ] and drL [ ] [ ] are the decoded image and the unfiltered reference image of the luminance components after downsampling. The temporary prediction images of the Cb and Cr components are generated from these downsampled luminance images duL [ ] [ ] and drL [ ] [ ].

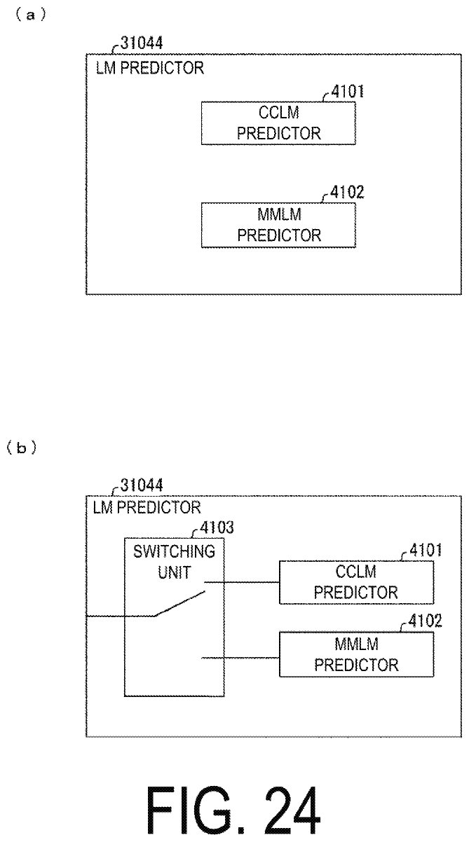

FIG. 24 is a block diagram illustrating an example of a configuration of the LM predictor 31044 included in the intra prediction image generation unit 310. As illustrated in FIG. 24(a), the LM predictor 31044 includes a CCLM predictor 4101 and an MMLM predictor 4102.

The CCLM predictor 4101 downsamples the luminance image in a case that the chrominance format is 4:2:0, and calculates the decoded image duL [ ] [ ] and the unfiltered reference image drL [ ] [ ] of the downsampled luminance components in FIG. 23(b).

Next, the CCLM predictor 4101 derives a parameter (a CCLM parameter) (a, b) of a linear model from the unfiltered reference image drL [ ] [ ] of the downsampled luminance components and the unfiltered reference images rCb [ ] [ ] and rCr [ ] [ ] of the Cb and Cr components. Specifically, the CCLM predictor 4101 calculates a linear model (aC, bC) that minimizes the square error SSD between the unfiltered reference image drL [ ] [ ] of the luminance components and the unfiltered reference image rC [ ] [ ] of the chrominance components.

SSD=ΣΣ(rC[x][y]−(aC*drL[x][y]+bC)) (Equation CCLM-3)

Here, ΣΣ is the sum of x and y. In the case of a Cb component, rC [ ] [ ] is rCb [ ] [ ], and (aC, bC) is (aCb, bCb), and in the case of a Cr component, rC [ ] [ ] is rCr [ ] [ ], and (aC, bC) is (aCr, bCr).

The CCLM predictor 4101 also calculates a linear model aResi that minimizes the square error SSD between the unfiltered reference image rCb [ ] [ ] of the Cb components and the unfiltered reference image rCr [ ] [ ] of the Cr components, in order to utilize the correlation of the prediction error of the Cb components and the Cr components.

SSD=ΣΣ(rCr[x][y]−(aResi*rCb[x][y]) (Equation CCLM-4)

Here, ΣΣ is the sum for x and y. These CCLM parameters are used to generate the temporary prediction images qCb [ ] [ ] and qCr [ ] [ ] of the chrominance components in the following equation.

qCb[x][y]=aCb*duL[x][y]+bCb

qCr[x][y]=aCr*duL[x]+aResi*ResiCb[x][y]+bCr (Equation CCLM-5)

Here, ResiCb [ ] [ ] is a prediction error of the Cb components.

The MMLM predictor 4102 is used in a case that the relationship between the unfiltered reference images between the luminance components and the chrominance components is categorized into two or more linear models. In a case that there are multiple regions in the target block, such as foreground and background, the linear model between the luminance components and the chrominance components differs in each region. In such a case, multiple linear models can be used to generate a temporary prediction image of the chrominance components from the decoded image of the luminance components. For example, in a case that there are two linear models, the pixel values of the unfiltered reference image of the luminance components are divided into two categories at a certain threshold value th_mmlm, and the linear models that minimizes the square error SSD between the unfiltered reference image drL [ ] [ ] of the luminance components and the unfiltered reference image rC [ ] [ ] of the chrominance components are calculated for each of category 1 in which the pixel value is equal to or less that a threshold value th_mmlm, and category 2 in which the pixel value is greater than the threshold value th_mmlm.

SSD1=ΣΣ(rC[x][y]−(a1C*drL[x][y]+b1))(if drL[x][y]<=th_mmlm)

SSD2=ΣΣ(rC[x][y]−(a2C*drL[x][y]+b2))(if drL[x][y]th_mmlm) (Equation CCLM-6)

Here, ΣΣ is the sum of x and y, and rC [ ] [ ] is rCb [ ] [ ], and (a1C, b1C) is (a1Cb, b1Cb) for a Cb component, and rC [ ] [ ] is rCr [ ] [ ], and (a1C, b1C) is (a1Cr, b1Cr) for a Cr component.

MMLM has fewer samples of unfiltered reference images available for derivation of each linear model than CCLM, so that it may not operate properly in a case that the target block size is small or in a case that the number of samples is a few. Thus, as illustrated in FIG. 24(b), a switching unit 4103 is provided in the LM predictor 31044, and in a case that any of the conditions described below is satisfied, MMLM is turned off and a CCLM prediction is performed.
Target block size is equal to or less than TH_MMLMB (for example, TH_MMLMB is 8×8)
Number of samples of the unfiltered reference image rCb [ ] [ ] of the target block is less than TH_MMLMR (for example, TH_MMLMR is 4)
Unfiltered reference image of the target block is not on both the upper side and the left side of the target block (not in the rectangular slice)

These conditions can be determined by the size and position information of the target block, and thus, a notification of a flag for indicating whether CCLM or not may be omitted.

In a case that a portion of the unfiltered reference image is outside of the rectangular slice, the LM prediction may be turned off. In a block that uses an intra prediction, the flag for indicating whether a CCLM prediction or not is signalled at the beginning of the intra prediction information of the chrominance component, and thus the code amount can be reduced by not signalling the flag. That is, on and off control of CCLM is performed at a rectangular slice boundary.

Typically, in a case that the chrominance component of the target block has a higher correlation with the luminance component in the target block at the same position than the same chrominance component of adjacent blocks, an LM prediction is applied in an intra prediction to generate a more accurate prediction image and to reduce a prediction residual, so that the coding efficiency is increased. As described above, by reducing the information required for an LM prediction and making an LM prediction easier to select, a reduction in the coding efficiency can be suppressed while independently performing an intra prediction of a rectangular slice, even in a case that a reference image adjacent to the target block is outside of the rectangular slice.

Note that an LM prediction generates a temporary prediction image by using an unfiltered reference image, so that a correction process at the prediction image correction unit 3105 is not performed on the temporary prediction image of an LM prediction.

Note that the configuration described above is one example of the predictor 3104, and the configuration of the predictor 3104 is not limited to the above configuration.

### Configuration of Prediction Image Correction Unit 3105

The prediction image correction unit 3105 corrects a temporary prediction image that is the output of the predictor 3104 in accordance with the intra prediction mode. Specifically, the prediction image correction unit 3105 weighs (weighting average) an unfiltered reference image and a temporary prediction image in accordance with the distance between the reference region R and the target prediction pixel for each pixel of the temporary prediction image, and outputs a prediction image (a corrected prediction image) Pred in which the temporary prediction image is modified. Note that in some intra prediction modes, the prediction image correction unit 3105 does not correct the temporary prediction image, and the output of the predictor 3104 may be the prediction image as is. The prediction image correction unit 3105 may have a configuration to switch between the output of the predictor 3104 (the temporary prediction image, or the pre-correction prediction image), and the output of the prediction image correction unit 3105 (the prediction image, or the corrected prediction image) in accordance with a flag that is explicitly decoded from the coded data or a flag that is derived from the coding parameter.

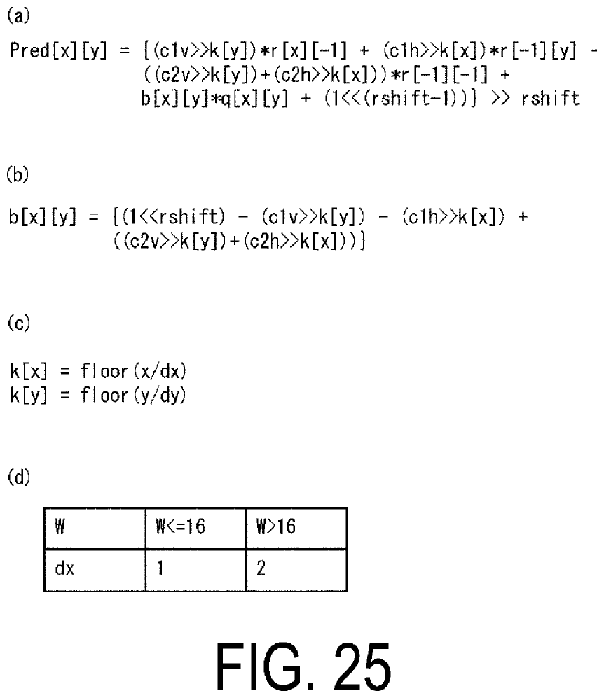

The processing for deriving the prediction pixel value Pred [x] [y] at the position (x, y) within the prediction target block by using the boundary filter at the prediction image correction unit 3105 will be described with reference to FIG. 25. (a) of FIG. 25 is a derivation equation of the prediction image Pred [x] [y]. The prediction image Pred [x][y] is derived by weighting (weighted averaging) a temporary prediction image q [x] [y]and an unfiltered reference image (for example, r [x] [−1], r [−1] [y], r [−1] [−1]). The boundary filter is a weighted addition of an unfiltered reference image and a temporary prediction image of a reference region R. Here, rshift is a prescribed positive integer value corresponding to the adjustment term for expressing the distance weight k [ ] as an integer, and is referred to as a normalization adjustment term. For example, rshift=4 to 10 is used. For example, rshift is 6.

Weighting coefficients of an unfiltered reference image are derived by right shifting reference intensity coefficients C=(c1v, c1h, c2v, c2h) predetermined for each prediction direction by a distance weight k (k [x] or k [y]) that depends on the distance (x or y) to the reference region R. More specifically, as the weighting coefficient (a first weighting coefficient w1v) of the unfiltered reference image r [x] [−1] on the upper side of the prediction target block, the reference intensity coefficient clv is shifted to the right by the distance weight k [y] (the vertical direction distance weight). As the weighting coefficient (a second weighting coefficient w1h) of the unfiltered reference image r [−1][y] on the left side of the prediction target block, the reference intensity coefficient c1h is shifted to the right by the distance weight k [x] (the horizontal direction distance weight). As the weighting coefficient (a third weighting coefficient w2) of the unfiltered reference image r [−1] [−1] in the upper left of the prediction target block, a sum of the reference intensity coefficient c2v shifted to the right by the distance weight k [y] and the reference intensity coefficient c2h shifted to the right by the distance weight k [x] is used.

FIG. 25(b) is a derivation equation of a weighting coefficient b [x] [y] for a temporary prediction pixel value q [x] [y]. The weighting coefficient b [x] [y] is derived so that the sum of the products of the weighting coefficient and the reference intensity coefficient matches (1<<rshift). This value is configured for the purpose of normalizing the product of the weighting coefficient and the reference intensity coefficient in consideration with the right shift operation of rshift in FIG. 25(a).

FIG. 25(c) is a derivation equation of a distance weight k [x]. The distance weight k [x] is set with a value floor (x/dx) that monotonically increases in accordance with the horizontal distance x between the target prediction pixel and the reference region R. Here, dx is a prescribed parameter according to the size of the prediction target block.

FIG. 25(d) illustrates an example of dx. In FIG. 25(d), dx=1 is configured in a case that the width W of the prediction target block is equal to or less than 16, and dx=2 is configured in a case that W is greater than 16.

The distance weight k [y] can utilize a definition in which the horizontal distance x is replaced by the vertical distance y in the aforementioned distance weight k [x]. The values of the distance weights k [x] and k [y] become smaller as the values of x or y is larger.

According to the derivation method of an target prediction image by using the equation described above in FIG. 25, the larger the reference distance (x, y), which is the distance between the target prediction pixel and the reference region R, the greater the value of the distance weight (k [x], k [y]). Thus, the value of the weighting coefficient for an unfiltered reference image resulting from the right shift of a prescribed reference intensity coefficient by the distance weight is a small value. Therefore, the closer the position within the prediction target block is to the reference region R, the greater the weight of the unfiltered reference image is used to derive the prediction image in which the temporary prediction image is corrected. In general, the closer to the reference region R, the more likely the unfiltered reference image is suitable as an estimate value of the target prediction block as compared to a temporary prediction image. Therefore, the prediction image derived by the equation in FIG. 25 has a higher prediction accuracy compared to a case that a temporary prediction image is used as the prediction image. In addition, according to the equation in FIG. 25, the weighting coefficient using an unfiltered reference image can be derived by multiplying the reference intensity coefficient by the distance weight. Therefore, by calculating the distance weight in advance for each reference distance and storing it in a table, the weighting coefficient can be derived without using a right shift operation or a division.

Example of Filter Mode and Reference Intensity Coefficient C The reference intensity coefficient C (c1v, c2v, c1h, c2h) of the prediction image correction unit 3105 (a boundary filter) is dependent on the intra prediction mode IntraPredMode, and is derived by reference to the table ktable corresponding to the intra prediction mode.

Note that the unfiltered reference image r [−1] [−1] is necessary for the correction processing of a prediction image, but in a case that the prediction target block shares the boundary with the rectangular slice boundary, r [−1] [−1] cannot be referred to, so the following configuration of the rectangular slice boundary boundary filter is used.

### Rectangular Slice Boundary Boundary Filter 1

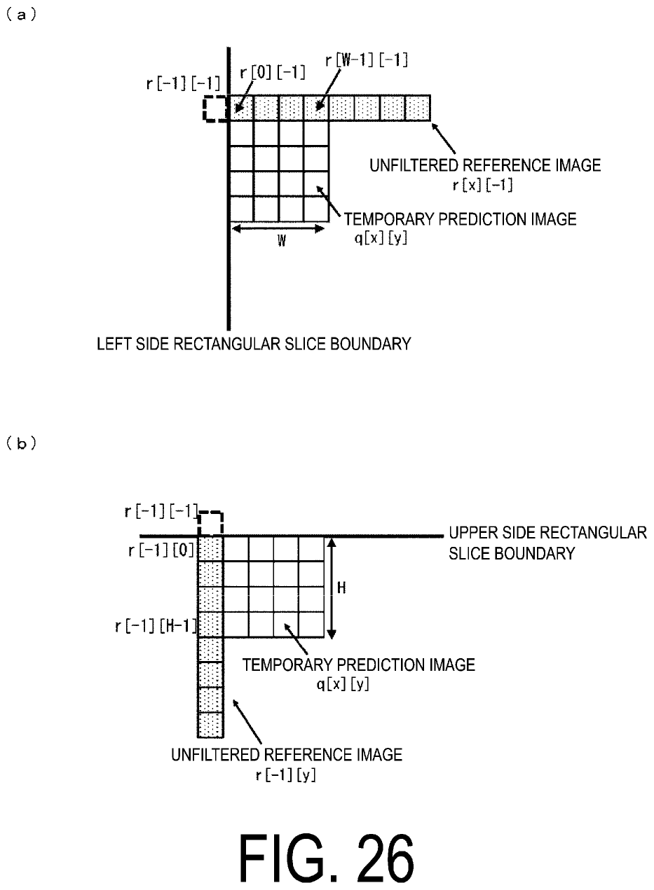

As illustrated in FIG. 26, the intra prediction image generation unit 310 uses pixels in a position that can be referred to instead of the upper left Boundary pixel r [−1] [−1] to apply a boundary filter, in a case that the prediction target block shares the boundary with the rectangular slice boundary.

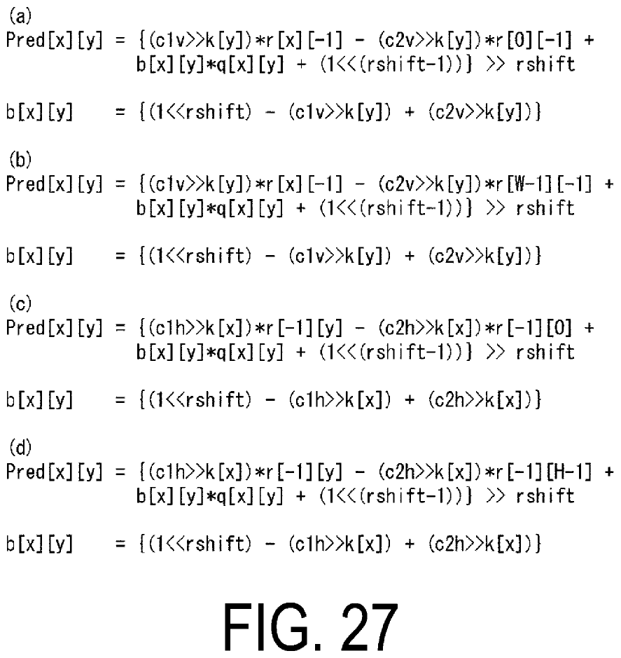

FIG. 26(a) is a diagram illustrating a process for deriving the prediction pixel value Pred [x] [y] at a position (x, y) within the prediction target block by using the boundary filter in a case that the prediction target block shares the boundary with the boundary on the left side of the rectangular slice. Blocks adjacent to the left side of the prediction target block are outside of the rectangular slice and cannot be referred to, but the pixels of the block that is adjacent to the upper side of the prediction target block can be referred to. Thus, the upper left neighboring upper boundary pixel r [0] [−1] is referred to instead of the upper left boundary pixel r [−1] [−1], and the boundary filter illustrated in FIG. 27(a) is applied instead of FIG. 25(a) or (b) to derive a prediction pixel value Pred [x] [y]. That is, the intra prediction image generation unit 310 calculates and derives the prediction image Pred [x] [y] with reference to the temporary prediction pixel q [x] [y], the upper boundary pixel r [x] [−1], and the upper left neighboring upper boundary pixel r [0] [−1] and by weighting (weighted average).

Alternatively, the upper right neighboring upper boundary pixel r [W−1] [−1] is referred to instead of the upper left boundary pixel r [−1] [−1], and the boundary filter illustrated in FIG. 27(b) is applied instead of FIG. 25(a) or (b) to derive a prediction pixel value Pred [x] [y]. Here, W is the width of the prediction target block. That is, the intra prediction image generation unit 310 calculates and derives the prediction image Pred [x][y] with reference to the temporary prediction pixel q [x] [y], the upper boundary pixel r [x] [−1], and the upper right neighboring upper boundary pixel r [W−1] [−1] by weighting (weighted average).

FIG. 26(b) is a diagram illustrating a process for deriving the prediction pixel value Pred [x] [y] at a position (x, y) within the prediction target block by using the boundary filter in a case that the prediction target block shares the boundary with the boundary on the upper side of the rectangular slice. Blocks adjacent to the upper side of the prediction target block are outside of the rectangular slice and cannot be referred to, but the pixels of the block that is adjacent to the left side of the prediction target block can be referred to. Thus, the upper left neighboring left boundary pixel r [−1] [0] is referred to instead of the upper left boundary pixel r [−1] [−1], and the boundary filter illustrated in FIG. 27(c) is applied instead of FIG. 25(a) or (b) to derive a prediction pixel value Pred [x] [y]. That is, the intra prediction image generation unit 310 calculates and derives the prediction image Pred [x] [y] with reference to the temporary prediction pixel q [x] [y], the left boundary pixel r [−1] [y], and the upper left neighboring left boundary pixel r [−1] [0] and by weighting (weighted average).

Alternatively, the lower right neighboring left boundary pixel r [−1] [H−1] is referred to instead of the upper left boundary pixel r [−1] [−1], and the boundary filter illustrated in FIG. 27(d) is applied instead of FIG. 25(a) or (b) to derive a prediction pixel value Pred [x] [y]. Here, H is the height of the prediction target block. That is, the intra prediction image generation unit 310 calculates and derives the prediction image Pred [x][y] with reference to the temporary prediction pixel q [x] [y], the left boundary pixel r [−1][y], and the lower left neighboring left boundary pixel r [−1] [H−1] and by weighting (weighted average).

In this manner, by replacing the upper left boundary pixel r [−1] [−1] with a pixel that can be referred to, it is possible to apply a boundary filter while independently performing an intra prediction to a rectangular slice even in a case that one of the left side or the upper side of the prediction target block shares the boundary with the rectangular slice boundary, so the coding efficiency is increased.

### Rectangular Slice Boundary Boundary Filter 2

A configuration will be described in which, in the unfiltered reference image configuration unit 3102 of the intra prediction image generation unit 310, a boundary filter is applied to a rectangular slice boundary by generating an unfiltered reference image from a reference image that can be referred to, in a case that an unfiltered reference image presents that cannot be referred to. In this configuration, a boundary pixel (an unfiltered reference image) r [x] [y] is derived in accordance with the process including the following steps.

Step 1: In a case that r [−1] [H*2−1] cannot be referred to, scan the pixels in sequence from (x, y)=(−1, H*2−1) to (x, y)=(−1, −1). In a case that there is a pixel r [−1] [y] that can be referred to during the scanning, the scanning is ended and r [−1] [y] is configured to r [−1] [H*2−1]. Subsequently, in a case that r [W*2−1] [−1] cannot be referred to, scan the pixels in sequence from (x, y)=(W*2−1, −1) to (x, y)=(0, −1). In a case that there is a pixel r [x] [−1] that can be referred to during the scanning, the scanning is ended and r [x] [−1] is configured to r [W*2−1] [−1].

Step 2: Scan the pixels in sequence from (x, y)=(−1, H*2−2) to (x, y)=(−1, −1), and in a case that r [−1] [y] cannot be referred to, r [−1] [y+1] is configured to r [−1] [y].

Step 3: Scan the pixels in sequence from (x, y)=(W*2−2, −1) to (x, y)=(0, −1), and in a case that r [x] [−1] cannot be referred to, r [x+1] [−1] is configured to r [x] [−1].

Note that the boundary pixel r [x] [y] cannot be referred to is a case that a reference pixel is not present in the same rectangular slice as the target pixel or is outside of the picture boundary. The above process is also referred to as a boundary pixel replacement process (unfiltered image replacement process).

The inverse quantization and inverse transform processing unit 311 performs inverse quantization on a quantization transform coefficients input from the entropy decoder 301 to calculate transform coefficients. The inverse quantization and inverse transform processing unit 311 performs inverse frequency transform such as inverse DCT, inverse DST, and inverse KLT for the calculated transform coefficients to calculate a prediction residual signal. The inverse quantization and inverse transform processing unit 311 outputs the calculated residual signal to the addition unit 312.

The addition unit 312 adds a prediction image of a PU input from the inter prediction image generation unit 309 or the intra prediction image generation unit 310 and a residual signal input from the inverse quantization and inverse transform processing unit 311 for each pixel, and generates a decoded image of a PU. The addition unit 312 outputs the generated decoded image of the block to at least one of a deblocking filter, a sample adaptive offset (SAO) unit, or ALF.

### Configuration of Inter Prediction Parameter Decoder

Next, a configuration of the inter prediction parameter decoder 303 will be described.

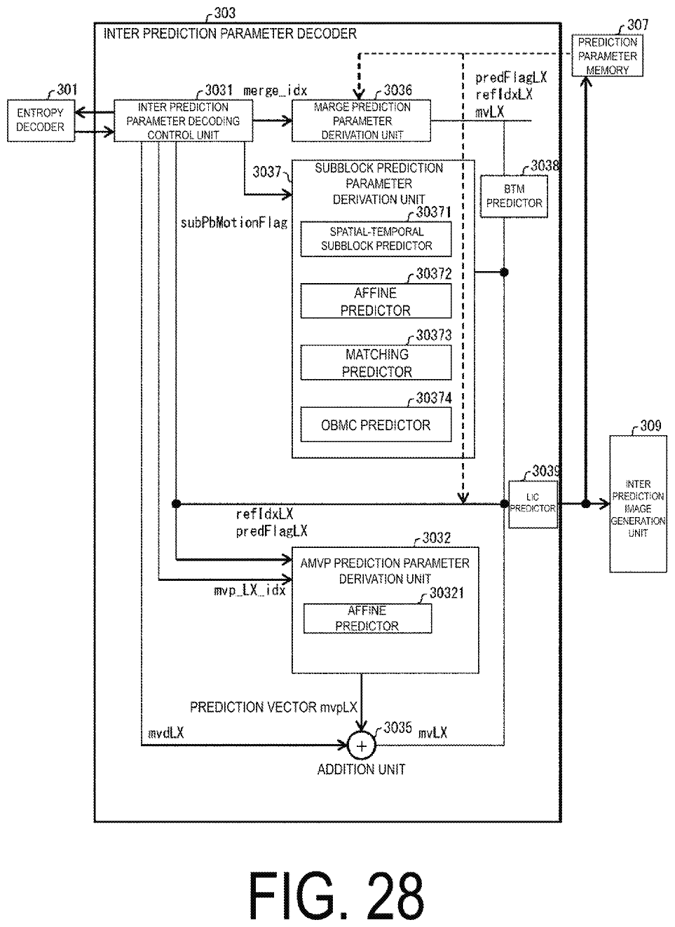

FIG. 28 is a schematic diagram illustrating a configuration of the inter prediction parameter decoder 303 according to the present embodiment. The inter prediction parameter decoder 303 includes an inter prediction parameter decoding control unit 3031, an AMVP prediction parameter derivation unit 3032, an addition unit 3035, a merge prediction parameter derivation unit 3036, a subblock prediction parameter derivation unit 3037, and a BTM predictor 3038.

The inter prediction parameter decoding control unit 3031 indicates the entropy decoder 301 to decode codes (a syntax elements) associated with an inter prediction, and extracts the codes (syntax elements) included in the coded data.

The inter prediction parameter decoding control unit 3031 first extracts the merge flag merge_flag. In a case of expressing the inter prediction parameter decoding control unit 3031 extracting a certain syntax element, it means that the inter prediction parameter decoding control unit 3031 indicates the entropy decoder 301 to decode a certain syntax element, and reads the corresponding syntax element from the coded data.

In a case that the merge flag merge_flag indicates 0, that is, an AMVP prediction mode, the inter prediction parameter decoding control unit 3031 extracts an AMVP prediction parameter from the coded data by using the entropy decoder 301. The AMVP prediction parameters include an inter prediction indicator inter_pred_idc, a reference picture index refIdxLX, a prediction vector index mvp_lX_idx, and a difference vector mvdLX, for example. The AMVP prediction parameter derivation unit 3032 derives the prediction vector mvpLX from the prediction vector index mvp_lX_idx. Details will be described below. The inter prediction parameter decoding control unit 3031 outputs the difference vector mvdLX to the addition unit 3035. In the addition unit 3035, the prediction vector mvpLX and the difference vector mvdLX are added together, and a motion vector is derived.

In a case that the merge flag merge_flag indicates 1, i.e., a merge prediction mode, the inter prediction parameter decoding control unit 3031 extracts the merge index merge_idx as a prediction parameter related to the merge prediction. The inter prediction parameter decoding control unit 3031 outputs the extracted merge index merge_idx to the merge prediction parameter derivation unit 3036 (details will be described later), and outputs a subblock prediction mode flag subPbMotionFlag to the subblock prediction parameter derivation unit 3037. The subblock prediction parameter derivation unit 3037 partitions a PU into multiple subblocks in accordance with the value of the subblock prediction mode flag subPbMotionFlag, and derives the motion vector in a subblock unit. In other words, in the subblock prediction mode, the prediction block is predicted in units of small blocks of 4×4 or 8×8. In a slice coder 2012 described below, a method of partitioning a CU into multiple partitions (PUs such as 2N×N, N×2N, N×N, and the like) and coding the syntax of the prediction parameter in partition units is used, while in the subblock prediction mode, multiple subblocks are gathered into a group (set), and the syntax of the prediction parameter is coded for each set, so that motion information of many subblocks can be coded with smaller code amount.

Specifically, the subblock prediction parameter derivation unit 3037 includes at least one of a spatial-temporal subblock predictor 30371, an affine predictor 30372, a matching motion derivation unit 30373, and an OBMC predictor 30374 that perform a subblock prediction in a subblock prediction mode.

Subblock Prediction Mode Flag Here, a method of deriving a subblock prediction mode flag subPbMotionFlag, which indicates whether or not a prediction mode for a certain PU is a subblock prediction mode in the slice decoder 2002 or the slice coder 2012 (details will be described later) will be described. The slice decoder 2002 or the slice coder 2012 derives the subblock prediction mode flag subPbMotionFlag, based on which one of a spatial subblock prediction SSUB, a temporal subblock prediction TSUB, an affine prediction AFFINE, and a matching motion derivation MAT described later to use. For example, in a case that the prediction mode selected for a certain PU is N (for example, N is a label for indicating the selected merge candidate), the subblock prediction mode flag subPbMotionFlag may be derived by the following equation.

subPbMotionFlag=(N==TSUB)∥(N==SSUB)∥(N==AFFINE)∥(N==MAT)

Here, ∥ indicates a logical sum (as below).

The slice decoder 2002 and the slice coder 2012 may be configured to perform some of the predictions of the spatial subblock prediction SSUB, the temporal subblock prediction TSUB, the affine prediction AFFINE, the matching motion derivation MAT, and the OBMC prediction OBMC. In other words, in a case that the slice decoder 2002 and the slice decoder 2002 are configured to perform the spatial subblock prediction SSUB and the affine prediction AFFINE, the subblock prediction mode flag subPbMotionFlag may be derived as described below.

subPbMotionFlag=(N==SSUB)∥(N==AFFINE)

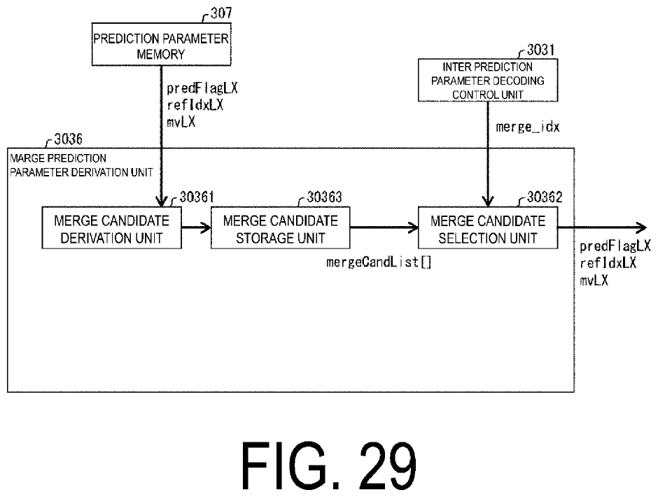

FIG. 29 is a schematic diagram illustrating a configuration of the merge prediction parameter derivation unit 3036 according to the present embodiment. The merge prediction parameter derivation unit 3036 includes a merge candidate derivation unit 30361, a merge candidate selection unit 30362, and a merge candidate storage unit 30363. The merge candidate storage unit 30363 stores the merge candidate input from the merge candidate derivation unit 30361. Note that the merge candidate includes a prediction list utilization flag predFlagLX, a motion vector mvLX, and a reference picture index refIdxLX. In the merge candidate storage unit 30363, a stored merge candidate is assigned an index according to a prescribed rule.

The merge candidate derivation unit 30361 derives a merge candidate by using the motion vector and the reference picture index refIdxLX of an adjacent PU, which has already been decoded. In addition to the above-described example, the merge candidate derivation unit 30361 may derive a merge candidate by using an affine prediction. This method will be described in detail below. The merge candidate derivation unit 30361 may use an affine prediction in a spatial merge candidate derivation process, a temporal merge candidate derivation process, a joint merge candidate derivation process, and a zero merge candidate derivation process described later. Note that the affine prediction is performed in subblock units, and the prediction parameter is stored in the prediction parameter memory 307 for each subblock. Alternatively, the affine prediction may be performed in pixel units.

### Spatial Merge Candidate Derivation Process

As a spatial merge candidate derivation process, the merge candidate derivation unit 30361 reads a prediction parameter (a prediction list utilization flag predFlagLX, a motion vector mvLX, a reference picture index refIdxLX and the like) stored in the prediction parameter memory 307 in accordance with a prescribed rule, derives the read prediction parameter as a merge candidate, and stores the prediction parameter in a merge candidate list mergeCandList [ ] (a prediction vector candidate list mvpListLX [ ]). The prediction parameter to be read is a prediction parameter related to each of PU (for example, some or all of PUs adjoining each of the lower left end, the upper left end, and the upper right end of the decoding target PU as illustrated in FIG. 20(b)) which is within a predetermined range from the decoding target PU.

### Temporal Merge Candidate Derivation Process

As a temporal merge derivation process, the merge candidate derivation unit 30361 reads a prediction parameter of the lower right (block BR) of the collocated block illustrated in FIG. 21(c) in the reference picture, or the block (block C) including the coordinate of the center of the decoding target PU from the prediction parameter memory 307 as a marge candidate to store in the merge candidate list mergeCandList [ ]. The motion vector of the block BR is more distant from the block position that would be a spatial merge candidate than the motion vector of the block C, so that the block BR is more likely to have a motion vector that is different from the motion vector of the spatial merge candidate. Therefore, in general, the block BR is added to the merge candidate list mergeCandList [ ] with priority, and the motion vector of the block C is added to the prediction vector candidate in a case that the block BR does not have a motion vector (for example, an intra prediction block) or in a case that the block BR is located outside of the picture. By adding a different motion vector as a prediction candidate, selection options of a prediction vector increase and the coding efficiency increases. The method of specifying the reference picture may be, for example, using a reference picture index refIdxLX specified in the slice header, or may be specifying by using a minimum of reference picture index refIdxLX of a PU adjacent to the decoding target PU.

For example, the merge candidate derivation unit 30361 may derive the position (xColCtr, yColCtr) of the block C and the position (xColBr, yColBr) of the block BR in the following equation.

xColCtr=xPb+(W>>1)

yColCtr=yPb+(H>>1)

xColBr=xPb+W

yColBr=yPb+H (Equation BR0)

Here, (xPb, yPb) is the upper left coordinate of the target block, and (W, H) is the width and the height of the target block.

### Rectangular Slice Boundary BR, BRmod

Incidentally, the block BR, which is one of the blocks referred to as a temporal merge candidate illustrated in FIG. 20(c), is located outside of the rectangular slice as in FIG. 20(e) in a case that the target block is located at the right end of the rectangular slice as in FIG. 20(d). Then, the merge candidate derivation unit 30361 may configure the position of the block BR to the lower right in the collocated block, as illustrated in FIG. 20(f). This position is also referred to as BRmod. For example, the position (xColBr, yColBr) of BRmod, which is a block boundary position, may be derived by the following equation.

xColBr=xPb+W−1

yColBr=yPb+H−1 (Equation BR1)

Furthermore, to make the position of BRmod a multiple of 2 to the power of M, a process of left shift may be added after the following right shift. For example, M may be 2, 3, 4 or the like. In a case that the position of reference to the motion vector is limited by this, the memory required for the storage of the motion vector can be reduced.

xColBr=((xPb+W−1)>>M)<<M

yColBr=((yPb+H−1)>>M)<<M (Equation BR2)

In a case that the target block is not located at the lower end of the rectangular slice, the merge candidate derivation unit 30361 may derive the Y coordinate yColBr of the BRmod position by (Equation BR1) and (Equation BR2) by the following equation, which is the position within the block boundary.

yColBr=yPb+H (Equation BR3)

In Equation BR3 as well, the position (the block boundary position, a position within the round block) may be configured to a multiple of 2 to the power of M.

yColBr=((yPb+H)>>M)<<M (Equation BR4)

The block BR (or BRmod) at the lower right position can be referred to as a temporal merge candidate because a block outside the rectangular slice is not referred to in the position within the block boundary or the position within the round block. Note that configuring the temporal merge candidate block BR to the position in FIG. 20(f) may be applied regardless of the position of all target blocks, or may be limited to a case that the target block is located at the right end of the rectangular slice. For example, assuming that a function for deriving SliceId at a certain position (x, y) is getSliceID (x, y), in a case of getSliceID (xColBr, yColBr)!=“SliceId of the rectangular slice including the target block”, the position of BR (BRmod) may be derived by any of the above equations. In the case of rectangular_slice_flag=1, the position of BR (BRmod) may be configured to the lower right BRmod in the collocated block. For example, the merge candidate derivation unit 30361 may derive the block BR at the block boundary position (Equation BR0) in the case of rectangular_slice_flag=0, and may derive the block BR at a position within the block boundary (Equation BR1) or (Equation BR2) in the case of rectangular_slice_flag=1.

In the case of rectangular_slice_flag=1, the merge candidate derivation unit 30361 may also derive the block BR at the round block boundary position (Equation BR3) or at the position within the block boundary (Equation BR4) in a case that the target block is not located at the lower end of the rectangular slice.

In this way, by configuring the lower right block position of the collocated block to the lower right position BRmod in the collocated rectangular slice illustrated in FIG. 20(f), in the case of rectangular_slice_flag=1, the rectangular slice sequence can be decoded independently without decreasing the coding efficiency by using a merge prediction in a temporal direction.

### Joint Merge Candidate Derivation Process

As a joint merge derivation process, the merge candidate derivation unit 30361 derives a joint merge candidate by combining a motion vector and a reference picture index of two different derived merge candidates that have already been derived and stored in the merge candidate storage unit 30363 as motion vectors for L0 and L1, respectively, and stores it in the merge candidate list mergeCandList [ ].

Note that, in a case that a motion vector derived in the spatial merge candidate derivation process, the temporal merge candidate derivation process, and the joint merge candidate derivation process described above indicates even a part of the outside of the collocated rectangular slice of the rectangular slice in which the target block is located, the motion vector may be clipped (the rectangular slice boundary motion vector limitation) to be modified to refer to only inside of the collocated rectangular slice. This process requires the slice coder 2012 and the slice decoder 2002 to select the same process.

### Zero Merge Candidate Derivation Process

As a zero merge candidate derivation process, the merge candidate derivation unit 30361 derives a merge candidate having the reference picture index refIdxLX being 0, and the X component and the Y component of the motion vector mvLX both being 0, and stores the merge candidate in the merge candidate list mergeCandList [ ].

The merge candidates described above derived by the merge candidate derivation unit 30361 are stored in the merge candidate storage unit 30363. The order of storing in the merge candidate list mergeCandList [ ] is {L, A, AR, BL, AL, BR/C, joint merge candidate, and zero merge candidate} in FIGS. 20(b) and (c). BR/C means to use the block C in a case that the block BR is not available. Note that reference blocks that are not available (the block is outside of the rectangular slice, an intra prediction, and the like) are not stored in the merge candidate list.

The merge candidate selection unit 30362 selects a merge candidate assigned with an index corresponding to the merge index merge_idx input from the inter prediction parameter decoding control unit 3031 as the inter prediction parameter of the target PU among the merge candidates stored in the merge candidate list mergeCandList [ ] of the merge candidate storage unit 30363. The merge candidate selection unit 30362 stores the selected merge candidate in the prediction parameter memory 307 and also outputs the selected merge candidate to the prediction image generation unit 308.

### Subblock Predictor

Next, the subblock predictor will be described.

### Spatial-Temporal Subblock Predictor 30371

The spatial-temporal subblock predictor 30371 derives a motion vector of a subblock which is obtained by partitioning a target PU, from a motion vector of a PU on a reference picture (for example, the immediately preceding picture) that is temporally adjacent to the target PU, or a motion vector of a PU that is spatially adjacent to the target PU. Specifically, the spatial-temporal subblock predictor 30371 derives a motion vector spMvLX [xi] [yi] for each subblock in the target PU by scaling the motion vector of a PU on the reference picture in accordance with the reference picture referred to by the target PU (a temporal subblock prediction).

The spatial-temporal subblock predictor 30371 may also derive a motion vector spMvLX [xi] [yi] for each subblock in the target PU by calculating the weighted average of the motion vector of a PU adjacent to the target PU in accordance with the distance from the subblock obtained by partitioning the target PU (a spatial subblock prediction). Here, (xPb, yPb) is the upper left coordinate of the target PU, W, H is the size of the target PU, BW, BH is the size of the subblock, and (xi, yi)=(xPb+BW*i, yPb+BH*j), i=0, 1, 2, . . . , W/BW−1, j=0, 1, 2, . . . , H/BH−1.

The candidate TSUB for a temporal subblock prediction and the candidate SSUB for a spatial subblock prediction described above are selected as one mode (a merge candidate) of merge modes.

### Motion Vector Scaling

A method of deriving the scaling of a motion vector will be described. Assuming the motion vector as Mv, the picture including the block with the motion vector My as Pic, the reference picture of the motion vector My as Ric2, the motion vector after scaling as sMv, the picture including the block with the motion vector after scaling sMv as Pict3, the reference picture referred to by the motion vector after scaling sMv as Pic4, the derivation function MvScale (Mv, Pic1, Pic2, Pic3, Pic4) of sMv is represented by the following equation.

sMv=MvScale(Mv,Pic1,Pic2,Pic3,Pic4)=Clip3(−R1,R1−1,sign(distScaleFactor*Mv)*((abs(distScaleFactor*Mv)+round1−1)>>shift1))

distScaleFactor=Clip3(−R2,R2−1,(tb*tx+round2)>>shift2)

tx=(16384+abs(td)>>1)/td

td=DiffPicOrderCnt(Pic1,Pic2)

tb=DiffPicOrderCnt(Pic3,Pic4) (Equation MVSCALE-1)

Here, round1, round2, shift1, and shift2 are rounded values and shifted values for division by using a reciprocal, such as round1=1<<(shift1−1), round2=1<<(shift2−1), shift1=8, shift2=6, and the like. DiffPicOrderCnt (Pic1, Pic2) is a function to return a difference in temporal information (for example, POC) between Pic1 and Pic2. R1, R2, and R3 are to limit the range of values to perform processing with limited accuracy, such as R1=32768, R2=4096, R3=128, and the like.

A scaling function MvScale (Mv, Pic1, Pic2, Pic3, Pic4) may also be the following equation.

MvScale(Mv,Pic1,Pic2,Pic3,Pic4)=Mv*DiffPicOrderCnt(Pic3,Pic4)/DiffPicOrderCnt(Pic1,Pic2) (Equation MVSCALE-2)

That is, Mv may be scaled depending on the ratio between the difference in temporal information between Pic1 and Pic2 and the difference in temporal information between Pic3 and Pic4.

As a specific spatial-temporal subblock prediction method, an Adaptive Temporal Motion Vector Prediction (ATMVP) and a Spatial-Temporal Motion Vector Prediction (STMVP) will be described.

### ATMVP, Rectangular Slice Boundary ATMVP

The ATMVP is a method for deriving a motion vector for each subblock of a target block, based on motion vectors of spatial adjacent blocks (L, A, AR, BL, AL) of the target block of the target picture PCur illustrated in FIG. 20(b), and for generating a prediction image in units of subblocks, and is processed by the following procedure.

### Step 1) Initial Vector Derivation

A first adjacent block available is determined in the order of the spatial adjacent blocks L, A, AR, BL, AL. In a case that an available adjacent block is found, the motion vector and the reference picture of that block are set as the initial vector IMV and the initial reference picture IRef of the ATMVP, and the process proceeds to step 2. In a case that all adjacent blocks are not available (non available), the ATMVF is turned off and the processing is terminated. The meaning of “ATMVP being turned off” is that the motion vector by the ATMVP is not stored in the merge candidate list.

Here, the meaning of an “available adjacent block” is, for example, that the position of the adjacent block is included in the target rectangular slice and the adjacent block has a motion vector.

### Step 2) Rectangular Slice Boundary Check of Initial Vector

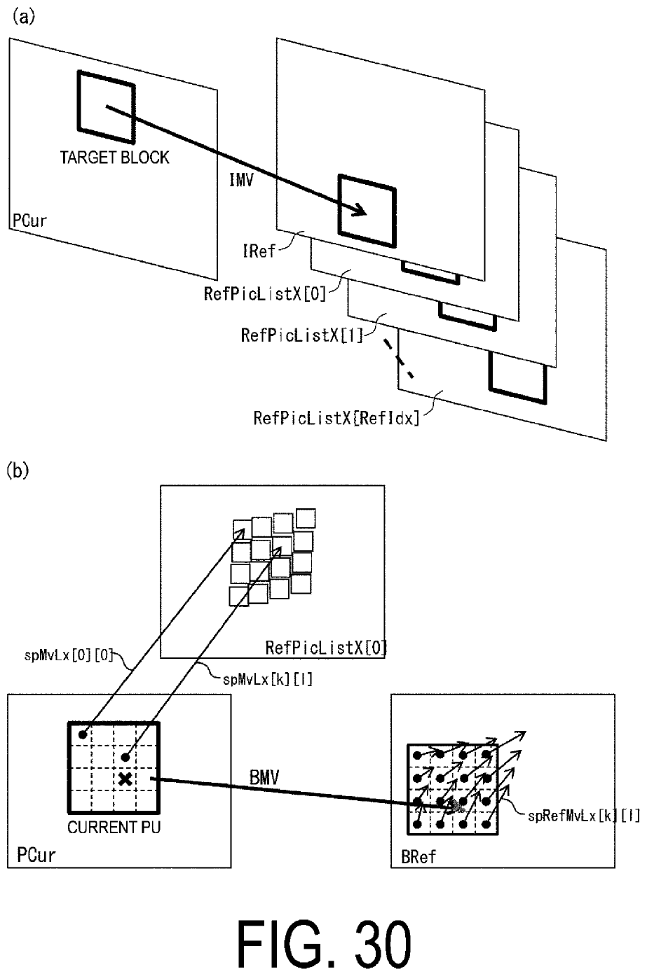

It is checked whether or not the block referred to by using IMV by the target block is within a collocated rectangular slice on the initial reference picture IRef. In a case that the block is in a collocated rectangular slice, IMV and IRef are set as the motion vector BMV and the reference picture BRef of the block level of the target block, respectively, and the process is transferred to step 3. In a case that the block is not in a collocated rectangular slice, as illustrated in FIG. 30(a), it is checked whether or not the block referred to by using the sIMV derived by using the scaling function MvScale (IMV, PCur, IRef, PCur, RefPicListX [refIdx]) from the IMV is in a collocated rectangular slice on the reference pictures RefPicListX [RefIdx] (RefIdx=0 . . . the number of reference pictures−1) stored in the reference picture list RefPicListX sequentially. In a case that the block is in a collocated rectangular slice, this sIMV and RefPicListX [RefIdx] are set as the motion vector BMV and the reference picture BRef of the block level of the target block, respectively, and the process is transferred to step 3.

Note that in a case that no such block is found in all reference pictures stored in the reference picture list, the ATMVF is turned off and the process is terminated.

### Step 3) Subblock Motion Vector

As illustrated in FIG. 30(b), on the reference picture BRef, for the target block, a block at a position shifted by the motion vector BMV is partitioned into subblocks, and a motion vector SpRefMvLX [k] [l] (k=0 . . . NBW−1, l=0 . . . NBH−1) and a reference picture SpRef [k] [l] of each subblock are obtained. Here, the NBW and the NBH are the number of subblocks in the horizontal and vertical directions, respectively. In a case that a motion vector of a certain subblock (k1, l1) does not exist, the motion vector BMV and the reference picture BRef of the block level are set as the motion vector SpRefMvLX [k1] [l1] and the reference picture SpRef [k1] [l1] of the subblock (k1, l1).

### Step 4) Motion Vector Scaling

A motion vector SpMvLX [k] [l] for each subblock on the target block is derived by the scaling function MvScale ( ) from a motion vector SpRefMvLX [k] [l] and a reference picture SpRef [k] [l] of each subblock on the reference picture.

SpMvLX[k][l]=MvScale(SpRefMvLX[k][l],Bref,SpRef[k][l],PCur,RefPicListX[refIdx0]) (Equation ATMVP-1)

Here, RefPicListX [refIdx0] is a reference picture of the subblock level of the target block, such as the reference picture RefPicListX [refIdxATMVP], refIdxATMVP=0.

Note that the reference picture of the subblock level of the target block may not be the reference picture RefPicListX [refIdx0], but a reference picture specified by the index (collocated_ref_idx) used for prediction motion vector derivation in a temporal direction signalled in the slice header illustrated in FIG. 8 (SYN03) and FIG. 11(a) (SYN13). In this case, the reference picture of the subblock level of the target block is RefPicListX [collocated_ref_idx], and the calculation equation for the motion vector SpMvLX [k] [l]of the subblock level of the target block is described below.

SpMvLX[k][l]=MvScale(SpRefMvLX[k][l],Bref,SpRef[k][l],PCur,RefPicListX[collocated_ref_idx]) (Equation ATMVP-2)

### Step 5) Rectangular Slice Boundary Check of Subblock Vector

In the reference picture of the subblock level of the target block, it is checked whether or not the subblock to which the target subblock refers by using SpMvLX [k] [l]is within a collocated rectangular slice. In a case that the target pointed by a subblock motion vector SpMvLX [k2] [l2] is not in a collocated rectangular slice in a certain subblock (k2, l2), any of the following processing 1 (processing 1A to processing 1D) is performed.

[Processing 1A] Rectangular Slice Boundary Padding

Rectangular slice boundary padding (rectangular slice outside padding) is achieved by clipping the reference positions at the positions of the upper, lower, left, and right bounding pixels of the rectangular slice, as previously described. For example, in a case that the upper left coordinate of the target subblock relative to the upper left coordinate of the picture is (xs, ys), the width and the height of the target subblock are BW and BW, the upper left coordinate of the target rectangular slice in which the target subblock is located is (xRSs, yRSs), the width and the height of the target rectangular slice are wTRS and hRS, and the motion vector is spMvLX [k2] [l2], the reference pixel (xRef, yRef) of the subblock level is derived with the following equation.

xRef+i=Clip3(xRSs,xRSs+wRS−1,xs+(SpMvLX[k2][l2][0]>>log 2(M))+i)

yRef+j=Clip3(yRSs,yRSs+hRS−1,ys+(SpMvLX[k2][l2][1]>>log 2(M))+j) (Equation ATMVP-3)

[Processing 1B] Rectangular Slice Boundary Motion Vector Limitation (Rectangular Slice Outside Motion Vector Limitation)

The subblock motion vector SpMvLX [k2] [l2] is clipped so that the motion vector SpMvLX [k2] [l2] of the subblock level does not refer to outside of the rectangular slice. For the rectangular slice boundary motion vector limitations, there are methods such as, for example, (Equation CLIP1) to (Equation CLIP5) described above.

[Processing 1C] Rectangular Slice Boundary Motion Vector Replacement (Replacement by Alternative Motion Vector Outside of Rectangular Slice)

In a case that the target pointed by the subblock motion vector SpMvLX [k2] [l2] is not inside of a collocated rectangular slice, an alternative motion vector SpMvLX [k3] [l3] inside of a collocated rectangular slice is copied. For example, (k3, l3) may be an adjacent subblock of (k2, l2) or a center of the block.

SpMvLX[k2][l2][0]=SpMvLX[k3][l3][0]

SpMvLX[k2][l2][1]=SpMvLX[k3][l3][1] (Equation ATMVP-4)

[Processing 1D] Rectangular Slice Boundary ATMVP Off (Rectangular Slice Outside ATMVP Off)

In a case that the number of subblocks in which the target pointed by the subblock motion vector SpMvLX [k2] [l2] is not within a collocated rectangular slice exceeds a prescribed threshold value, the ATMVP is turned off and the process is terminated. For example, the prescribed threshold value may be ½ of the total number of subblocks within the target block.

Note that the processing 1 requires the slice coder 2012 and the slice decoder 2002 to select the same process.

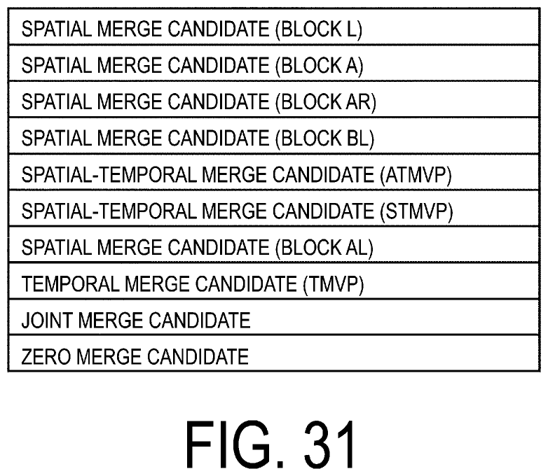

Step 6) The ATMVP is stored in the merge candidate list. An example of the order of the merge candidates stored in the merge candidate list is illustrated in FIG. 31. From among this list, a merge candidate for the target block is selected by using the merge_idx derived by the inter prediction parameter decoding control unit 3031.

In a case that the ATMVP is selected as a merge candidate, an image on the reference picture RefPicListX [refIdxATMVP] shifted by SpMvLX [k] [l] from each subblock of the target block is read as a prediction image as illustrated in FIG. 30(b).

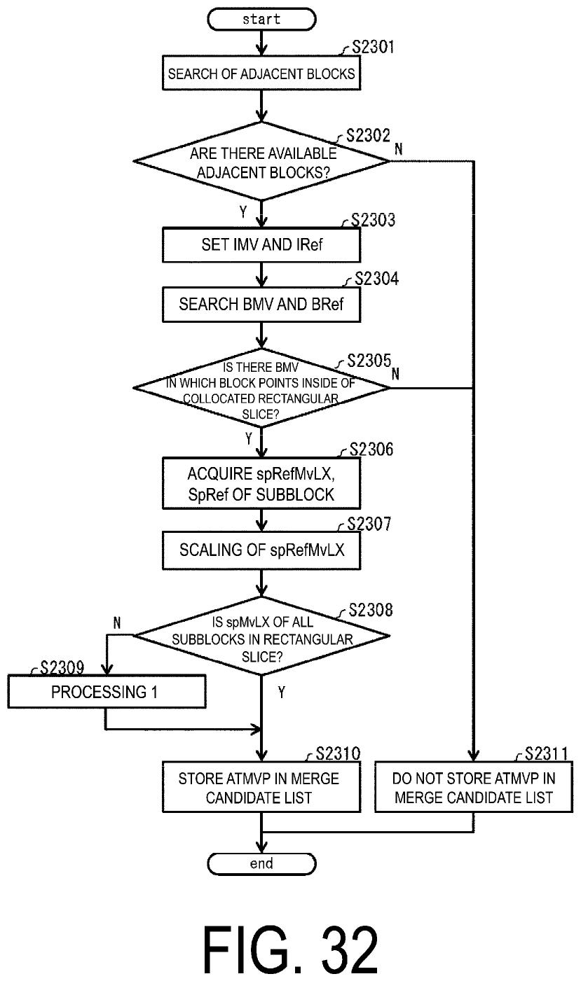

The merge candidate list derivation process related to ATMVP described in steps 1) to 6) will be described with reference to the flowchart of FIG. 32.

The spatial-temporal subblock predictor 30371 searches five adjacent blocks of the target block (S2301).

The spatial-temporal subblock predictor 30371 determines the presence or absence of a first available adjacent block, and the process proceeds to S2303 in a case that there is an available adjacent block, and the process proceeds to S2311 in a case that there is no available adjacent block (S2302).

The spatial-temporal subblock predictor 30371 configures the motion vector and the reference picture of the available adjacent block as the initial vector IMV and the initial reference picture IRef of the target block (S2303).

The spatial-temporal subblock predictor 30371 searches a block based motion vector BMV and a reference picture BRef of the target block, based on the initial vector IMV and the initial reference picture IRef of the target block (S2304).

The spatial-temporal subblock predictor 30371 determines the presence or absence of a block based motion vector BMV by which the reference block points within a collocated rectangular slice, and in a case that there is a BMV, BRef is acquired and the process proceeds to S2306, and in a case that there is no BMV, the process proceeds to S2311 (S2305).

The spatial-temporal subblock predictor 30371 acquires a subblock based motion vector SpRefMvLX [k] [l] and a reference picture SpRef [k] [l] of a collocated block by using the block based motion vector BMV and the reference picture BRef of the target block (S2306).

The spatial-temporal subblock predictor 30371 derives the subblock based motion vector spMvLX [k] [l] of the target block by scaling, in a case of the reference picture configured to RefPicListX [refIdxATMVP], by using the motion vector SpRefMvLX [k][l] and the reference picture SpRef (S2307).

The spatial-temporal subblock predictor 30371 determines whether or not each of the blocks pointed by the motion vector spMvLX [k] [l] all refers inside of a collocated rectangular slice on the reference picture RefPicListX [refIdxATMVP]. In a case that all of the blocks refer only inside of the collocated rectangular slice, the process proceeds to S2310, or otherwise the process proceeds to S2309 (S2308).

In a case that at least some of the blocks shifted by motion vector spMvLX [k] [l]are outside of the collocated rectangular slice, the spatial-temporal subblock predictor 30371 copies the motion vector of the subblock level of the adjacent subblocks, having the motion vector of the subblock level in which the subblock after shift is inside of the collocated rectangular slice (S2309).

The spatial-temporal subblock predictor 30371 stores the motion vector of the ATMVP in the merge candidate list mergeCandList [ ] illustrated in FIG. 31 (S2310).

The spatial-temporal subblock predictor 30371 does not store the motion vector of the ATMVP in the merge candidate list mergeCandList [ ] (S2311).

Note that, in addition to copying the motion vectors of the adjacent blocks, the processing of S2309 may be a padding processing of the rectangular slice boundary of the reference picture or a clipping processing of the motion vector of the subblock level of the target block, as described in step 5). The ATMVP may also be turned off and the process may proceed to S2311 in a case that the number of subblocks that are not available is greater than a prescribed threshold value.

By the above process, the merge candidate list related to the ATMVP is derived.

By deriving the motion vector of the ATMVP and generating the prediction image in this manner, the pixel values can be replaced by using the reference pixels in the collocated rectangular slice even in a case that the motion vector points outside of the collocated rectangular slice for an inter prediction, so that the inter prediction can be performed independently on the rectangular slice. Thus, even in a case that some of the reference pixels are not included in the collocated rectangular slice, an ATMVP can be selected as one of the merge candidates. In a case that the performance is higher than that of a merge candidate other than an ATMVP, the ATMVP can be used to generate the prediction image, so that the coding efficiency can be increased.

### STMVP

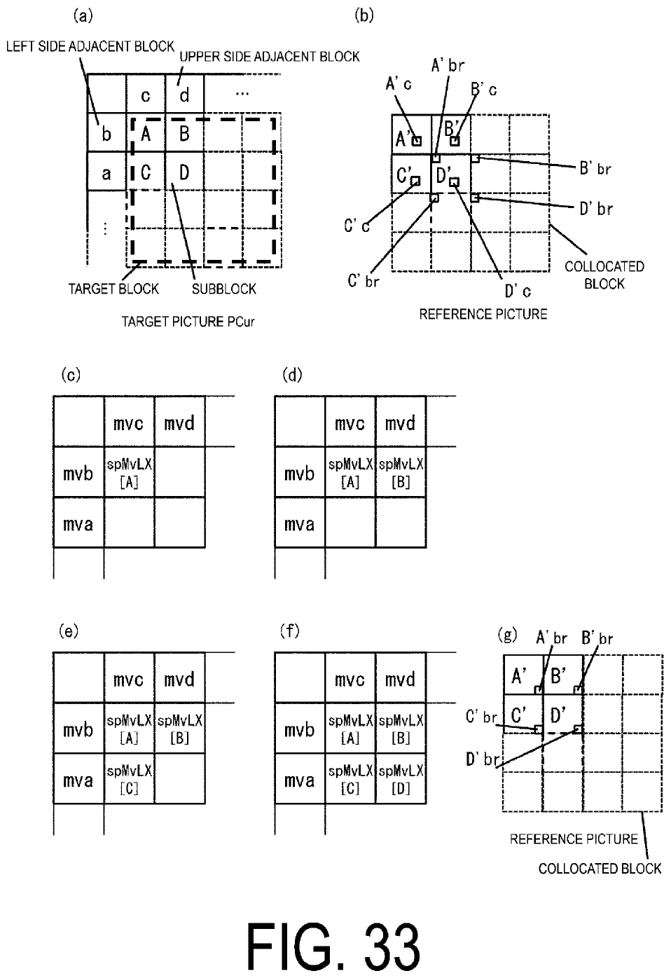

The STMVP is a scheme to derive a motion vector for each subblock of the target block, and generate a prediction image in units of subblocks, based on the motion vectors of the spatial adjacent blocks (a, b, c, d, . . . ) of the target block of the target picture PCur illustrated in FIG. 33(a), and the collocated blocks (A′, B′, C′, D′, . . . ) of the target block illustrated in FIG. 33(b). A, B, C, and D in FIG. 33(a) are examples of subblocks into which the target block is partitioned. A′, B′, C′, and D′ in FIG. 33(b) are the collocated blocks of the subblocks A, B, C, and D in FIG. 33(a). Ac′, Bc′, Cc′, and Dc′ in FIG. 33(b) are regions located in the center of A′, B′, C′, and D′, and Abr′, Bbr′, Cbr′, and Dbr′ are regions located at the lower right of A′, B′, C′, and D′. Note that Abr′, Bbr′, Cbr′, and Dbr′ may be not in the lower right positions outside of A′, B′, C′, and D′ illustrated in FIG. 33(b), but may be in the lower right positions inside of A′, B′, C′, and D′ illustrated in FIG. 33(g). In FIG. 33(g), Abr′, Bbr′, Cbr′, and Dbr′ take positions within the collocated rectangular slices. The STMVP is processed with the following procedure.

Step 1) The target block is partitioned into subblocks, and a first available block is determined from the upper adjacent block of the subblock A in the right direction. In a case that an available adjacent block is found, the motion vector and the reference picture of that first block is set as the upper vector mvA_above and the reference picture RefA_above of the STMVP, with the count cnt=1. In a case that there is no available adjacent block, the count is set as cnt=0.

Step 2) An available first block is determined from the left side adjacent block b of the subblock A in the downward direction. In a case that an available adjacent block is found, the motion vector and the reference picture of that first block are set as the left side vector mvA_left and the reference picture RefA_left, and the count cnt is incremented by one. In a case that there is no available adjacent block, the count cnt is not updated.

Step 3) It is checked whether or not a block is available in the collocated block A′ of the subblock A in the order of the lower right position A′br and the A′c. In a case that an available region is found, the first motion vector and the reference picture in that block are set as the collocated vector mvA_col and the reference picture RefA_col, and the count is incremented by one. In a case that there is no available block, the count cnt is not updated.

Step 4) In a case of cnt=0 (there is no available motion vector), the STMVP is turned off and the processing is terminated.

Step 5) In a case that ctn is not 0, the temporal information of the target picture PCur and the reference picture RefPicListX [collocated_ref_idx] of the target block is used to scale the available motion vectors found in steps 1) to 3). The scaled motion vectors are denoted as smvA_above, smvA_left, and smvA_col.

smvA_above=MvScale(mvA_above,PCur,RefA_above,PCur,RefPicListX[collocated_ref_idx])

smvA_left=MvScale(mvA_left,PCur,RefA_left,PCur,RefPicListX[collocated_ref_idx])

smvA_col=MvScale(mvA_col,PCur,RefA_col,PCur,RefPicListX[collocated_ref_idx]) (Equation STMVP-1)

An unavailable motion vector is set to 0.

Here, the scaling function MvScale (Mv, Pic1, Pic2, Pic3, Pic4) is a function for scaling the motion vector My as described above.

Step 6) The average of smvA_above, smvA_left, and smvA_col is calculated and set as the motion vector spMvLX [A] of the subblock A. The reference picture of the subblock A is RcfPicListX [collocated_ref_idx].

SpMvLX[A]=(smvA_above+smvA_left+smvA_col)/cnt (Equation STMVP-2)

For integer computation, for example, it may be derived as follows. In a case of cnt==2, two vectors are described sequentially as mvA_cnt0, mvA_cnt1, which may be derived in the following equation.

SpMvLX[A]=(smvA_cnt0+smvA_cnt1)>>1

In a case of cnt==3, it may be derived by the following equation.

SpMvLX[A]=(5*smvA_above+5*smvA_left+6*smvA_col)>>4

Step 7) In the reference picture RefPicListX [collocated_ref_idx], it is checked whether or not the block at the position in which the collocated block is shifted by spMvLX [A] is within the collocated rectangular slice. In a case that some or all of the blocks are not in the collocated rectangular slice, any of the following processing 2 (processing 2A to processing 2D) is performed.

[Processing 2A] Rectangular Slice Boundary Padding

Rectangular slice boundary padding (rectangular slice outside padding) is achieved by clipping the reference positions at the positions of the upper, lower, left, and right bounding pixels of the rectangular slice, as previously described. For example, in a case that the upper left coordinate of the subblock A relative to the upper left coordinate of the picture is (xs, ys), the width and the height of the subblock A are BW and BH, the upper left coordinate of the target rectangle slice in which the subblock A is located is (xRSs, yRSs), and the width and the height of the target rectangular slice are wRS and hRS, the reference pixel (xRef, yRef) of the subblock A is derived with the following equation.

xRef+i=Clip3(xRSs,xRSs+wRS−1,xs+(spMvLX[A][0]>>log 2(M))+i)

yRef+j=Clip3(yRSs,yRSs+hRS−1,ys+(spMvLX[A][1]>>log 2(M))+j) (Equation STMVP-3)

Note that the processing 2 requires the slice coder 2012 and the slice decoder 2002 to select the same process.

[Processing 2B] Rectangular Slice Boundary Motion Vector Limitation

The subblock motion vector spMvLX [A] is clipped so that the motion vector spMvLX [A] of the subblock level does not refer to outside of the rectangular slice. For the rectangular slice boundary motion vector limitations, there are methods such as, for example, (Equation CLIP1) to (Equation CLIP5) described above.

[Processing 2C] Rectangular Slice Boundary Motion Vector Replacement (Replacement by Alternative Motion Vector)

In a case that the target pointed by the subblock motion vector SpMvLX [k2] [l2] is not inside of a collocated rectangular slice, an alternative motion vector SpMvLX [k3][l3] inside of a collocated rectangular slice is copied. For example, (k3, l3) may be an adjacent subblock of (k2, l2) or a center of the block.

SpMvLX[k2][l2][0]=SpMvLX[k3][l3][0]

SpMvLX[k2][l2][1]=SpMvLX[k3][l3][1] (Equation STMVP-4)

[Processing 2D] Rectangular Slice Boundary STMVP Off

In a case that the number of subblocks in which the target pointed by the subblock motion vector SpMvLX [k2] [l2] is not within a collocated rectangular slice exceeds a prescribed threshold value, the STMVP is turned off and the process is terminated. For example, the prescribed threshold value may be ½ of the total number of subblocks within the target block.

Step 8) The processes in steps 1) to 7) described above are performed on each subblock of the target block, such as the subblocks B, C, and D, and the motion vectors of the subblocks are determined as in FIGS. 33(d), (e), and (f). However, in the subblock B, an upper side adjacent block is searched from d to the right direction. In the subblock C, the upper side adjacent block is A, and a left side adjacent block is searched from a in the downward direction. In the subblock D, the upper side adjacent block is B, and the left side adjacent block is C.

Step 9) The motion vectors of the STMVP are stored in the merge candidate list. The order of the merge candidates stored in the merge candidate list is illustrated in FIG. 31. From among this list, a merge candidate for the target block is selected by using the merge_idx derived by the inter prediction parameter decoding control unit 3031.

In a case that the STMVP is selected as a merge candidate, an image on the reference picture RefPicListX [collocated_ref_idx] shifted by the motion vector from each subblock of the target block is read as a prediction image.

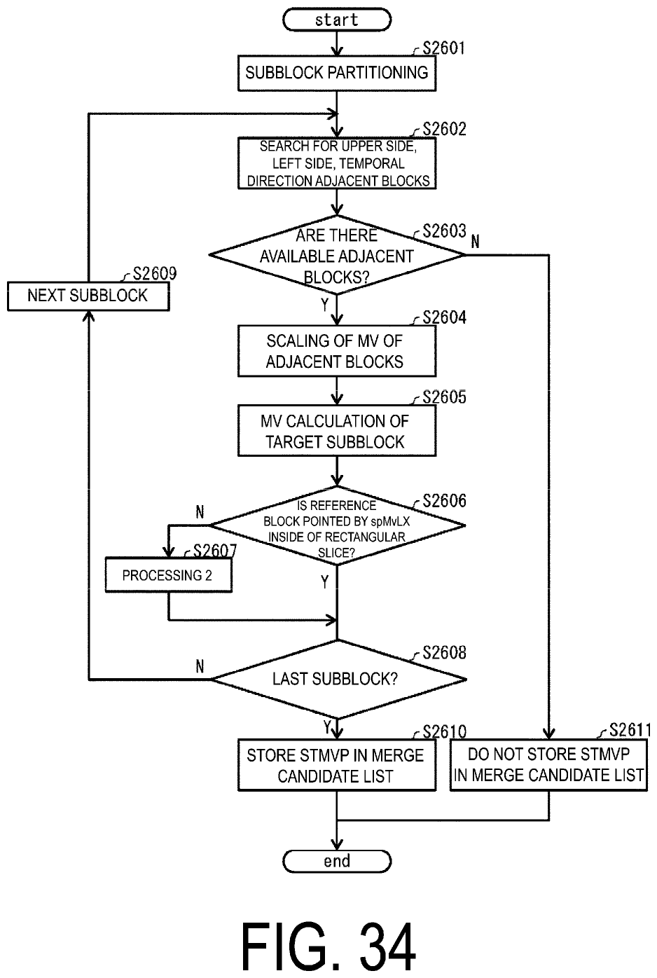

The merge candidate list derivation process related to STMVP described in steps 1) to 9) will be described with reference to the flowchart of FIG. 34(a).

The spatial-temporal subblock predictor 30371 partitions the target block into subblocks (S2601).

The spatial-temporal subblock predictor 30371 searches adjacent blocks on the upper side and the left side, and in the temporal direction of the subblocks (S2602).

The spatial-temporal subblock predictor 30371 determines the presence or absence of an available adjacent block, and the process proceeds to S2604 in a case that there is an available adjacent block, and the process proceeds to S2610 in a case that there is no available adjacent block (S2603).

The spatial-temporal subblock predictor 30371 scales the motion vectors of the available adjacent blocks depending on the temporal distance between the target picture and the reference pictures of the multiple adjacent blocks (S2604).

The spatial-temporal subblock predictor 30371 calculates an average value of the scaled motion vectors to set as the motion vector spMvLX [ ] of the target subblock (S2605).

The spatial-temporal subblock predictor 30371 determines whether or not a block in which the collocated subblock on the reference picture is shifted by the motion vector spMvLX [ ] is inside of the collocated rectangular slice, and in a case that the block is inside of the collocated rectangular slice, the process proceeds to S2608, and in a case that even a portion is not inside of the collocated rectangular slice, the process proceeds to S2607 (S2606).

The spatial-temporal subblock predictor 30371 clips the motion vector spMvLX [ ] in a case that the block shifted by the motion vector spMvLX [ ] is outside of the collocated rectangular slice (S2607).

The spatial-temporal subblock predictor 30371 checks whether or not the subblock during processing is the last subblock of the target block (S2608), and the process proceeds to S2610 in a case of the last subblock, and otherwise the processing target is transferred to the next subblock and the process proceeds to S2602 (S2609), and S2602 to S2608 are processed repeatedly.

The spatial-temporal subblock predictor 30371 stores the motion vector of the STMVP in the merge candidate list mergeCandList [ ] illustrated in FIG. 31 (S2610).

The spatial-temporal subblock predictor 30371 does not store the motion vector of the STMVP in the merge candidate list mergeCandList [ ] in a case that there is no available motion vector, and the process is terminated (S2611).

Note that, in addition to the clipping process of the motion vector of the target subblock, the processing of S2607 may be a padding process of the rectangular slice boundary of the reference picture, as described in 7).

By the above process, the merge candidate list related to the STMVP is derived.

By deriving the motion vector of the STMVP and generating the prediction image in this manner, the pixel values can be replaced by using the reference pixels in the collocated rectangular slice even in a case that the motion vector points outside of the collocated rectangular slice for an inter prediction, so that the inter prediction can be performed independently on the rectangular slice. Thus, even in a case that some of the reference pixels are not included in the collocated rectangular slice, an STMVP can be selected as one of the merge candidates. In a case that the performance is higher than that of a merge candidate other than an STMVP, the STMVP can be used to generate the prediction image, so that the coding efficiency can be increased.

### Affine Predictor

The affine predictors 30372 and 30321 derive an affine prediction parameter of the target PU. In the present embodiment, motion vectors (mv0_x, mv0_y) and (mv1_x, mv1_y) of two control points (V0, V1) of the target PU is derived as affine prediction parameters. Specifically, a motion vector of each control point may be derived by prediction from a motion vector of an adjacent PU of the target PU (the affine predictor 30372), or a motion vector of each control point may be derived from the sum of the prediction vector derived as the motion vector of the control point and the difference vector derived from the coded data (the affine predictor 30321).

### Motion Vector Derivation Process of Subblock

As a further specific example of an embodiment configuration, a processing flow in which the affine predictors 30372 and 30321 derive the motion vector mvLX of each subblock by using the affine prediction will be described in steps below. The process in which the affine predictors 30372 and 30321 use the affine prediction to derive the motion vector mvLX of the target subblock includes three steps of (STEP 1) to (STEP 3) described below.

### (STEP1) Derivation of Control Point Vector

This is a process of deriving a motion vector of each of the representative points of the target block (here, the upper left point V of the block and the upper right point V1 of the block) as two control points used in the affine prediction for deriving the candidate by the affine predictors 30372 and 30321. Note that a representative point of the block uses a point on the target block. In the present specification, a representative point of a block used for a control point of an affine prediction is referred to as a “block control point”.

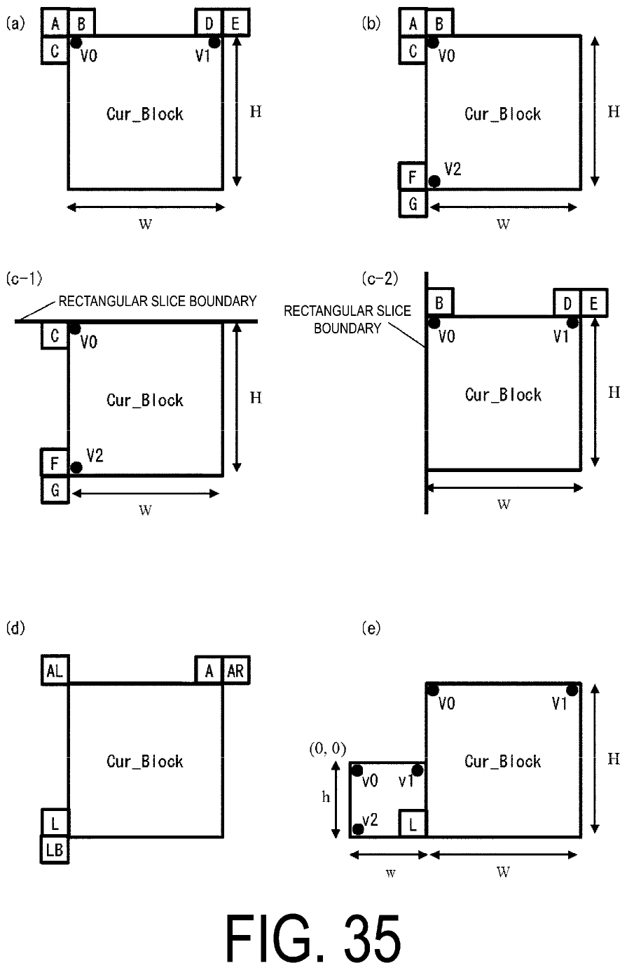

First, each of the processes of the AMVP mode and the merge mode (STEP1) will be described with reference to FIG. 35, respectively. FIG. 35 is a diagram illustrating an example of a position of a reference block utilized for derivation of a motion vector for a control point in the AMVP mode and the merge mode.

### Derivation of Motion Vector of Control Point in AMVP Mode

The affine predictor 30321 adds a prediction vector mvpVNLX and a difference vector of two control points (V0, V1) to derive a motion vector mvN=(mvN_x, mvN_y), respectively. N represents a control point.

More specifically, the affine predictor 30321 derives a prediction vector candidate of a control point VN (N=0 . . . 1) to store in the prediction vector candidate list mvpListVNLX [ ]. Furthermore, the affine predictor 30321 derives a prediction vector index mvpVN_LX_idx of the point VN from the coded data, and a motion vector (mvN_x, mvN_y) of the control point VN from a difference vector mvdVNLX by using the following equation.

mvN_x=mvNLX[0]=mvpListVNLX[mvpVN_LX_idx][0]+mvdVNLX[0]

mvN_y=mvNLX[1]=mvpListVNLX[mvpVN_LX_idx][1]+mvdVNLX[1] (Equation AFFIN-1)

As illustrated in FIG. 35(a), the affine predictor 30321 selects either of the blocks A, B, and C adjacent to one of the representative points as a reference block (an AMVP reference block) with reference to mvpV0_LX_idx. Then, the motion vector of the selected AMVP reference block is set as the prediction vector mvpV0LX of the representative point V0. Furthermore, the affine predictor 30321 selects either of the blocks D and E as an AMVP reference block with reference to mvpV1_LX_idx. Then, the motion vector of the selected AMVP reference block is set as the prediction vector mvpV1LX of the representative point V1. Note that a position of a control point in (STEP1) is not limited to the above position, and instead of V1 may be the position of the lower left point V2 of the block illustrated in FIG. 35(b). In this case, any of the blocks F and G is selected as an AMVP reference block with reference to mvpV2_LX_idx. Then, the motion vector of the selected AMVP reference block is set as the prediction vector mvpV2LX of the representative point V2.

For example, as in FIG. 35 (c-2), in a case that the left side of the target block shares the boundary with the rectangular slice boundary, the control points are V0 and V1, and the reference block of the control point V0 is B. In this case, mvpV_L0_idx is not required. Note that, in a case that the reference block B is an intra prediction, the affine prediction may be turned off (the affine prediction is not performed, affine_flag=0), or the affine prediction may be performed by coping the prediction vector of the control point VI as the prediction vector of the control point V0. These may be processed the same as the affine predictor 11221 of the slice coder 2012.

As in FIG. 35 (c-1), in a case that the upper side of the target block shares the boundary with the rectangular slice boundary, the control points are V0 and V2, and the reference block of the control point V0 is C. In this case, mvpV0_L0_idx is not required. Note that, in a case that the reference block C is an intra prediction, the affine prediction may be turned off (the affine prediction is not performed), or the affine prediction may be performed by coping the prediction vector of the control point V2 as the prediction vector of the control point V0. These may be processed the same as the affine predictor 11221 of the slice coder 2012.

### Derivation of Motion Vector of Control Point in Merge Mode

The affine predictor 30372 refers to the prediction parameter memory 307 to check whether or not an affine prediction is used for the blocks including L, A, AR, LB, and AL as illustrated in FIG. 35(d). The affine predictor 30372 searches the blocks L, A, AR, LB, and AL in that order, and selects a first found block that utilizes an affine prediction (referred to here as L in FIG. 35(d)) as a reference block (a merge reference block) to derive a motion vector.

The affine predictor 30372 derives a motion vector (mvN_x, mvN_y) (N=0 . . . 1) of a control point (for example V0 or V1) from motion vectors (mvvN_x, mvvN_y) (N=0 . . . 2) of the block including three points of the selected merge reference block (the point v0, the point v1, and the point v2 in FIG. 35(e)). Note that in the example illustrated in FIG. 35(e), the horizontal width of the target block is W, the height is H, and the lateral width of the merge reference block (the block including L in the example illustrated in the drawing) is w and the height is h.

mv0_x=mv0LX[0]=mvv0_x+(mvv1_x−mvv0_x)/w*w−(mvv2_y−mvv0_y)/h*(h−H)

mv_y=mv0LX[1]=mvv0_y+(mvv2_y−mvv0_y)/h*w+(mvv1_x−mvv0_x)/w*(h−H)

my1_x=mv1LX[0]=mvv0_x+(mvv1_x−mvv0_x)/w*(w+W)−(mvv2_y−mvv0_y)/h*(h−H)

mv1_y=mv1LX[1]=mvv0_y+(mvv2_y−mvv0_y)/h*(w+W)+(mvv1_x−mvv0_x)/w*(h−H) (Equation AFFINE-2)

In a case that the reference picture of the derived motion vectors mv0 and mv1 is different from the reference picture of the target block, it may be scaled based on the inter picture distance between each of the reference pictures and the target picture.

Next, in a case that the motion vector (mvN_x, mvN_y) (N=0 . . . 1) of the control points V0 and V1 derived by the affine predictors 30372 and 30321 in (STEP1) points to outside of the rectangular slice (in the reference picture, some or all of the blocks at the positions to which collocated blocks are shifted by mvN are not inside of the collocated rectangular slice), any of the following processes 4 (processing 4A to processing 4D) is performed.

[Processing 4A] Rectangular Slice Boundary Padding

A rectangular slice boundary padding process is performed at STEP3. In this case, an additional processing is not particularly performed in (STEP1). Rectangular slice boundary padding (rectangular slice outside padding) is achieved by clipping the reference positions at the positions of the upper, lower, left, and right bounding pixels of the rectangular slice, as previously described. For example, in a case that the upper left coordinate of the target subblock relative to the upper left coordinate of the picture is (xs, ys), the width and the height of the target block are W and H, the upper left coordinate of the target rectangular slice in which the target subblock is located is (xRSs, yRSs), and the width and the height of the target rectangular slice are wRS and hRS, a reference pixel (xRef, yRef) of the subblock level is derived in the following equation.

xRef+i=Clip3(xRSs,xRSs+wRS−1,xs+(SpMvLX[k2][l2][0]>>log 2(M))+i)

yRef+j=Clip3(yRSs,yRSs+hRS−1,ys+(SpMvLX[k2][l2][1]>>log 2(M))+j)(Equation AFFINE-3)

[Processing 4B] Rectangular Slice Boundary Motion Vector Limitation

The subblock motion vector spMvLX [k2] [l2] is clipped so that the motion vector spMvLX [k2] [l2] of the subblock level does not refer to outside of the rectangular slice. For the rectangular slice boundary motion vector limitations, there are methods such as, for example, (Equation CLIP1) to (Equation CLIP5) described above.

[Processing 4C] Rectangular Slice Boundary Motion Vector Replacement (Alternative Motion Vector Replacement)

A motion vector is copied from an adjacent subblock with a motion vector pointing inside of a collocated rectangular slice.

[Processing 4D] Rectangular Slice Boundary Affine Off

In a case that it is determined to point to outside of the collocated rectangular slice, affine_flag=0 is set (an affine prediction is not performed). In this case, the processing described above is not performed.

Note that the processing 4 requires to select the same processing by the affine predictor of the slice coder 2012 and the affine predictor of the slice decoder 2002.

### (STEP2) Derivation of Subblock Vector

This is a process in which the affine predictors 30372 and 30321 derives a motion vector of each subblock included in the target block from a motion vector of block control points (the control points V0 and V1 or V0 and V2) being representative points of the target block derived at (STEP1). By (STEP1) and (STEP2), a motion vector spMvLX of each subblock is derived. Note that, in the following, an example of the control points V0 and V1 is described, but in a case that the motion vector of V1 is replaced by the motion vector of V2, a motion vector of each subblock can be derived in a similar manner for the control points V0 and V2 as well.

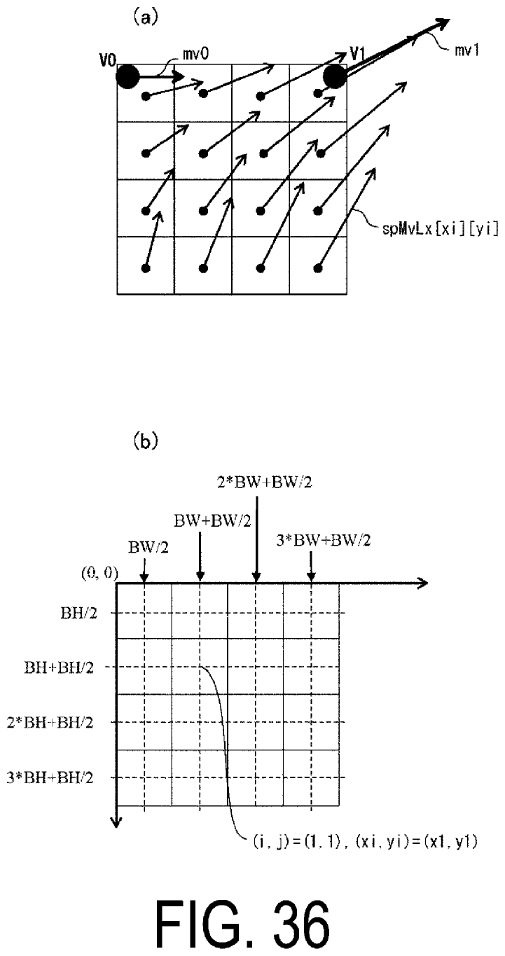

FIG. 36(a) is a diagram illustrating an example of deriving a motion vector spMvLX of each subblock constituting the target block from the motion vector (mv0_x, mv0_y) of the control point V0 and the motion vector (mv1_x, mv1_y) of V1. The motion vector spMvLX of each subblock is derived as a motion vector for each point located in the center of each subblock, as illustrated in FIG. 36(a).

The affine predictors 30372 and 30321 derive a motion vector spMvLX [xi] [yi] (xi=xb+BW*i, yj=yb+BH*j, i=0, 1, 2, . . . , W/BW−1, j=0,1,2, . . . , H/BH−1) of each subblock in the target PU, based on the motion vectors (mv0_x, mv0_y) and (mv1_x, mv1_y) of the control points V0 and V1 by using the following equation.

SpMvLX[xi][yi][0]=mv0_x+(mv1_x−mv0_x)/W*(xi+BW/2)−(mv1_y−mv0_y)/W*(yi+BH/2)

SpMvLX[xi][yi][1]=mv0_y+(mv1_y−mv0_y)/W*(xi+BW/2)+(mv1_x−mv0_x)/W*(yi+BH/2)(Equation AFFINE-4)

Here, xb and yb are the upper left coordinate of the target PU, W and H are the width and the height of the target block, and BW and BH are the width and the height of the subblock.

FIG. 36(b) is a diagram illustrating an example in which a target block (the width W and the height H) is partitioned into subblocks having the width BW and the height BH.

The points of a subblock position (i, j) and a subblock coordinate (xi, yj) are the intersections of the dashed lines parallel to the x axis and the dashed lines parallel to the y axis in FIG. 36(b). FIG. 36(b) illustrates, by way of example, the point of the subblock position (i, j)=(1,1), and the point of the subblock coordinate (xi, yj)=(x1, y1)=(BW+BW/2, BH+BH/2) for the subblock position (1, 1).

### (STEP3) Subblock Motion Compensation

This is a process in which the motion compensation unit 3091 performs a motion compensation in subblock units, based on the prediction list utilization flag predFlagLX input from the inter prediction parameter decoder 303, the reference picture index refIdxLX, the motion vector spMvLX of the subblock derived in (STEP2), in a case of affine_flag=1. Specifically, the motion compensation unit 3091 generates a motion compensation image PredLX by reading and filtering a block at a position shifted by the motion vector spMvLX, starting from the position of the target subblock, on the reference picture specified by the reference picture index refIdxLX, from the reference picture memory 306.

In a case that the motion vector of the subblock derived in (STEP2) points to outside of the rectangular slice, the pixel is read by padding the rectangular slice boundary.

Note that in the slice decoder 2002, in a case that there is affine_flag signalled from the slice coder 2012, the processing described above may be performed only in a case of affine_flag=1.

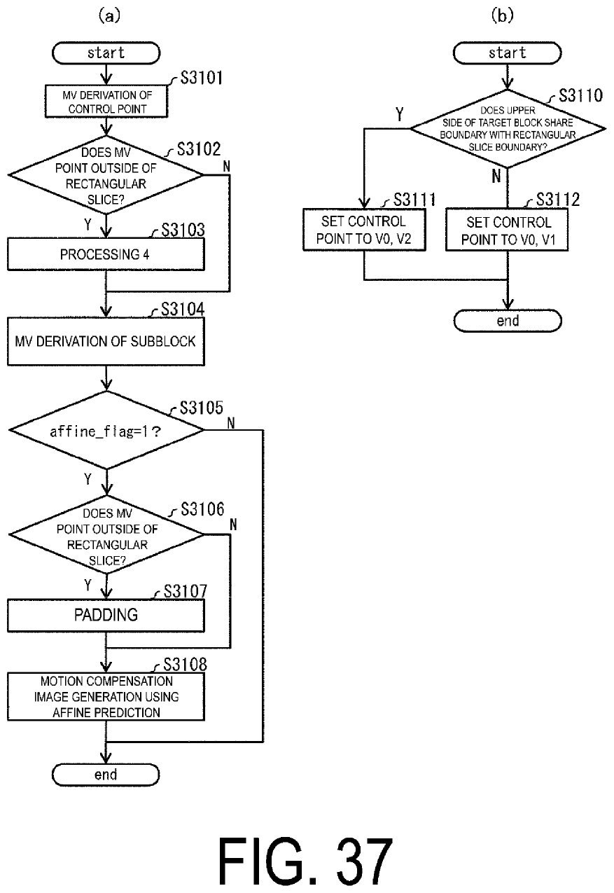

FIG. 37(a) is a flowchart illustrating operations of the affine prediction described above.

The affine predictor 30372 or 30321 derives a motion vector of the control point (S3101).

Next, the affine predictor 30372 or 30321 determines whether or not the derived motion vector of the control point points to outside of the rectangular slice (S3102). In a case that the motion vector does not point to outside of the rectangular slice (N at S3102), the process proceeds to S3104. In a case that the motion vector points to outside of the rectangular slices even partially (Y in S3102), the process proceeds to S3103.

In the case that the motion vector points to outside of the rectangular slice even partially, the affine predictor 30372 or 30321 any of the processes 4 described above, for example, clipping the motion vector to modify the motion vector to point to inside of the rectangular slice.

These S3101 to S3103 are the processes corresponding to (STEP1) described above.

The affine predictor 30372 or 30321 derives the motion vector of each subblock, based on the derived motion vector of the control point (S3104). S3104 is a process corresponding to (STEP2) described above.

The motion compensation unit 3091 determines whether or not affine_flag=1 (S3105). In a case of not affine_flag=1 (N in S3105), the motion compensation unit 3091 does not perform an affine prediction, and terminates the affine prediction process. In a case of affine_flag=1 (Y in S3105), the process proceeds to S3106.

The motion compensation unit 3091 determines whether or not the motion vector of the subblock points to outside of the rectangular slice (3106). In a case that the motion vector does not point to outside of the rectangular slice (N at S3106), the process proceeds to S3108. In a case that the motion vector points to outside of the rectangular slices even partially (Y in S3106), the process proceeds to S3107.

In a case that the motion vector of the subblock points to outside of the rectangular slice even partially, the motion compensation unit 3091 performs padding to the rectangular slice boundary (S3107).

The motion compensation unit 3091 generates a motion compensation image by an affine prediction, by using the motion vector of the subblock (S3108).

These S3105 to S3108 are the processes corresponding to (STEP3) described above.

FIG. 37(b) is a flowchart illustrating an example of determining a control point in a case of an AMVP prediction at S3101 in FIG. 37(a).

The affine predictor 30321 determines whether or not the upper side of the target block shares the boundary with the rectangular slice boundary (S3110). In a case that it shares the boundary with the upper side boundary of the rectangular slice (Y in S3110), the process proceeds to S3111 and the control points are set to V0 and V2 (S3111). Otherwise (N at S3110), the process proceeds to S3112 and the control points are set to V0 and V1 (S3112).

In an affine prediction, even in a case that the adjacent block is outside of the rectangular slice, or the motion vector points to outside of the rectangular slice, by configuring a control point, deriving a motion vector of the affine prediction, and generating a prediction image as described above, the reference pixel can be replaced by using a pixel value within the rectangular slice. Therefore, a reduction in the frequency of use of an affine prediction processing can be suppressed, and the rectangular slices can be independently performed an inter prediction, so that the coding efficiency can be increased.

### Matching Motion Derivation Unit 30373

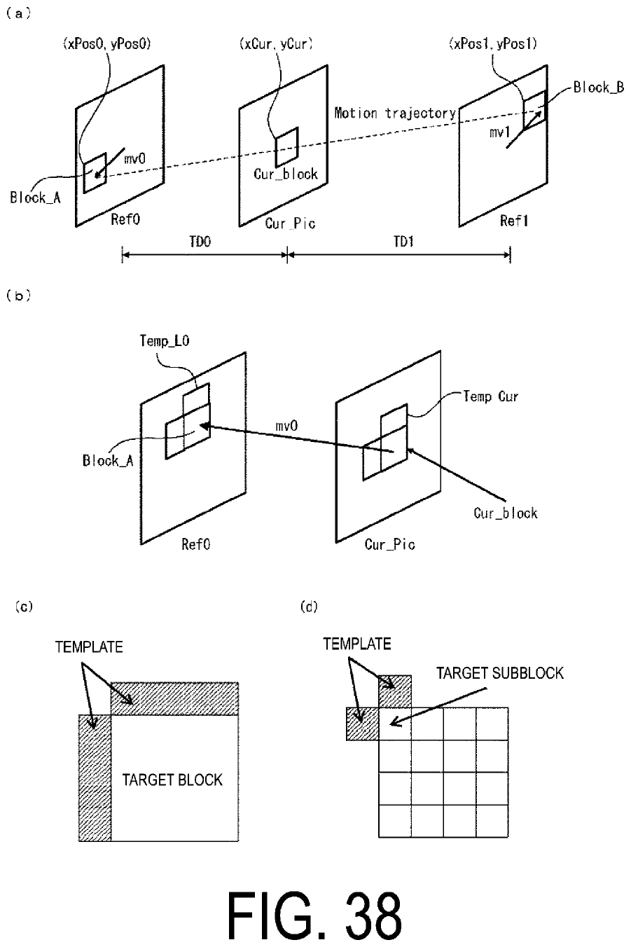

The matching motion derivation unit 30373 derives a motion vector spMvLX of a block or a subblock constituting a PU by performing matching processing of either the bilateral matching or the template matching. FIG. 38 is a diagram for describing (a) Bilateral matching, and (b) Template matching. The matching motion derivation mode is selected as one merge candidate (matching candidate) in merge modes.

The matching motion derivation unit 30373 derives a motion vector by matching of regions in multiple reference pictures, assuming that an object is moving at an equal speed. In the bilateral matching, a motion vector of the target PU is derived by matching between the reference pictures A and B, assuming that an object passes through a certain region of the reference picture A, a target PU of the target picture Cur_Pic, and a certain region of the reference picture B at an equal speed. In the template matching, a motion vector is derived by matching of an adjacent region Temp_Cur (template) of the target PU and an adjacent region Temp_L0 of the reference block on the reference picture, assuming that the motion vector of the adjacent region of the target PU and the motion vector of the target PU are equal. In the matching motion derivation unit, the target PU is partitioned into multiple subblocks, and the bilateral matching or the template matching described later is performed in units of partitioned subblocks,

to derive a motion vector of a subblock spMvLX [xi] [yi] (xi=xPb+BW*i, yj=yPb+BH*j, i=0,1,2, . . . , W/BW−1, j=0, 1, 2, . . . , H/BH−1).

As illustrated in (a) of FIG. 38, in the bilateral matching, two reference pictures are referred to for deriving a motion vector of the target block Cur_block in the target picture Cur_Pic. More specifically, first, in a case that the coordinate of the target block Cur_block is expressed as (xCur, yCur), a region within the reference picture Ref0 (referred to as the reference picture A) specified by the reference picture index refIdxL0, the region Block_A having the upper left coordinate (xPos0, yPos0) specified by:

(xPos0,yPos0)=(xCur+mv0[0],yCur+mv0[1]) (Equation FRUC-1)

and, for example, a region within the reference picture Ref1 (referred to as the reference picture B) specified by the reference picture index refIdxL1, the region Block_B having the upper left coordinate (xPos1, yPos1) specified by

(xPos1,yPos1)=(xCur+mv1[0],xCur+mv1[1])=(xCur−mv0[0]*DiffPicOrderCnt(Cur_Pic,Ref1)/DiffPicOrderCnt(Cur_Pic,Ref0),yCur−mv0[1]*DiffPicOrderCnt(Cur_Pic,Ref1)/DiffPicOrderCnt(Cur_Pic,Ref0) (Equation FRUC-2)

are configured.

Here, DiffPicOrderCnt (Cur_Pic, Ref0) and DiffPicOrderCnt (Cur_Pic, Ref1) represent a function of returning a difference in temporal information between the target picture Cur_Pic and the reference picture A, and a function of returning a difference in temporal information between the target picture Cur_Pic and the reference picture B, respectively, as illustrated in (a) of FIG. 38.

Next, (mv0 [0], mv0 [1]) is determined so that the matching costs of Block_A and Block_B are minimized. (mv0 [0], mv0 [1]) derived in this way is the motion vector applied to the target block. Based on the motion vector applied to the target block, a motion vector spMVL0 is derived for each subblock into which the target block is partitioned.

Meanwhile, (b) of FIG. 38 is a diagram illustrating the Template matching among the matching processes described above.

As illustrated in (b) of FIG. 38, in the template matching, reference is made to one reference picture at a time in order to derive a motion vector of the target block Cur_block in the target picture Cur_Pic.

More specifically, for example, a region within the reference picture Ref0 (referred to as the reference picture A) specified by the reference picture index refIdxL0, the region referred to as the reference block Block_A having the upper left coordinate (xPos0, yPos0) identified by

(xPos0,yPos0)=(xCur+mv0[0],yCur+mv0[1]) (Equation FRUC-3)

is identified.

Here, (xCur, yCur) is the upper left coordinate of the target block Cur_block.

Next, the template region Temp_Cur adjacent to the target block Cur_block in the target picture Cur_Pic and the template region Temp_L0 adjacent to Block_A in the reference picture A are configured. In the example illustrated in (b) of FIG. 38, the template region Temp_Cur is constituted by a region adjacent to the upper side of the target block Cur_block and a region adjacent to the left side of the target block Cur_block. The template region Temp_L0 is comprised of a region adjacent to the upper side of Block_A and a region adjacent to the left side of Block_A.

Next, (mv0 [0], mv0 [1]) by which the matching cost of Temp_Cur and Temp_L0 is minimized is determined, as a motion vector applied to the target block. Based on the motion vector applied to the target block, a motion vector spMvL0 is derived for each subblock into which the target block is partitioned.

The template matching may also be processed for two reference pictures Ref0 and Ref1. In this case, matching of the reference picture Ref0 described above and matching of the reference picture Ref1 are performed sequentially. A region in the reference picture Ref1 (referred to as the reference picture B) specified by the reference picture index refIdxL1, the region being the reference block Block_B having the upper left coordinate (xPos1, yPos1) identified by

(xPos1,yPos1)=(xCur+mv1[0],yCur+mv1[1]) (Equation FRUC-4)

is identified, and the template region Temp_L1 adjacent to Block_B in the reference picture B is configured.

Finally, (mv1 [0], mv1 [1]) by which the matching cost of Temp_Cur and Temp_L1 is minimized is determined, as a motion vector applied to the target block. Based on the motion vector applied to the target block, a motion vector spMvL1 is derived for each subblock into which the target block is partitioned.

### Motion Vector Derivation Process by Matching Processing

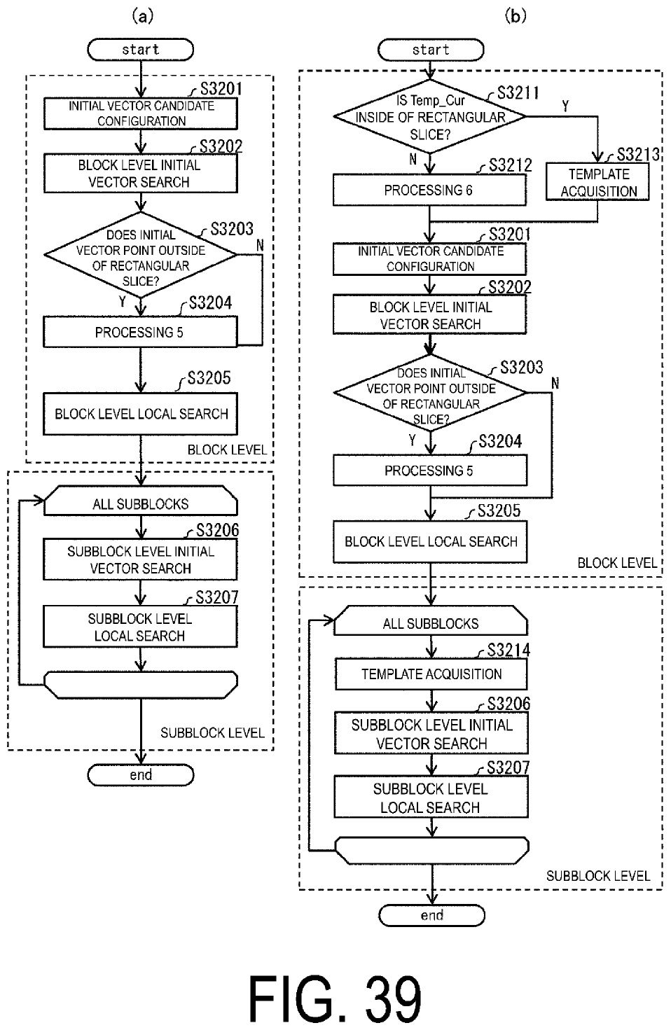

The flow of motion vector derivation (pattern match vector derivation) process in a matching mode will be described with reference to the flowchart of FIG. 39.

The process illustrated in FIG. 39 is executed by the matching predictor 30373. FIG. 39(a) is a flowchart of the bilateral matching processing, and FIG. 39(b) is a flowchart of the template matching processing.

Note that, among the steps illustrated in FIG. 39(a), S3201 to S3205 are a block search performed at a block level. That is, a pattern match is used to derive a motion vector across a block (CU or PU).

S3206 to S3207 are a subblock search performed at a subblock level. That is, a pattern match is used to a derive motion vector in subblock units that constitute a block.

First, in S3201, the matching predictor 30373 configures an initial vector candidate for the block level in the target block. The initial vector candidate is a motion vector of an adjacent block, such as an AMVP candidate, a merge candidate, or the like of the target block.

Next, at S3202, the matching predictor 30373 searches a vector having a minimum matching cost among the initial vector candidates configured above to set as an initial vector being a basis of a vector search. The matching cost is expressed as, for example, the following equation.

SAD=ΣΣabs(Block_A[x][y]−Block_B[x][y]) (Equation FRUC-5)

Here, ΣΣ is the sum of x and y, Block_A [ ] [ ] and Block_B [ ] [ ] are blocks in which the upper left coordinates of the blocks are represented by (xPos0, yPos0) and (xPos1, yPos1) in (Equation FRUC-1) and (Equation FRUC-2), respectively, and the initial vector candidate is substituted into (mv0 [0], mv0 [1]). Then, the vector with the minimum matching cost is set again to (mv0 [0], mv0 [1]).

Next, at S3203, the matching predictor 30373 determines whether or not the initial vector determined at S3202 points to outside of the rectangular slice (in the reference picture, some or all of the blocks at the positions in which the collocated block is shifted by mvN (N=0 . . . 1) are not inside of the collocated rectangular slice). In a case that the initial vector does not point outside of the rectangular slice (N at S3203), the process proceeds to S3205. In a case that the initial vector points to outside of the rectangular slices even partially (Y at S3203), the process proceeds to S3204.

In S3204, the matching predictor 30373 performs any of the following processes 5 (processing 5A to processing 5C).

[Processing 5A] Rectangular Slice Boundary Padding

The rectangular slice boundary padding is performed by the motion compensation unit 3091.

The pixel pointed by the initial vector (mv0 [0], mv0 [1]) is clipped so as not to refer to outside of the rectangular slice. In a case that the upper left coordinate of the target block relative to the upper left coordinate of the picture is (xs, ys), the width and the height of the target block are W and H, the upper left coordinate of the target rectangular slice in which the target block is located is (xRSs, yRSs), and the width and the height of the target rectangular slice are wRS and hRS, a reference pixel (xRef, yRef) of a subblock is derived in the following equation.

xRef+i=Clip3(xRSs,xRSs+wRS−1,xs+(mv0[0]>>log 2(M))+i)

yRef+j=Clip3(yRSs,yRSs+hRS−1,ys+(mv1[1]>>log 2(M))+j) (Equation FRUC-6)

[Processing 5B] Rectangular Slice Boundary Motion Vector Limitation

The initial vector mv0 is clipped so that motion vector mv0 of the initial vector does not refer to outside of the rectangular slice. For the rectangular slice boundary motion vector limitations, there are methods such as, for example, (Equation CLIP1) to (Equation CLIP5) described above.

[Processing 5C] Rectangular Slice Boundary Motion Vector Replacement (Alternative Motion Vector Replacement)

In a case that the target pointed by the motion vector mv0 is not inside of a collocated rectangular slice, an alternative motion vector inside of a collocated rectangular slice is copied.

[Processing 5D] Rectangular Slice Boundary Bilateral Matching Off

In a case that referring to outside of the collocated rectangular slice is determined, BM_flag that indicates on or off of the bilateral matching is set to 0, and the bilateral matching is not performed (the process proceeds to end).

Note that the processing 5 requires the slice coder 2012 and the slice decoder 2002 to select the same process.

In S3205, the matching predictor 30373 performs local search of the block level in the target block. In a local search, local regions with the center of the initial vector derived from S3202 or S3204 (for example, regions of D pixels centered on the initial vector) are further searched, and a vector having a minimum matching cost is searched to set as the motion vector of the final target block.

Next, the following process is performed for each subblock included in the target block (S3206 to S3207).

At S3206, the matching predictor 30373 derives an initial vector of a subblock in the target block (initial vector search). The initial vector candidate of the subblock is a motion vector of the block level derived at S3205, a motion vector of an adjacent block in the spatial-temporal direction of the subblock, an ATMVP or STMVP vector of the subblock, and the like. Among these candidate vectors, a vector that minimizes the matching cost is set as the initial vector of the subblock. Note that the vector candidates used for the initial vector search of the subblock are not limited to the vectors described above.

Next, at S3207, the matching predictor 30373 performs a step search or the like (local search) in a local region centered on the initial vector of the subblock selected at S3206 (for example, a region of ±D pixels centered on the initial vector). Then, matching costs of the vector candidates near the initial vector of the subblock are derived, and the minimum vector is derived as the motion vector of the subblock.

Then, after processing is completed for all of the subblocks included in the target block, the pattern match vector derivation process of the bilateral matching ends.

Next, a pattern matching vector derivation process of the template matching will be described with reference to FIG. 39(b). Among the steps illustrated in FIG. 39(b), S3211 to S3205 are a block search performed at the block level. S3214 to S3207 are a subblock search performed at a subblock level.

First, at S3211, the matching predictor 30373 determines whether or not a template Temp_Cur of the target block (both the upper adjacent region and the left adjacent region of the target block) is present in the rectangular slice. In a case of being determined as present (Y at S3211), as illustrated in FIG. 38(c), Temp_Cur is set with the upper adjacent region and the left adjacent region of the target block to obtain a template for the target block (S3213). Otherwise (N at S3211), the process proceeds to S3212, and any of the following processes 6 (Processing 6A to processing 6E) is performed.

[Processing 6A] Rectangular Slice Boundary Padding

The motion compensation unit 3091 performs a rectangular slice boundary padding (for example, (Equation FRUC-6) described above).

[Processing 6B] Rectangular Slice Boundary Motion Vector Limitation

The motion vector is clipped so that the motion vector does not refer to outside of the rectangular slice. For the rectangular slice boundary motion vector limitations, there are methods such as, for example, (Equation CLIP1) to (Equation CLIP5) described above.

[Processing 6C] Rectangular Slice Boundary Motion Vector Replacement (Alternative Motion Vector Replacement)

In a case that the target pointed by the subblock motion vector is not inside of a collocated rectangular slice, an alternative motion vector inside of a collocated rectangular slice is copied.

[Processing 6D] Template Matching Off

In a case that referring to outside of the collocated rectangular slice is determined, TM_flag that indicates on or off of the template matching is set to 0, and the template matching is not performed (the process proceeds to end).

[Processing 6E] in a Case that Either One of the Upper Adjacent Region and the Left Adjacent Region is within the Rectangular Slice, that Adjacent Region is Set as a Template.

Note that the processing 6 requires the slice coder 2012 and the slice decoder 2002 to select the same process.

Next, at S3201, the matching predictor 30373 configures an initial vector candidate of the block level in the target block. The processing of S3201 is the same as the S3201 in FIG. 39(a).

Next, at S3202, the matching predictor 30373 searches a vector having a minimum matching cost among the initial vector candidates configured above to set as an initial vector being a basis of a vector search. The matching cost is expressed as, for example, the following equation.

SAD=ΣΣabs(Temp_Cur[x][y]−Temp_L0[x][y]) (Equation FRUC-7)

Here, ΣΣ is the sum of x and y, Temp_L0 [ ] [ ] is a template of the target block illustrated in FIG. 38(b), and is a region adjacent to the upper side and the left side of Block_A, where (xPos0, yPos0) indicated by (Equation FRUC-3) is the upper left coordinate. (mv0 [0], mv0 [1]) in (Equation FRUC-3) is replaced by the initial vector candidate. Then, the vector with the minimum matching cost is set again to (mv0 [0], mv0 [1]). Note that, in a case that only the upper side or the left side region of the target block is set to the template in the S3212, Temp_L0 [ ] [ ] is the same shape.

The processing of S3203 and S3204 is the same processing as S3203 and S3204 in FIG. 39(a). Note that in processing 5 of S3204 in FIG. 39(b), in a case that the template matching is turned off, TM_flag is set to 0.

In S3205, the matching predictor 30373 performs local search of the block level in the target block. In a local search, local regions with the center of the initial vector derived from S3202 or S3204 (for example, regions of +D pixels centered on the initial vector) are further searched, and a vector having a minimum matching cost is searched to set as the motion vector of the final target block.

Next, the following process is performed for each subblock included in the target block (S3214 to S3207).

In S3214, the matching predictor 30373 acquires a template of a subblock in the target block, as illustrated in FIG. 38(d). In a case that only the upper side or the left side region of the target block is set to the template at S3212, the template of the subblock is the same shape at S3214 as well.

At S3206, the matching predictor 30373 derives an initial vector of a subblock in the target block (initial vector search). The initial vector candidate of the subblock is a motion vector of the block level derived at S3205, a motion vector of an adjacent block in the spatial-temporal direction of the subblock, an ATMVP or STMVP vector of the subblock, and the like. Among these candidate vectors, a vector that minimizes the matching cost is set as the initial vector of the subblock. Note that the vector candidates used for the initial vector search of the subblock are not limited to the vectors described above.

Next, at S3207, the matching predictor 30373 performs a step search (local search) centered on the initial vector of the subblock selected at S3206. The matching predictor 30373 derives a matching cost of a vector candidate of a local region centered on the initial vector of the subblock (for example, within a search range centered on the initial vector (a region of ±D pixels)), and derives the smallest vector as the motion vector of the subblock. Here, in a case that the vector candidate matches (or is outside of) the search range centered on the initial vector, the matching predictor 30373 does not search for the vector candidate.

Then, in a case that processing is complete for all of the subblocks included in the target block, the pattern match vector derivation process of the template matching ends.

Although the above reference picture is Ref0, the template matching can be performed by the same process as described above even in a case that the reference picture is Refl. Furthermore, in a case that there are two reference pictures, the motion compensation unit 3091 performs a bi-prediction process by using two derived motion vectors.

The output fruc_merge_idx to the motion compensation unit 3091 is derived by the following equation.

fruc_merge_idx=fruc_merge_idx & BM_flag &(TM_flag<<1) (Equation FRUC-8)

Note that, in a case that fruc_mergc_idx is signalled by the rectangular slice decoder 2002, BM_flag and TM_flag may be derived before the pattern match vector derivation processing, and a matching process with the value of the flag being true may only be performed.

BM_flag=fruc_merge_idx & 1

TM_flag=(fruc_merge_idx & 10)>>1 (Equation FRUC-9)

Note that in a case that the template is located outside of the rectangular slice, so the template matching is turned off, there is two options of fruc_merge_idx=0 (no matching) or fruc_merge_idx=1 (bilateral matching), and fruc_merge_idx can be expressed as 1 bit.

### Rectangular Slice Boundary Search Range

In a case of performing independent coding or decoding of a rectangular slice (rectangular_slice_flag is 1), the search range D may be configured so as not to refer to pixels outside of a collocated rectangular slice in the search process of the motion vector. For example, the search range D of the bilateral matching process and the template matching process may be configured in accordance with the position and the size of the target block, or the position and the size of the target subblock.

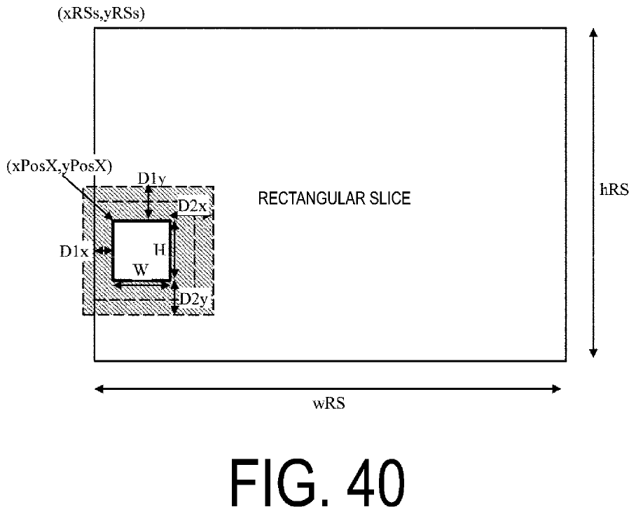

Specifically, the matching predictor 30373 derives the search range D1x in the left direction of the target block illustrated in FIG. 40, the search range D2x in the right direction of the target block, the search range D1y in the upward direction of the target block, and the search range D2y in the downward direction of the target block, as the range for referring to only pixels inside of a collocated rectangular slice, by the following.

D1x=xPosX+mvX[0]−xRSs

D2x=xRSs+wRS−(xPosX+mvX[0]+W)

D1y=yPosX+mvX[1]−yRSs

D2y=yRSs+hRS−(yPosX+mvX[1]+H) (Equation FRUC-11)

The matching predictor 30373 configures the minimum value of D1x, D2x, D1y, and D2y determined by (Equation FRUC-11) and default search range Ddef as the search range D of the target block.

D=min(Dx1,Dx2,Dy1,Dy2,Ddef) (Equation FRUC-12)

The following derivation method may be used. The matching predictor 30373 derives the search range D1x in the left direction of the target block illustrated in FIG. 40, the search range D2x in the right direction of the target block, the search range D1y in the upward direction of the target block, and the search range D2y in the downward direction of the target block, as the range for referring to only pixels inside of a collocated rectangular slice, by the following.

D1x=clip3(0,Ddef,xPosX+mvX[0]−xRSs)

D2x=clip3(0,Ddef,xRSs+wRS−(xPosX+mvX[0]+W))

D1y=clip3(0,Ddef,yPosX+mvX[1]−yRSs)

D2y=clip3(0,Ddef,yRSs+hRS−(yPosX+mvX[1]+H) (Equation FRUC-11b)

The matching predictor 30373 configures the minimum value of D1x, D2x, D1y, and D2y determined by (Equation FRUC-11 b) as range D of the target block.

D=min(Dx1,Dx2,Dy1,Dy2) (Equation FRUC-12 b)

Note that, in a case that a configuration in which the rectangular slice boundary is performed padding with a fixed value, and the width and the height of the padding are xPad and yPad, the following equation may be used instead of (Equation FRUC-11) and (Equation FRUC-11b).

D1x=xPosX+mvX[0]−(xRSs−xPad)

D2x=xRSs+wRS+xPad−(xPosX+mvX[0]+W)

D1y=yPosX+mvX[1]−(yRSs−yPad)

D2y=yRSs+hRS+yPad−(yPosX+mvX[1]+H) (Equation FRUC-13)

Alternatively, the following equation may be used.

D1x=clip3(0,Ddef,xPosX+mvX[0]−(xRSs−xPad))

D2x=clip3(0,Ddef,xRSs+wRS+xPad−(xPosX+mvX[0]+W))

D1y=clip3(0,Ddef,yPosX+mvX[1]−(yRSs−yPad))

D2y=clip3(0,Ddef,yRSs+hRS+yPad−(yPosX+mvX[1]+H) (Equation FRUC-13b)

In the matching process, even in a case that the template is outside of the rectangular slice, or the motion vector points to outside of the rectangular slice, by deriving a motion vector and generating a prediction image as described above, the reference pixel can be replaced by using a pixel value within the rectangular slice. Therefore, a reduction in the frequency of use of the matching processing can be suppressed, and the rectangular slices can be independently performed an inter prediction, so that the coding efficiency can be increased.

### OBMC Processing

The motion compensation unit 3091 according to the present embodiment may generate a prediction image by using an OBMC processing. Here, the Overlapped block motion compensation (OBMC) processing will be described. The OBMC processing is a processing to generate an interpolation image (a motion compensation image) of a target block by using an interpolation image PredC of the target subblock generated by using an inter prediction parameter (hereinafter, a motion parameter) of the target block, and an interpolation image PredRN of the target block generated by using a motion parameter of an adjacent block of the target subblock. In pixels (boundary pixels) in the target block where the distance to the block boundary is close, processing to correct an interpolation image of the target block is performed in units of subblocks by an interpolation image PredRN based on a motion parameter of an adjacent block.

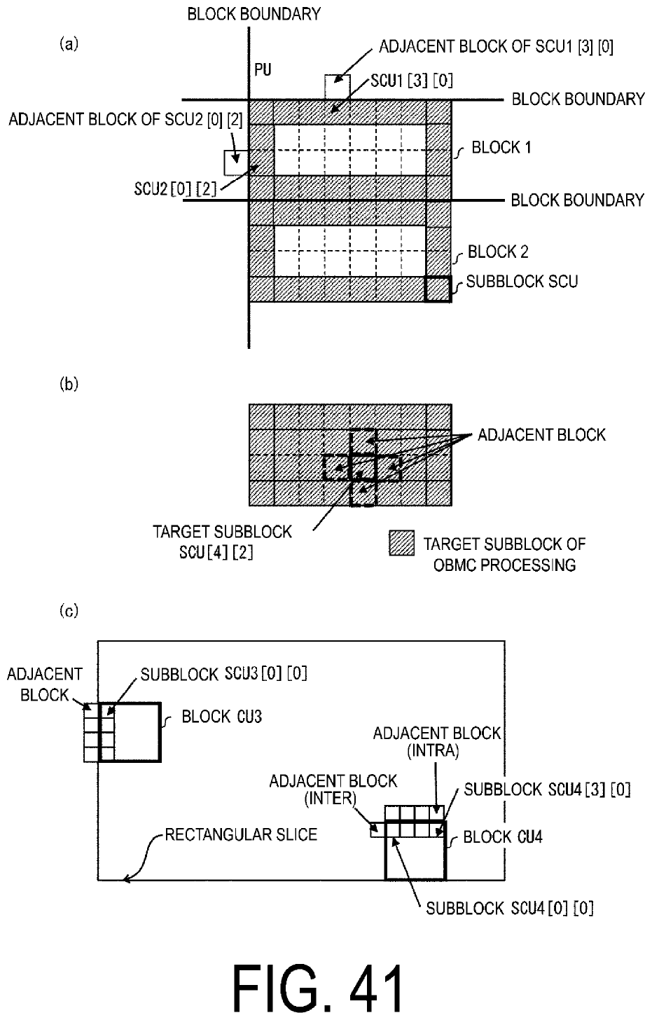

FIG. 41 is a diagram illustrating an example of a region for generating a prediction image by using a motion parameter of an adjacent block according to the present embodiment. In a prediction in units of blocks, since the motion parameters in the block are the same, the pixels of the subblocks with diagonal lines that are within a prescribed distance from the block boundary are subject to OBMC processing applications as illustrated in FIG. 41(a). In a prediction in units of subblocks, since the motion parameter is different for each subblock, the pixels of each of the subblocks are subject to OBMC processing applications, as illustrated in FIG. 41(b).

Note that the shapes of the target block and an adjacent block are not necessarily the same, so that the OBMC processing is preferably performed on a subblock unit into which blocks are partitioned. The size of the subblocks can vary from 4×4 to 8×8 block sizes.

### Flow of OBMC Processing

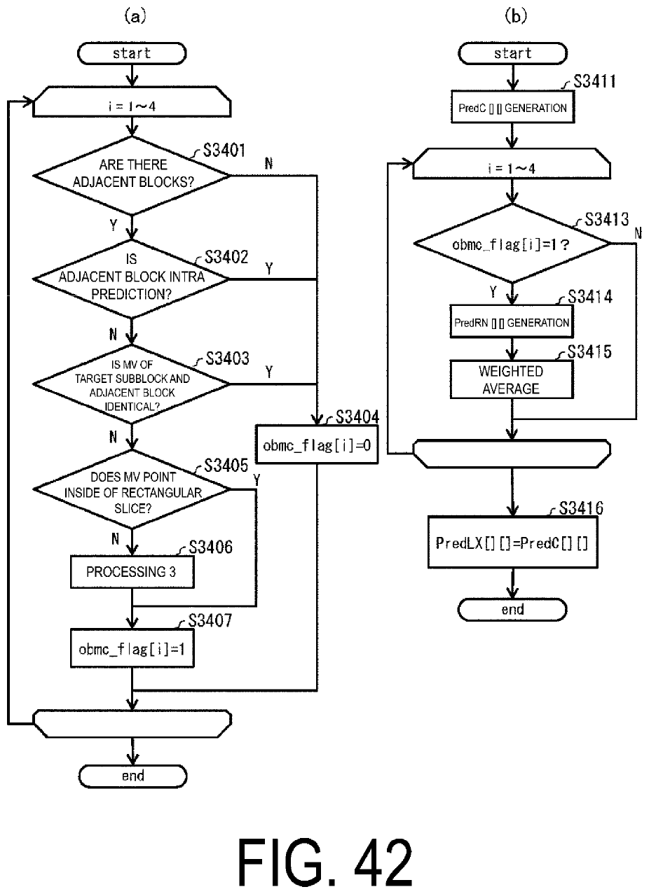

FIG. 42(a) is a flowchart illustrating a parameter derivation processing performed by the OBMC predictor 30374 according to the present embodiment.

The OBMC predictor 30374 determines whether or not an adjacent block adjacent in each direction of the upper side, the left side, the lower side, and the right side is present or absent or available with respect to the target subblock. In FIG. 42, a method is illustrated in which all of the subblocks are processed for each direction of the upper, left, lower, and right, and then the process is transferred to processing in the next direction, but, a method can be taken in which all the directions are processed for a certain subblock, and then the process is transferred to processing of the next subblock. In FIG. 42(a), for the direction of the adjacent block relative to the target subblock, i=I is the upper side, i=2 is the left side, i=3 is the lower side, and i=4 is the right side.

First, the OBMC predictor 30374 checks the need for the OBMC processing and the presence or absence of an adjacent block (S3401). In a case that the prediction unit is a block unit, and the target subblock does not share the boundary with the block boundary in the direction indicated by i, there is no adjacent block required for the OBMC processing (N in S3401), so the process proceeds to S3404, and the flag obmc_flag [i] is set to 0. Otherwise (in a case that the prediction unit is a block unit and the target subblock shares the boundary with the block boundary, or in a case that the processing unit is a subblock), there is an adjacent block required for the OBMC processing (Y at S3401), and the process proceeds to S3402.

For example, the subblock SCU1 [3] [0] in FIG. 41(a) does not share the boundary with the block boundary on the left side, the lower side, and the right side, so obmc_flag [2]=0, obmc_flag [3]=0, and obmc_flag [4]=0 are set. The subblock SCU2 [0] [2] does not share the boundary with the block boundary on the upper side, the lower side, and the right side, so obmc_flag [1]=0, obmc_flag [3]=0, and obmc_flag [4]=0 are set. A white subblock is a subblock that does not share the boundary with the block boundary at all, so obmc_flag [1]=obmc_flag [2]=obmc_flag [3]=obmc_flag [4]=0 is set.

Next, the OBMC predictor 30374 checks whether an adjacent block in the direction indicated by i is an intra prediction block, or a block outside of the rectangular slice, as the availability of the adjacent block (S3402). In a case that the adjacent block is an intra prediction block or a block outside of the rectangular slice (Y in S3402), the process proceeds to S3404, and obmc_flag [i] in the corresponding direction i is set to 0. Otherwise (in a case that the adjacent block is an inter prediction block and a block is inside of the rectangular slice) (N at S3402), the process proceeds to S3403.

For example, in the case of FIG. 41(c), with respect to the target subblock SCU3 [0] [0] of the target block CU3 in the rectangular slice, since the adjacent block on the left side is outside of the rectangular slice, obmc_flag [2] of the target subblock SCU3 [0] [0]is set to 0. With respect to the target subblock SCU4 [3] [0] of the target block CU4 in the rectangular slice, obmc_flag [1] of the target subblock SCU4 [3] [0] is set to 0 since the adjacent block on the upper side is an intra prediction.

Next, the OBMC predictor 30374 checks whether or not motion parameters of the adjacent block in the direction indicated by i and the target subblock are the same as the availability of the adjacent block (S3403). In a case that the motion parameters are the same (Y at S3403), the process proceeds to S3404 and obmc_flag [i]=0 is set. Otherwise (in a case that the motion parameters are different) (N at S3403), the process proceeds to S3405.

Whether or not the motion parameters of the subblock and the adjacent block are the same is determined by the following equation.

((mvLX[0]!=mvLXRN[0])∥(mvLX[1]!=mvLXRN[1])∥(refIdxLX!=refIdxLXRN))? (Equation OBMC-1)

Here, the motion vector of the target subblock in the rectangular slice is (mvLX [0], mvLX [1]), the reference picture index is refIdxLX, the motion vector of the adjacent block in the direction indicated by i is (mvLXRN [0], mvLXRN [1]), and the reference picture index is refIdxRN.

For example, in FIG. 41(c), in a case that the motion vector of the target subblock SCU4 [0] [0] is (mvLX [0], mvLX [1]), the reference picture index is refIdxLX, the motion vector of the left side adjacent block is (mvLXR2 [0], mvLXR2 [1]), the reference picture index is refIdxLXR2, in a case that the motion vector and the reference picture index are the same, for example, in case that ((mvLX [0]==mvLXRN [0]) && (mvLX [1]==mvLXRN [1]) && (refIdxLX==refIdxLXRN)) is true, obmc_flag [2]=0 of the target subblock is set.

Note that the motion vector and the reference picture index are used in the above equation, but the motion vector and the POC may be used as the following equation.

((mvLX[0]!=mvLXRN[0])∥(mvLX[1]!=mvLXRN[1])∥(refPOC!=refPOCRN))? (Equation OBMC-2)

Here, refPOC is the POC of the target subblock and refPOCRN is the POC of the adjacent block.

Next, the OBMC predictor 30374 determines whether or not all regions pointed by the motion vectors of the adjacent blocks are inside of the rectangular slice (in the reference picture, some or all of the blocks at the positions in which the collocated block is shifted by mvN (N=0 . . . 4) are not inside of the collocated rectangular slice) (S3405). In a case that all the regions pointed by the motion vectors are inside of the rectangular slice (Y in S3405), the process proceeds to S3407. Otherwise (in a case that regions pointed by the motion vectors are outside of the rectangular slice even partially) (N at S3405), the process proceeds to S3406.

In a case that a motion vector of an adjacent block points to outside of the rectangular slice, any of the following processes 3 are applied (S3406).

[Processing 3A] Rectangular Slice Boundary Padding

The rectangular slice boundary padding is performed by the motion compensation unit 3091. Rectangular slice boundary padding (rectangular slice outside padding) is achieved by clipping the reference positions at the positions of the upper, lower, left, and right bounding pixels of the rectangular slice, as previously described. For example, in a case that the upper left coordinate of the target subblock relative to the upper left coordinate of the picture is (xs, ys), the width and the height of the target subblock are BW and BH, the upper left coordinate of the target rectangular slice in which the target subblock is located is (xRSs, yRSs), the width and the height of the target rectangular slice are wRS and hRS, and the motion vector of the adjacent block is (MvLXRN [0], MvLXRN [1]), the reference pixel (xRef, yRef) of the subblock is derived with the following equation.

xRef+i=Clip3(xRSs,xRSs+wRS−BW,xs+(MvLXRN[0]>>log 2(M)))

yRef+j=Clip3(yRSs,yRSs+hRS−BH,ys+(MvLXRN[1]>>log 2(M)) (Equation OBMC-3)

[Processing 3B] Rectangular Slice Boundary Motion Vector Limitation

The motion vector MvLXRN of the adjacent block is clipped so as not to refer to outside of the rectangular slice in a manner such as, for example, (Equation CLIP1) to (Equation CLIP5) described above.

[Processing 3C] Rectangular Slice Boundary Motion Vector Replacement (Alternative Motion Vector Replacement)

A motion vector is copied from an adjacent subblock with a motion vector pointing inside of a collocated rectangular slice.

[Processing 3D] Rectangular Slice Boundary OBMC Off

In a case that referring to outside of the collocated rectangular slice is determined with reference to the reference image with the motion vector (MvLXRN [0], MvLXRN [1]) of the adjacent block in the direction i, obmc_flag [i]=0 is set (the OBMC processing is not performed in the direction i). In this case, S3407 is skipped and proceeded.

Note that the processing 3 requires the slice coder 2012 and the slice decoder 2002 to select the same process.

The OBMC predictor 30374 sets obmc_flag [i]=1 in a case that the motion vector of the adjacent block indicates inside of the rectangular slice or in a case that the processing 3 is performed (S3407).

Next, the OBMC predictor 30374 performs the processes of S3401 to S3407 described above in all directions (i=1 to 4) of the subblocks, and the process is terminated.

The OBMC predictor 30374 outputs the derived prediction parameter described above (obmc_flag and the motion parameters of the adjacent blocks of each of the subblocks) to the inter prediction image generation unit 309, and the inter prediction image generation unit 309 refers to obmc_flag to determine whether or not the OBMC processing is necessary, and performs the OBMC processing to the target block (described in detail in Motion Compensation).

Note that in the slice decoder 2002, obmc_flag (i) is set in a case that obmc_flag is signalled from the slice coder 2012, and the above processing may be performed only in the case of obmc_flag [i]=1.

### BTM

The BTM predictor 3038 derives a high accuracy motion vector by performing the bilateral template matching (BTM) processing by setting a prediction image generated by using bi-directional motion vectors derived by the merge prediction parameter derivation unit 3036 as a template.

### Example of Motion Vector Derivation Process

In a case that two motion vectors derived in the merge mode are opposite relative to the target block, the BTM predictor 3038 performs the bilateral template matching (BTM) process.

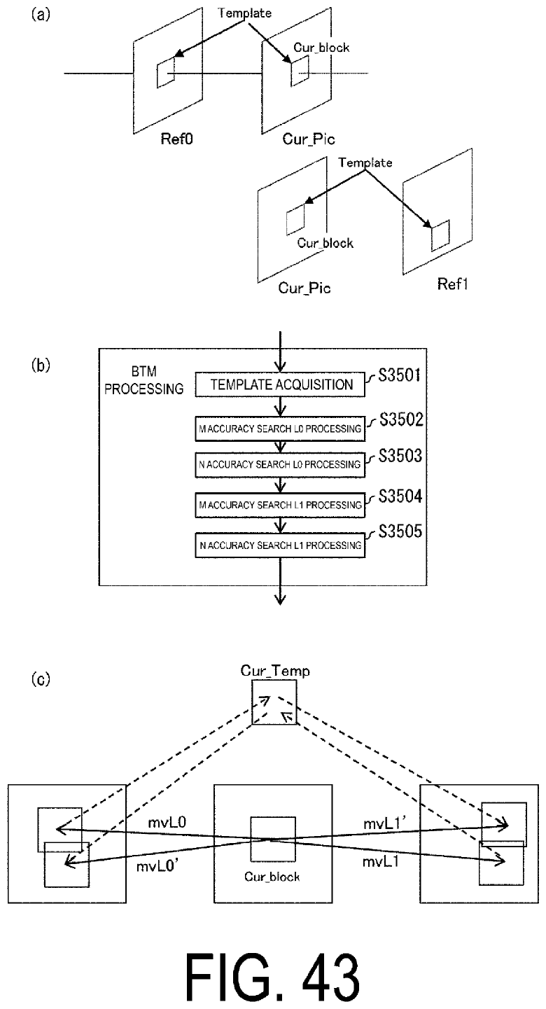

The bilateral template matching (BTM) process will be described with reference to FIG. 43. FIG. 43(a) is a diagram illustrating a relationship between a reference picture and a template in a BTM prediction, (b) is a diagram illustrating the flow of the processing, and (c) is a diagram illustrating a template in a BTM prediction.

As illustrated in FIGS. 43(a) and (c), the BTM predictor 3038 first generates a prediction block of the target block Cur_block from multiple motion vectors (for example mvL0 and mvL1) derived by the merge prediction parameter derivation unit 3036, and set this as a template. Specifically, the BTM predictor 3038 first generates a prediction block Cur_Temp from a motion compensation image predL0 generated by mvL0 and a motion compensation image predL1 generated by mvL1.

Cur_Temp[x][y]=Clip3(0,(1<<bitDepth)−1,(predL0[x][y]+predL1[x][y]+1)>>1) (Equation BTM-1)

Next, the BTM predictor 3038 configures motion vector candidates in a range of ±D pixels with mvL0 and mvL1 each as the center (initial vector), and derives the matching costs of the motion compensation images PredL0 and PredL1 generated by each of the motion vector candidates and the template. Then, the vectors mvL0′ and mvL1′, which minimizes the matching cost, are set as the updated motion vector of the target block. However, the search range is limited to inside of the collocated rectangular slices on the reference pictures Ref0 and Ref1.

Next, a flow of the BTM prediction will be described with reference to FIG. 43(b). First, the BTM predictor 3038 acquires a template (S3501). As described above, the template is generated from the motion vectors (for example mvL0 and mvL1) derived by the merge prediction parameter derivation unit 3036. Next, the BTM predictor 3038 performs local search in the collocated rectangular slice. The local search may be performed by repeating a search of multiple different accuracies such as S3502 to S3505. For example, the local search is performed in the order of M pixel accuracy search L0 processing (S3502), N pixel accuracy search L0 processing (S3503), M pixel accuracy search L1 processing (S3504), and N pixel accuracy search L1 processing (S3505). Here, M>N, for example, M=1 pixel accuracy and N=½ pixel accuracy can be set.

The M pixel accuracy LX search processing (X=0 . . . 1) performs a search centered on the coordinate indicated by mvLX in the rectangular slice. The N pixel accuracy search LX processing performs, in the rectangular slice, a search centered on coordinate with the minimal matching cost in the M pixel accuracy search LX processing.

Note that the rectangular slice boundary may extended by padding in advance. In this case, the motion compensation unit 3091 also performs a padding process.

In a case that rectangular_slice_flag is 1, the search range D may be adaptively modified as illustrated in (Equation FRUC-11) to (Equation FRUC-13) to avoid reference to pixels outside of the collocated rectangular slice in the motion vector search process so that each rectangular slice may be decoded independently. In the BTM processing, (mvX [0], mvX [1]) of (FRUC-11) and (FRUC-13) is replaced by (mvLX [0], mvLX [1]).

By modifying the motion vector derived in the merge mode in this way, the prediction image can be improved. Then, by limiting the modified motion vector inside of the rectangular slice, the coding efficiency can be increased since the rectangular slices can be independently performed inter predictions while suppressing a reduction in the frequency of use of the bilateral template matching processing.

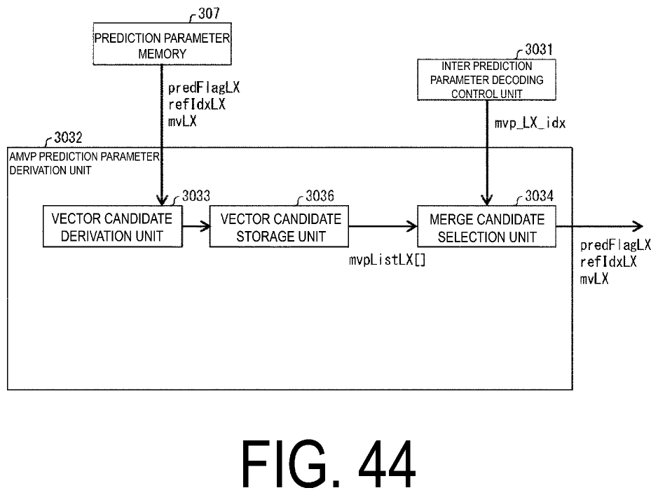

FIG. 44 is a schematic diagram illustrating a configuration of the AMVP prediction parameter derivation unit 3032 according to the present embodiment. The AMVP prediction parameter derivation unit 3032 includes a vector candidate derivation unit 3033, a vector candidate selection unit 3034, and a vector candidate storage unit 3036. The vector candidate derivation unit 3033 derives a prediction vector candidate from a motion vector mvLX of an already processed PU stored in the prediction parameter memory 307, based on the reference picture index refIdx, and stores the prediction vector candidate in the prediction vector candidate list mvpListLX [ ] of the vector candidate storage unit 3036.

The vector candidate selection unit 3034 selects the motion vector mvpListLX [mvp_lX_idx] indicated by the prediction vector index mvp_lX_idx among the prediction vector candidates of the prediction vector candidate list mvpListLX [ ] as the prediction vector mvpLX. The vector candidate selection unit 3034 outputs the selected prediction vector mvpLX to the addition unit 3035.

Note that the prediction vector candidate is derived by scaling a motion vector of a PU for which decoding processing is completed, the PU (for example, an adjacent PU) in a predetermined range from the decoding target PU. Note that the adjacent PU includes a PU spatially adjacent to the decoding target PU, such as, for example, a left PU and an upper PU, and a region that is temporally adjacent to the decoding target PU, for example, a region that is obtained from a prediction parameter of a PU with the same position as the decoding target PU but with a different display time. Note that, as described in the derivation of a temporal merge candidate, by changing the lower right block position of the collocated block to the lower right position in the rectangular slice illustrated in FIG. 20(f), in the case of rectangular_slice_flag=1, a rectangular slice sequence can be decoded independently by using an AMVP prediction without decreasing the coding efficiency.

The addition unit 3035 calculates the motion vector mvLX by adding the prediction vector mvpLX input from the AMVP prediction parameter derivation unit 3032 and the difference vector mvdLX input from the inter prediction parameter decoding control unit 3031. The addition unit 3035 outputs the calculated motion vector mvLX to the prediction image generation unit 308 and the prediction parameter memory 307.

Note that the motion vector derived in the merge prediction parameter derivation unit 3036 may not be output to the inter prediction image generation unit 309 as is, but may be output via the BTM predictor 3038.

### LIC Predictor 3039

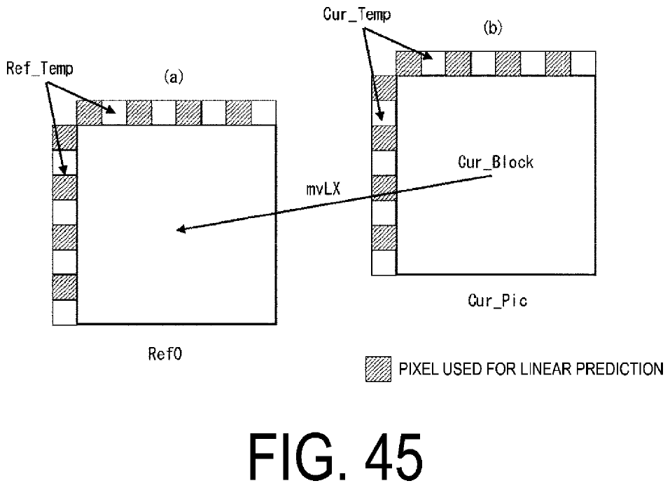

A Local Illumination Compensation (LIC) prediction is a processing for linearly predicting a pixel value of a target block Cur_block from pixel values of an adjacent region Ref_Temp (FIG. 45(a)) of a region on a reference picture pointed by a motion vector derived by a merge prediction, a subblock prediction, an AMVP prediction, or the like. and an adjacent region Cur_Temp (FIG. 45(b)) of the target block. As described in the equation below, a combination of a scale coefficient a and a offset b is calculated in which the square error SSD is minimized between the prediction value Cur_Temp′ of the adjacent region of the target block determined from the adjacent region Ref_Temp of the region on the reference picture, and the adjacent region Cur_Temp of the target block.

Cur_Temp′[ ][ ]=a*Ref_Temp[ ][ ]+b

SSD=ΣΣ(Cur_Temp′[x][y]−Cur_Temp[x][y])\hat{ }2 (Equation LIC-1)

Here, ΣΣ is the sum of x and y.

Note that in FIG. 45, the pixel values used in the calculation of a and b are subsampled, but may not be subsampled, and all pixel values in the region may be used.

In a case that a portion of any region of the adjacent region Cur_Temp of the target block or the adjacent region Ref_Temp of the reference block is located outside of the rectangular slice or the collocated rectangular slice, only the pixels in the rectangular slice or the collocated rectangular slice may be used. For example, in a case that the upper side adjacent region of the reference block is outside of the collocated rectangular slice, Cur_Temp and Ref_Temp only use pixels in the left side adjacent region of the target block and the reference block. For example, in a case that the left side adjacent region of the reference block is outside of the collocated rectangular slice, Cur_Temp and Ref_Temp may only use pixels in the upper side adjacent region of the target block and the reference block.

Alternatively, in a case that a portion of any region of the adjacent region Cur_Temp of the target block or the adjacent region Ref_Temp of the reference block is located outside of the rectangular slice or the collocated rectangular slice, an LIC prediction may be turned off and an LIC prediction may not be performed in the motion compensation unit 3091.

Alternatively, in a case that a portion of any region of the adjacent region Cur_Temp of the target block or the adjacent region Ref_Temp of the reference block is located outside of the rectangular slice or the collocated rectangular slice, in a case that the size of the region included in the rectangular slice or the collocated rectangular slice is greater than a threshold value, the region may be set by using pixels in the rectangular slice or the collocated rectangular slice, or otherwise an LIC prediction may be off. For example, in a case that the upper side adjacent region of the reference block is outside of the collocated rectangular slice and in a case of the threshold TH=16, Cur_Temp and Ref_Temp use pixels of the left side adjacent region of the target block and the reference block in a case that the height H of the target block is greater than 16, and an LIC prediction is turned off in a case that the height H of the target block is smaller than 16.

Note that the pixels used may be sub-sampled, or may not be sub-sampled, and all pixel values in the region may be used.

These processes require the slice coder 2012 and the slice decoder 2002 to select the same process.

The calculated a and b are output to the motion compensation unit 3091 along with a motion vector or the like.

### Inter Prediction Image Generation Unit 309

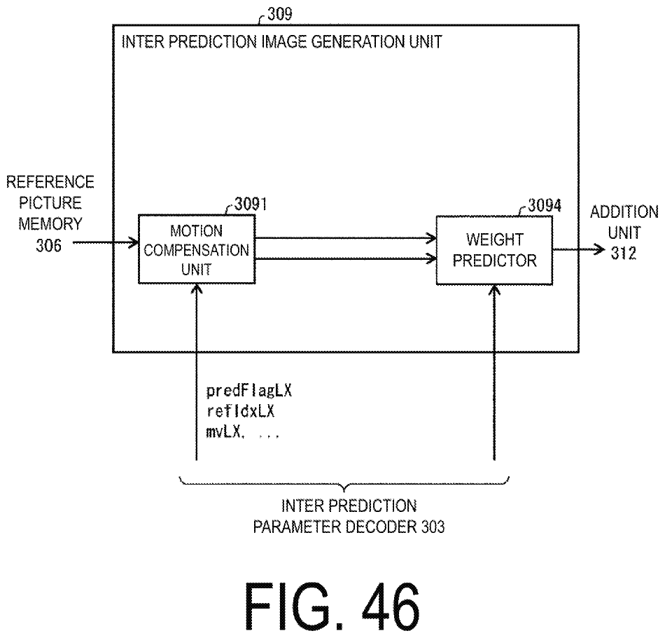

FIG. 46 is a schematic diagram illustrating a configuration of the inter prediction image generation unit 309 included in the prediction image generation unit 308 according to the present embodiment. The inter prediction image generation unit 309 includes a motion compensation unit (a prediction image generation unit) 3091 and a weight predictor 3094.

### Motion Compensation

The motion compensation unit 3091 generates an interpolation image (a motion compensation image) by reading a block at a position shifted by a motion vector mvLX, starting from a position of a decoding target PU, in a reference picture RefX specified by a reference picture index refIdxLX, from the reference picture memory 306, based on an inter prediction parameter input from the inter prediction parameter decoder 303 (such as a prediction list utilization flag predFlagLX, a reference picture index refIdxLX, a motion vector mvLX, an on/off flag, or the like). Here, in a case that the accuracy of the motion vector mvLX is not an integer accuracy, a filter called a motion compensation filter is applied to generate a pixel in a decimal fraction position to generate a motion compensation image.

In a case that the motion vector mvLX or the motion vector mvLXN input to the motion compensation unit 3091 is 1/M pixel accuracy (M is a natural number of two or more), an interpolation image is generated by an interpolation filter from a pixel value of a reference picture in an integer pixel position. That is, the interpolation image Pred [ ] [ ]described above is generated from a product-sum operation of an interpolation filter coefficient mcFilter [nFrac] [k] (k=0 . . . NTAP−1) of an NTAP tap corresponding to a phase nFrac and a pixel of a reference picture.

First, the motion compensation unit 3091 derives an integer position (xInt, yInt) and a phase (xFrac, yFrac) corresponding to an intra prediction block inside coordinate (x, y) by using the following equation.

xInt=xb+(mvLX[0]>>(log 2(M)))+x

xFrac=mvLX[0]&(M−1)

yInt=yb+(mvLX[1]>>(log 2(M)))+y

yFrac=mvLX[1]&(M−1) (Equation INTER-1)

Here, (xb, yb) is the upper left coordinate of the block, x=0 . . . nW−1, y=0 . . . nH−1, and M indicates the accuracy of the motion vector mvLX (1/M pixel accuracy).

The motion compensation unit 3091 derives a temporary image temp [ ] [ ] by performing a horizontal interpolation processing on a reference picture refImg by using an interpolation filter. The following Σ is a sum in terms of k of k=0 . . . NTAP−1, and shift1 is a normalized parameter to adjust the range of the value, offset1=1<<(shift1−1).

Temp[x][y]=(ΣmcFilter[xFrac][k]*refImg[xInt+k−NTAP/2+1][yInt]+offset1)>>shift1 (Equation INTER-2)

Note that the padding described below is performed in a case that reference is made to the pixel refImg [xInt+k−NTAP/2+1] [yInt] on the reference picture.

Subsequently, the motion compensation unit 3091 derives an interpolation image Pred [ ] [ ] by a vertical interpolation processing on the temporary image temp [ ] [ ]. The following Σ is a sum in terms of k of k=0 . . . NTAP−1, and shift2 is a normalized parameter to adjust the range of the value, offset2=1<<(shift2−1).

Pred[x][y]=(ΣmcFilter[yFrac][k]*temp[x][y+k−NTAP/2+1]+offset2)>>shift2 (Equation INTER-3)

Note that in the case of a bi-prediction, Pred [ ] [ ] described above is derived for each of the lists L0 and L1 (referred to as an interpolation image PredL0 [ ] [ ] and an interpolation image PredL1 [ ] [ ]), and an interpolation image Pred [ ] [ ] is generated from the interpolation image PredL0 [ ] [ ] and the interpolation image PredL1 [ ] [ ].

Note that in a case that the input motion vector mvLX or the motion vector mvLXN points to outside of the collocated rectangular slice of the rectangular slice in which the target block is located even partially, the rectangular slice can be independently performed an inter prediction by padding the rectangular slice boundary in advance.

### Padding

In the above (Equation INTER-2), reference is made to the pixel refImg [xInt+k−NTAP/2+1] [yInt] on the reference picture, but in a case of referring to a pixel value outside of the picture that does not actually exist, the following picture boundary padding (offpicture padding) is performed. The picture boundary padding is achieved by using a pixel value refImg [xRef+i] [yRef+j] at a following position xRef+i, yRef+j, as a pixel value at a position of a reference pixel (xIntL+i, yIntL+j).

xRef+i=Clip3(0,pic_width_in_luma_samples−1,xIntL+i)

yRef+j=Clip3(0,pic_height_in_luma_samples−1,yIntL+j) (Equation PAD-3)

Note that rectangular slice boundary padding (Equation PAD-1) may be performed instead of the picture boundary padding (Equation PAD-3).

### OBMC Interpolation Image Generation

In OBMC, two types of interpolation images are generated, including an interpolation image of a target subblock derived based on an inter prediction parameter of the target block, and an interpolation image derived based on an inter prediction parameter of an adjacent block, and an interpolation image that is used for prediction is ultimately generated by performing weighting processing on these. Here, an interpolation image of a target subblock derived based on an inter prediction parameter of the target block is referred to as an interpolation image PredC (a first OBMC interpolation image), and an interpolation image derived based on an inter prediction parameter of an adjacent block is referred to as an interpolation image PredRN (a second OBMC interpolation image). Note that N indicates either of the upper side (A), the left side (L), the lower side (B), and the right side (R) of the target subblock. In a case that the OBMC processing is not performed (OBMC off), the interpolation image PredC becomes a motion compensation image PredLX of the target subblock as is. In a case that the OBMC processing is performed (OBMC on), a motion compensation image PredLX of the target subblock is generated from the interpolation image PredC and the interpolation image PredRN.

The motion compensation unit 3091 generates an interpolation image, based on an inter prediction parameter of the target subblock input from the inter prediction parameter decoder 303 (the prediction list utilization flag predFlagLX, the reference picture index refIdxLX, the motion vector mvLX, and the OBMC flag obmc_flag).

FIG. 42(b) is a flowchart describing the operations of the interpolation image generation in the OBMC prediction of the motion compensation unit 3091.

First, the motion compensation unit 3091 generates an interpolation image PredC [x] [y] (x=0 . . . BW−1, y=0 . . . BH−1), based on a prediction parameter (S3411).

Next, it is determined whether or not obmc_flag [i]=1 (S3413). In a case of obmc_flag [i]=0 (N in S3413), the process proceeds in the next direction (i=i+1). In a case of obmc_flag [i]=1 (Y in S3413), an interpolation image PredRN [x] [y] is generated (S3414). In other words, only for the subblocks in the direction indicated by i being obmc_flag [i]=1, an interpolation image PredRN [x] [y] (x=0 . . . BW−1, y=0 . . . BH−1) is generated (S3414) based on the prediction list utilization flag predFlagLX [xPbN] [yPbN] of the adjacent block input from the inter prediction parameter decoder 303, the reference picture index refIdxLX [xPbN] [yPbN], and the motion vector mvLX [xPbN] [yPbN], and a weighted average processing of the interpolation image PredC [x][y] and the interpolation image PredRN [x] [y] described below is performed (S3415), to generate an interpolation image PredLX (S3416). Note that (xPbN, yPbN) is the upper left coordinate of the adjacent block.

The weighted average processing is then performed (S3415).

In the configuration of performing the OBMC processing, the motion compensation unit 3091 performs a weighted average processing on the interpolation image PredC [x] [y] and the interpolation image PredRN [x] [y] to update the interpolation image PredC [x] [y]. Specifically, in a case of the OBMC flag obmc_flag [i]=1 (the OBMC processing is effective) input from the inter prediction parameter decoder 303, the motion compensation unit 3091 performs the following weighted average processing on S pixels of the subblock boundary in the direction indicated by i.

PredC[x][y]=((w1*PredC[x][y]+w2*PredRN[x][y])+o)>>shift (Equation INTER-4)

Here, weights w1 and w2 in the weighted average processing will be described. the weights w1 and w2 in the weighted average processing are determined according to the distance (number of pixels) of the target pixel from the subblock boundary. They have a relationship of w1+w2=(1<<shift), o=1<<(shift−1).

In the OBMC processing, a prediction image is generated by using interpolation images of multiple adjacent blocks. Here, a method for updating PredC [x] [y] from motion parameters of multiple adjacent blocks will be described.

First, in a case of obmc_flag [1]=1, the motion compensation unit 3091 updates PredC [x] [y] by applying an interpolation image PredRA [x] [y] created by using the motion parameter of the upper side adjacent block to the interpolation image PredC [x] [y]of the target subblock.

PredC[x][y]=((w1*PredC[x][y]+w2*PredRA[x][y])+o)>>shift (Equation INTER-5)

Next, the motion compensation unit 3091 updates PredC [x] [y] sequentially by using the interpolation images PredRL [x] [y], PredRL [x] [y], and PredRL [x] [y] created by using the motion parameters of the adjacent blocks on the left side (i=2), the lower side (i=3), and the right side (i=4) of the target subblock for the direction i where obmc_flag [i]=1. That is, the updates are made by the following equation.

PredC[x][y]=((w1*PredC[x][y]+w2*PredRL[x][y])+o)>>shift

PredC[x][y]=((w1*PredC[x][y]+w2*PredRB[x][y])+o)>>shift

PredC[x][y]=((w1*PredC[x][y]+w2*PredRR[x][y])+o)>>shift (Equation INTER-6)

In a case of obmc_flag [0]=0, or after performing the above-described process for i=1 to 4, PredC [x] [y] is set to the prediction image PredLX [x] [y] (S3416).

PredLX[x][y]=PredC[x][y] (Equation INTER-7)

As described above, the motion compensation unit 3091 can generate a prediction image in consideration of a motion parameter of an adjacent block of a target subblock, and thus can generate a prediction image with high prediction accuracy in the OBMC processing.

The number of pixels S of the subblock boundary updated by the OBMC processing may be arbitrary (S=2 to block size). The manner of partitioning of a block including a subblock to be subjected to the OBMC processing may also be in any manner of partitioning such as 2N×N, N×2N, N×N, and the like.

By deriving a motion vector of OBMC and generating a prediction image in this manner, even in a case that the motion vector of the subblock points to outside of the rectangular slice, a reference pixel is replaced with a pixel value in the rectangular slice. Accordingly, a reduction in the frequency of use of the OBMC processing can be suppressed, and the rectangular slices can be independently performed an inter prediction, so the coding efficiency can be increased.

### LIC Interpolation Image Generation

In LIC, a prediction image PredLX is generated by using a scale coefficient a and an offset b calculated by the LIC predictor 3039 to modify the interpolation image Pred of the target block derived in (Equation INTER-3).

PredLX[x][y]=Pred[x][y]*a+b (Equation INTER-8)

### Weight Prediction

The weight predictor 3094 generates a prediction image of a target block by multiplying the input motion compensation image PredLX by a weighting coefficient. In a case that one of the prediction list utilization flags (predFlagL0 or predFlagL1) is 1 (in the case of a uni-prediction), and in a case that an weight prediction is not used, a processing of the following equation is performed by which the input motion compensation image PredLX (LX is L0 or L1) is combined with the number of pixel bits bitDepth.

Pred[x][y]=Clip3(0,(1<<bitDepth)−1,(PredLX[x][y]+offset1)>>shift1) (Equation INTER-9)

Here, shift1=14−bitDepth, offset1=1<<(shift1−1). In a case that both of the prediction list utilization flags (predFlagL0 and predFlagL1) are 1 (in the case of a bi-prediction BiPred), and in a case that an weight prediction is not used, a processing of the following equation is performed by which the input motion compensation images PredL0 and PredL1 are averaged and combined to the number of pixel bits.

Pred[x][y]=Clip3(0,(1<<bitDepth)−1,(PredL0[x][y]+PredL1[x][y]+offset2)>>shift2) (Equation INTER-10)

Here, shift2=15−bitDepth, offset2=1<<(shift2−1).

Furthermore, in the case of a uni-prediction, and in a case that a weight prediction is performed, the weight predictor 3094 derives a weighting prediction coefficient w0 and an offset o0 from the coded data, and performs the processing according to the following equation.

Pred[x][y]=Clip3(0,(1<<bitDepth)−1,((PredLX[x][y]*w0+2(log 2WD−1))>>log 2WD)+o0) (Equation INTER-11)

Here, log 2WD is a variable indicating a prescribed shift amount.

Furthermore, in the case of a bi-prediction BiPred, and in a case that a weight prediction is performed, the weight predictor 3094 derives weighting prediction coefficients w0, w1, o0, and o1 from the coded data, and performs the processing according to the following equation.

Pred[x][y]=Clip3(0,(1<<bitDepth)−1,(PredL0[x][y]*w0+PredL1[x][y]*w1+((o0+o1+1)<<log 2WD))>>(log 2WD+1)) (INTER-12)

With such a configuration, the video decoding apparatus 31 can independently decode a rectangular slice in rectangular slice sequence units in a case that the value of rectangular_slice_flag is 1. As a mechanism is introduced to ensure the independence of decoding of each rectangular slice for each individual tool, each rectangular slice can be independently decoded in the video while minimizing a decrease in the coding efficiency. As a result, the region required for display or the like can be selected and decoded, so that the amount of processing can be greatly reduced.

### Configuration of Video Coding Apparatus

FIG. 15(b) illustrates the video coding apparatus 11 of the present invention. The video coding apparatus 11 includes a picture partitioning processing unit 2010, a header information generation unit 2011, slice coders 2012a to 2012n, and a coding stream generation unit 2013. FIG. 16(a) is a flowchart of the video coding apparatus.

In a case that a slice is a rectangular slice (Y at S1601), the picture partitioning processing unit 2010 partitions the picture into multiple rectangular slices that do not overlap each other, and transmits the rectangular slices to the slice coders 2012a to 2012n. In a case that a slice is a general slice, the picture partitioning processing unit 2010 partitions the picture into any shape and transmits the slices to the slice coders 2012a to 2012n.

In the case that the slice is a rectangular slice (Y at S1601), the header information generation unit 2011 generates rectangular slice information (SliceId, and information related to the number and size of regions of the rectangular slices) from the partitioned rectangular slices. The header information generation unit 2011 also determines a rectangular slice for inserting an I slice (S1602). The header information generation unit 2011 transmits the rectangular slice information and the information related to the I slice insertion to the coding stream generation unit 2013 as the header information (S1603).

The slice coders 2012a to 2012n code each rectangular slice in a unit of rectangular slice sequence (S1604). In this manner, by the slice coders 2012a to 2012n, coding processing can be performed in parallel on the rectangular slices.

Here, the slice coders 2012a to 2012n perform coding processing on a rectangular slice sequence, similarly to one independent video sequence, and do not refer to prediction information of a rectangular slice sequence of a different SliceId temporally or spatially in a case of performing coding processing. That is, the slice coders 2012a to 2012n do not refer to a different rectangular slice spatially or temporally in a case of coding a rectangular slice in a picture. In a case of a general slice, the slice coders 2012a to 2012n perform coding processing on each slice sequence, while sharing information of the reference picture memory.

The coding stream generation unit 2013 generates a coding stream Te in a unit of NAL unit, from the header information including the rectangular slice information transmitted from the header information generation unit 2011 and the coding stream TeS of the rectangular slices output by the slice coders 2012a to 2012n. In a case of a general slice, the coding stream generation unit 2013 generates a coding stream Te in a unit of NAL unit from the header information and the unreasonable stream TeS.

In this way, the slice coders 2012a to 2012n can independently code each rectangular slice, so that coding processing can be performed in parallel on multiple rectangular slices.

### Configuration of Slice Coder

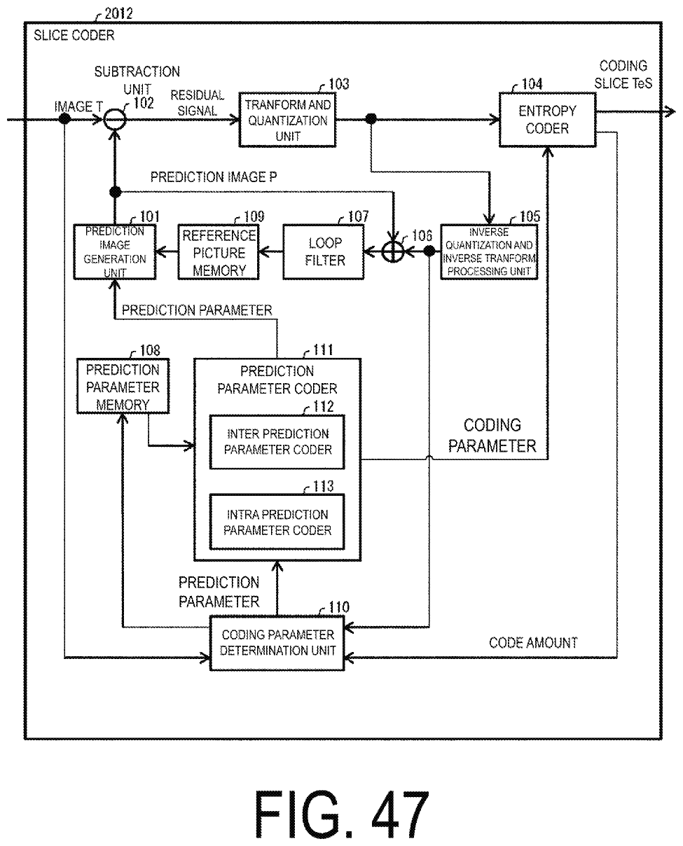

Next, a configuration of the slice coders 2012a to 2012n will be described. As an example below, the configuration of the slice coder 2012a will be described with reference to FIG. 47. FIG. 47 is a block diagram illustrating a configuration of 2012, which is one of the slice coders 2012a to 2012n. FIG. 47 is a block diagram illustrating a configuration of the slice coder 2012 according to the present embodiment. The slice coder 2012 includes a prediction image generation unit 101, a subtraction unit 102, a transform processing and quantization unit 103, an entropy coder 104, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, and a prediction parameter coder 111. The prediction parameter coder 111 includes an inter prediction parameter coder 112 and an intra prediction parameter coder 113. Note that the slice coder 2012 may have a configuration in which the loop filter 107 is not included.

For each picture of an image T, the prediction image generation unit 101 generates a prediction image P of a prediction unit PU for each coding unit CU, which is a region where the picture is partitioned. Here, the prediction image generation unit 101 reads a block that has been decoded from the reference picture memory 109, based on a prediction parameter input from the prediction parameter coder 111. For example, in a case of an inter prediction, the prediction parameter input from the prediction parameter coder 111 is a motion vector. The prediction image generation unit 101 reads a block at a position on a reference picture indicated by a motion vector starting from a target PU. In a case of an intra prediction, the prediction parameter is, for example, an intra prediction mode. The prediction image generation unit 101 reads a pixel value of an adjacent PU used in an intra prediction mode from the reference picture memory 109, and generates a prediction image P of a PU. The prediction image generation unit 101 generates the prediction image P of the PU by using one prediction scheme among multiple prediction schemes for the read reference picture block. The prediction image generation unit 101 outputs the generated prediction image P of the PU to the subtraction unit 102.

Note that the prediction image generation unit 101 is an operation same as the prediction image generation unit 308 already described, and thus descriptions thereof will be omitted.

The prediction image generation unit 101 generates the prediction image P of the PU, based on a pixel value of a reference block read from the reference picture memory, by using a parameter input from the prediction parameter coder. The prediction image generated by the prediction image generation unit 101 is output to the subtraction unit 102 and the addition unit 106.

The intra prediction image generation unit (not illustrated) included in the prediction image generation unit 101 is an operation same as the intra prediction image generation unit 310 already described.

The subtraction unit 102 subtracts a signal value of the prediction image P of the PU input from the prediction image generation unit 101 from a pixel value at a corresponding PU position of the image T, and generates a residual signal. The subtraction unit 102 outputs the generated residual signal to the transform processing and quantization unit 103.

The transform processing and quantization unit 103 performs a frequency transform for the prediction residual signal input from the subtraction unit 102, and calculates a transform coefficient. The transform processing and quantization unit 103 quantizes the calculated transform coefficients to calculate quantization transform coefficients. The transform processing and quantization unit 103 outputs the calculated quantization transform coefficients to the entropy coder 104 and the inverse quantization and inverse transform processing unit 105.

To the entropy coder 104, the quantization transform coefficients are input from the transform processing and quantization unit 103, and prediction parameters are input from the prediction parameter coder 111. For example, the input prediction parameters include codes such as a reference picture index ref_idx_lX, a prediction vector index mvp_lX_idx, a difference vector mvdLX, a prediction mode pred_mode_flag, and a merge index merge_idx.

The entropy coder 104 performs entropy coding on the input partitioning information, the prediction parameters, the quantization transform coefficients, and the like to generate the coding stream TeS, and outputs the generated coding stream TeS to the outside.

The inverse quantization and inverse transform processing unit 105 is the same as the inverse quantization and inverse transform processing unit 311 (FIG. 18) in the rectangular slice decoder 2002, and dequantizes the quantization transform coefficients input from the transform processing and quantization unit 103 to calculate the transform coefficients. The inverse quantization and inverse transform processing unit 105 performs inverse transform on the calculated transform coefficients to calculate a residual signal. The inverse quantization and inverse transform processing unit 105 outputs the calculated residual signal to the addition unit 106.

The addition unit 106 adds a signal value of the prediction image P of the PU input from the prediction image generation unit 101 and a signal value of the residual signal input from the inverse quantization and inverse transform processing unit 105 for each pixel, and generates the decoded image. The addition unit 106 stores the generated decoded image in the reference picture memory 109.

The loop filter 107 performs a deblocking filter, a sample adaptive offset (SAO), and an adaptive loop filter (ALF) to the decoded image generated by the addition unit 106. Note that the loop filter 107 need not necessarily include the three types of filters described above, and may be configured with a deblocking filter only, for example.

The prediction parameter memory 108 stores the prediction parameter generated by the coding parameter determination unit 110 for each picture and CU of the coding target in a predetermined position.

The reference picture memory 109 stores the decoded image generated by the loop filter 107 for each picture and CU of the coding target in a predetermined position. Note that the memory management of a reference picture is the same as the process of the reference picture memory 306 of the video decoding apparatus described above, and thus descriptions thereof will be omitted.

The coding parameter determination unit 110 selects one set among multiple sets of coding parameters. A coding parameter is an above-mentioned QT or BT partitioning parameter or a prediction parameter or a parameter to be a target of coding which is generated associated with these. The prediction image generation unit 101 generates the prediction image P of the PU by using each of the sets of these coding parameters.

The coding parameter determination unit 110 calculates an RD cost value indicating the volume of the information quantity and coding errors for each of the multiple sets. For example, the RD cost value is a sum of a code amount and a value of multiplying a square error by a coefficient X. The code amount is an information quantity of the coding stream TeS obtained by performing entropy coding on a quantization residual and a coding parameter. The square error is a sum of pixels for square values of residual values of residual signals calculated in the subtraction unit 102. The coefficient X is a pre-configured real number that is larger than a zero. The coding parameter determination unit 110 selects a set of coding parameters by which the calculated RD cost value is minimized. With this configuration, the entropy coder 104 outputs the selected set of coding parameters as the coding stream TeS to the outside, and does not output sets of coding parameters that are not selected. The coding parameter determination unit 110 stores the determined coding parameters in the prediction parameter memory 108.

The prediction parameter coder 111 derives a format for coding from the parameters input from the coding parameter determination unit 110, and outputs the format to the entropy coder 104. The derivation of the format for coding is, for example, to derive a difference vector from a motion vector and a prediction vector. The prediction parameter coder 111 derives parameters necessary to generate a prediction image from the parameters input from the coding parameter determination unit 110, and outputs the parameters to the prediction image generation unit 101. For example, the parameters necessary to generate a prediction image are a motion vector in a unit of subblock.

The inter prediction parameter coder 112 derives a inter prediction parameter, based on the prediction parameters input from the coding parameter determination unit 110. The inter prediction parameter coder 112 includes a partly identical configuration to the configuration in which the inter prediction parameter decoder 303 derives inter prediction parameters, as a configuration to derive the parameters necessary for generation of a prediction image output to the prediction image generation unit 101. A configuration of the inter prediction parameter coder 112 will be described later.

The intra prediction parameter coder 113 includes a partly identical configuration to the configuration in which the intra prediction parameter decoder 304 derives intra prediction parameters, as a configuration to derive the prediction parameters necessary for generation of a prediction image output to the prediction image generation unit 101.

The intra prediction parameter coder 113 derives a format for coding (for example, MPM_idx, rem_intra_luma_pred_mode, and the like) from the intra prediction mode IntraPredMode input from the coding parameter determination unit 110.

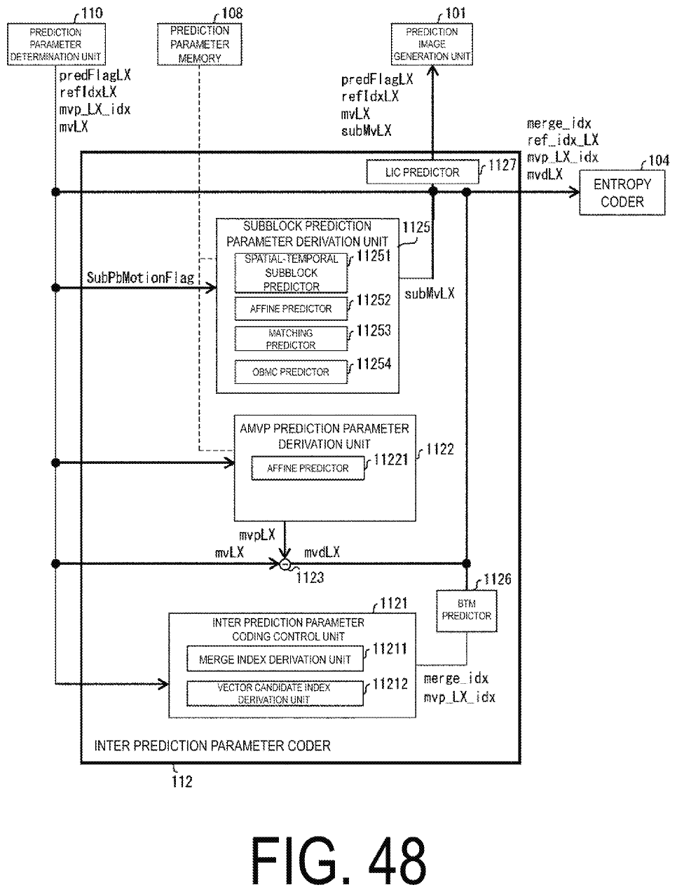

Configuration of Inter Prediction Parameter Coder Next, a configuration of the inter prediction parameter coder 112 will be described. The inter prediction parameter coder 112 is a unit corresponding to the inter prediction parameter decoder 303 of FIG. 28, and FIG. 48 illustrates the configuration.

The inter prediction parameter coder 112 includes an inter prediction parameter coding control unit 1121, an AMVP prediction parameter derivation unit 1122, a subtraction unit 1123, a subblock prediction parameter derivation unit 1125, a BTM predictor 1126, and a LIC predictor 1127, and a partitioning mode derivation unit, a merge flag derivation unit, an inter prediction indicator derivation unit, a reference picture index derivation unit, a vector difference derivation unit or the like not illustrated, and each of the partitioning mode derivation unit, the merge flag derivation unit, the inter prediction indicator derivation unit, the reference picture index derivation unit, and the vector difference derivation unit derives a PU partitioning mode part_mode, a merge flag merge_flag, an inter prediction indicator inter_pred_ide, a reference picture index refIdxLX, and a difference vector mvdLX, respectively. The inter prediction parameter coder 112 outputs a motion vector (mvLX, subMvLX), a reference picture index refIdxLX, a PU partitioning mode part_mode, an inter prediction indicator inter_pred_ide, or information for indicating these to the prediction image generation unit 101. The inter prediction parameter coder 112 outputs a PU partitioning mode part_mode, a merge flag merge_flag, a merge index merge_idx, an inter prediction indicator inter_pred_idc, a reference picture index refIdxLX, a prediction vector index mvp_lX_idx, a difference vector mvdLX, and a subblock prediction mode flag subPbMotionFlag to the entropy coder 104.

The inter prediction parameter coding control unit 1121 includes a merge index derivation unit 11211 and a vector candidate index derivation unit 11212. The merge index derivation unit 11211 compares a motion vector and a reference picture index input from the coding parameter determination unit 110 with a motion vector and a reference picture index possessed by a PU of a merge candidate read from the prediction parameter memory 108 to derive a merge index merge_idx, and outputs it to the entropy coder 104. The merge candidate is a reference PU in a predetermined range from a coding target CU being a coding target (for example, a reference PU adjoining the lower left end, the upper left end, and the upper right end of the coding target block), and is a PU for which a coding process is completed. The vector candidate index derivation unit 11212 derives a prediction vector index mvp_lX_idx.

In a case that the coding parameter determination unit 110 determines the use of a subblock prediction mode, the subblock prediction parameter derivation unit 1125 derives a motion vector and a reference picture index for a subblock prediction of any of a spatial subblock prediction, a temporal subblock prediction, an affine prediction, a matching motion derivation, and an OBMC prediction, in accordance with the value of subPbMotionFlag. As described in the description of the rectangular slice decoder 2002, the motion vector and the reference picture index are derived by reading out a motion vector or a reference picture index of an adjacent PU, a reference picture block, or the like from the prediction parameter memory 108. The subblock prediction parameter derivation unit 1125, and a spatial-temporal subblock predictor 11251, an affine predictor 11252, a matching predictor 11253, and an OBMC predictor 11254 included in the subblock prediction parameter derivation unit 1125 have configurations similar to the subblock prediction parameter derivation unit 3037 of the inter prediction parameter decoder 303, and the spatial-temporal subblock predictor 30371, the affine predictor 30372, the matching predictor 30373, and the OBMC predictor 30374 included in the subblock prediction parameter derivation unit 3037.

The AMVP prediction parameter derivation unit 1122 includes an affine predictor 11221, and has a configuration similar to the AMVP prediction parameter derivation unit 3032 (see FIG. 28) described above.

In other words, in a case that the prediction mode predMode indicates an inter prediction mode, a motion vector mvLX is input to the AMVP prediction parameter derivation unit 1122 from the coding parameter determination unit 110. The AMVP prediction parameter derivation unit 1122 derives a prediction vector mvpLX, based on the input motion vector mvLX. The AMVP prediction parameter derivation unit 1122 outputs the derived prediction vector mvpLX to the subtraction unit 1123. Note that the reference picture index refIdxLX and the prediction vector index mvp_lX_idx are output to the entropy coder 104. The affine predictor 11221 has a configuration similar to the affine predictor 30321 (see FIG. 28) of the AMVP prediction parameter derivation unit 3032 described above. The LIC predictor 1127 has a configuration similar to the LIC predictor 3039 (see FIG. 28) described above.

The subtraction unit 1123 subtracts the prediction vector mvpLX input from the AMVP prediction parameter derivation unit 1122 from the motion vector mvLX input from the coding parameter determination unit 110, and generates a difference vector mvdLX. The difference vector mvdLX is output to the entropy coder 104.

A video coding apparatus according to an aspect of the present invention includes: in coding of a slice resulting from partitioning of a picture, a first coder unit configured to code a sequence parameter set including information related to a plurality of the pictures; a second coder unit configured to code information indicating a position and a size of the slice on the picture; a third coder unit configured to code the picture on a slice unit basis, and a fourth coder unit configured to code a NAL header unit, wherein the first coder unit codes a flag indicating whether a shape of the slice is rectangular or not, the position and the size of the slice that is rectangular and has a same slice ID is not changed in a period of time in which each of the plurality of the pictures refers to a same sequence parameter set in a case that the flag indicates that the shape of the slice is rectangular, and the slice that is rectangular is coded independently without reference to information of another slice within the picture and without reference to information of another slice among the plurality of the pictures by the slice that is rectangular.

A video decoding apparatus according to an aspect of the present invention includes: in decoding of a slice resulting from partitioning of a picture, a first decoder unit configured to decode a sequence parameter set including information related to a plurality of the pictures; a second decoder unit configured to decode information indicating a position and a size of the slice on the picture; a third decoder unit configured to decode the picture on a slice unit basis, and a fourth decoder unit configured to decode a NAL header unit, wherein the first decoder unit decodes a flag indicating whether a shape of the slice is rectangular or not, the position and the size of the slice that is rectangular and has a same slice ID are not changed in a period of time in which each of the plurality of the pictures refers to a same sequence parameter set in a case that the flag indicates that the shape of the slice is rectangular, and the slice that is rectangular is decoded without reference to information of another slice within a picture and without reference to information of another slice that is rectangular among the plurality of the pictures by the slice that is rectangular.

In a video coding apparatus or a video decoding apparatus according to an aspect of the present invention, the independent coding or decoding processing of the slice that is rectangular refers to only a block included in the slice that is collocated and rectangular, and derives a prediction vector candidate in a temporal direction

In a video coding apparatus or a video decoding apparatus according to an aspect of the present invention, the independent coding or decoding processing of the slice that is rectangular clips a reference position at positions of upper, lower, left, and right boundary pixels of the slice that is collocated and rectangular in reference of a reference picture by motion compensation.

In a video coding apparatus or a video decoding apparatus according to an aspect of the present invention, the independent coding or decoding processing of the slice that is rectangular limits a motion vector such that the motion vector enters within the slice that is collocated and rectangular in motion compensation.

In a video coding apparatus according to an aspect of the present invention, the first coder unit codes a maximum value of a temporal hierarchy identifier and an insertion period of an intra slice.

In a video decoding apparatus according to an aspect of the present invention, the first decoder unit decodes a maximum value of a temporal hierarchy identifier and an insertion period of an intra slice.

In a video coding apparatus according to an aspect of the present invention, the third coder unit codes intra slices in a unit of the plurality of the pictures, and an insertion position of an intra slice of the intra slices is a picture of which a temporal hierarchy identifier is zero.

In a video coding apparatus according to an aspect of the present invention, the fourth coder unit codes an identifier indicating a type of NAL unit, an identifier indicating a layer to which NAL belongs, and a temporal identifier, and codes in addition the slice ID in a case that the NAL unit stores data including a slice header.

In a video decoding apparatus according to an aspect of the present invention, the fourth decoder unit codes an identifier indicating a type of NAL unit, an identifier indicating a layer to which NAL belongs, and a temporal identifier, and codes in addition the slice ID in a case that the NAL unit stores data including a slice header.

### Implementation Examples by Software

Note that, part of the slice coder 2012 and the slice decoder 2002 in the above-mentioned embodiments, for example, the entropy decoder 301, the prediction parameter decoder 302, the loop filter 305, the prediction image generation unit 308, the inverse quantization and inverse transform processing unit 311, the addition unit 312, the prediction image generation unit 101, the subtraction unit 102, the transform processing and quantization unit 103, the entropy coder 104, the inverse quantization and inverse transform processing unit 105, the loop filter 107, the coding parameter determination unit 110, and the prediction parameter coder 111, may be realized by a computer. In that case, this configuration may be realized by recording a program for realizing such control functions on a computer-readable recording medium and causing a computer system to read the program recorded on the recording medium for execution. Note that it is assumed that the “computer system” mentioned here refers to a computer system built into either the slice coder 2012 or the slice decoder 2002, and the computer system includes an OS and hardware components such as a peripheral apparatus. The “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. The program may be configured to realize some of the functions described above, and also may be configured to be capable of realizing the functions described above in combination with a program already recorded in the computer system.

Part or all of the video coding apparatus 11 and the video decoding apparatus 31 in the embodiments described above may be realized as an integrated circuit such as a Large Scale Integration (LSI). Each function block of the video coding apparatus 11 and the video decoding apparatus 31 may be individually realized as a processor, or part or all may be integrated into a processor. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

The embodiment of the present invention has been described in detail above referring to the drawings, but the specific configuration is not limited to the above embodiments and various amendments can be made to a design that fall within the scope that does not depart from the gist of the present invention.

### Application Examples

The above-mentioned video coding apparatus 11 and the video decoding apparatus 31 can be utilized being installed to various apparatuses performing transmission, reception, recording, and regeneration of videos. Note that, videos may be natural videos imaged by cameras or the like, or may be artificial videos (including CG and GUI) generated by computers or the like.

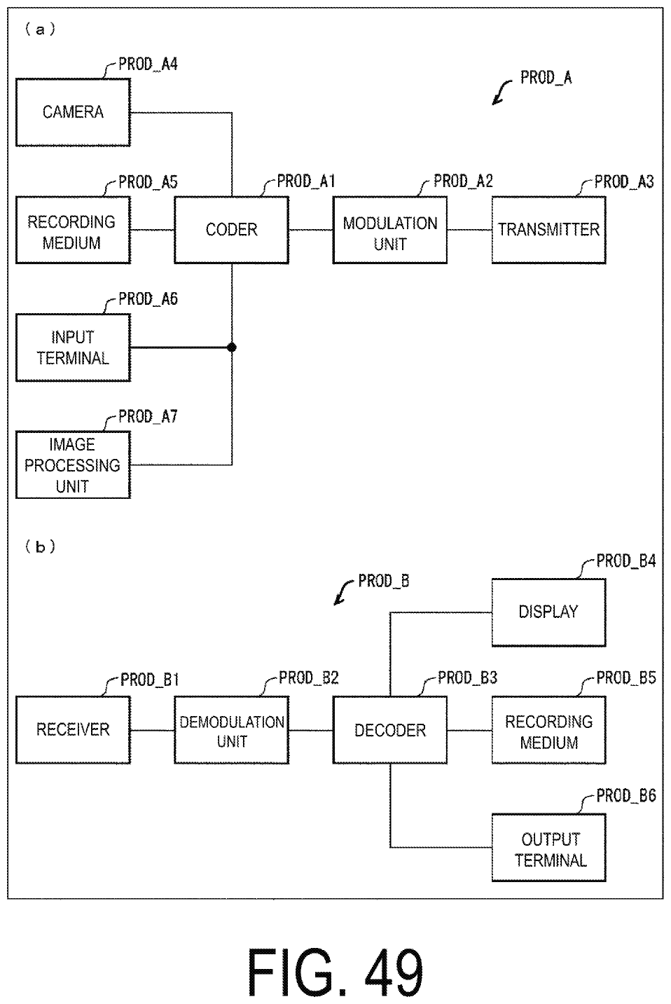

At first, referring to FIG. 49, it will be described that the above-mentioned video coding apparatus 11 and the video decoding apparatus 31 can be utilized for transmission and reception of videos.

(a) of FIG. 49 is a block diagram illustrating a configuration of a transmitting apparatus PROD_A installed with the video coding apparatus 11. As illustrated in (a) of FIG. 49, the transmitting apparatus PROD_A includes a coder PROD_A1 which obtains coded data by coding videos, a modulation unit PROD_A2 which obtains modulating signals by modulating carrier waves with the coded data obtained by the coder PROD_A1, and a transmitter PROD_A3 which transmits the modulating signals obtained by the modulation unit PROD_A2. The above-mentioned video coding apparatus 11 is utilized as the coder PROD_A1.

The transmitting apparatus PROD_A may further include a camera PROD_A4 for imaging videos, a recording medium PROD_A5 for recording videos, an input terminal PROD_A6 to input videos from the outside, and an image processing unit PRED_A7 which generates or processes images, as sources of supply of the videos input into the coder PROD_A1. In (a) of FIG. 49, although the configuration that the transmitting apparatus PROD_A includes these all is exemplified, a part may be omitted.

Note that the recording medium PROD_A5 may record videos which are not coded, or may record videos coded in a coding scheme for recording different than a coding scheme for transmission. In the latter case, a decoder (not illustrated) to decode coded data read from the recording medium PROD_A5 according to a coding scheme for recording may be interleaved between the recording medium PROD_A5 and the coder PROD_A1.

(b) of FIG. 49 is a block diagram illustrating a configuration of a receiving apparatus PROD_B installed with the video decoding apparatus 31. As illustrated in (b) of FIG. 49, the receiving apparatus PROD_B includes a receiver PROD_B1 which receives modulating signals, a demodulation unit PROD_B2 which obtains coded data by demodulating the modulating signals received by the receiver PROD_B1, and a decoder PROD_B3 which obtains videos by decoding the coded data obtained by the demodulation unit PROD_B2. The above-mentioned video decoding apparatus 31 is utilized as the decoder PROD_B3.

The receiving apparatus PROD_B may further include a display PROD_B4 for displaying videos, a recording medium PROD_B5 to record the videos, and an output terminal PROD_B6 to output videos outside, as supply destination of the videos output by the decoder PROD_B3. In (b) of FIG. 49, although the configuration that the receiving apparatus PROD_B includes these all is exemplified, a part may be omitted.

Note that the recording medium PROD_B5 may record videos which are not coded, or may record videos which are coded in a coding scheme for recording different from a coding scheme for transmission. In the latter case, a coder (not illustrated) to code videos acquired from the decoder PROD_B3 according to a coding scheme for recording may be interleaved between the decoder PROD_B3 and the recording medium PROD_B5.

Note that the transmission medium for transmitting modulating signals may be wireless or may be wired. The transmission aspect to transmit modulating signals may be broadcasting (here, referred to as the transmission aspect where the transmission target is not specified beforehand) or may be telecommunication (here, referred to as the transmission aspect that the transmission target is specified beforehand). Thus, the transmission of the modulating signals may be realized by any of radio broadcasting, cable broadcasting, radio communication, and cable communication.

For example, broadcasting stations (broadcasting equipment, and the like)/receiving stations (television receivers, and the like) of digital terrestrial television broadcasting are examples of the transmitting apparatus PROD_A/receiving apparatus PROD_B for transmitting and/or receiving modulating signals in radio broadcasting. Broadcasting stations (broadcasting equipment, and the like)/receiving stations (television receivers, and the like) of cable television broadcasting are examples of the transmitting apparatus PROD_A/receiving apparatus PROD_B for transmitting and/or receiving modulating signals in cable broadcasting.

Servers (work stations, and the like)/clients (television receivers, personal computers, smartphones, and the like) for Video On Demand (VOD) services, video hosting services using the Internet and the like are examples of the transmitting apparatus PROD_A/receiving apparatus PROD_B for transmitting and/or receiving modulating signals in telecommunication (usually, any of radio or cable is used as transmission medium in the LAN, and cable is used for as transmission medium in the WAN). Here, personal computers include a desktop PC, a laptop type PC, and a graphics tablet type PC. Smartphones also include a multifunctional portable telephone terminal.

Note that a client of a video hosting service has a function to code a video imaged with a camera and upload the video to a server, in addition to a function to decode coded data downloaded from a server and to display on a display. Thus, a client of a video hosting service functions as both the transmitting apparatus PROD_A and the receiving apparatus PROD_B.

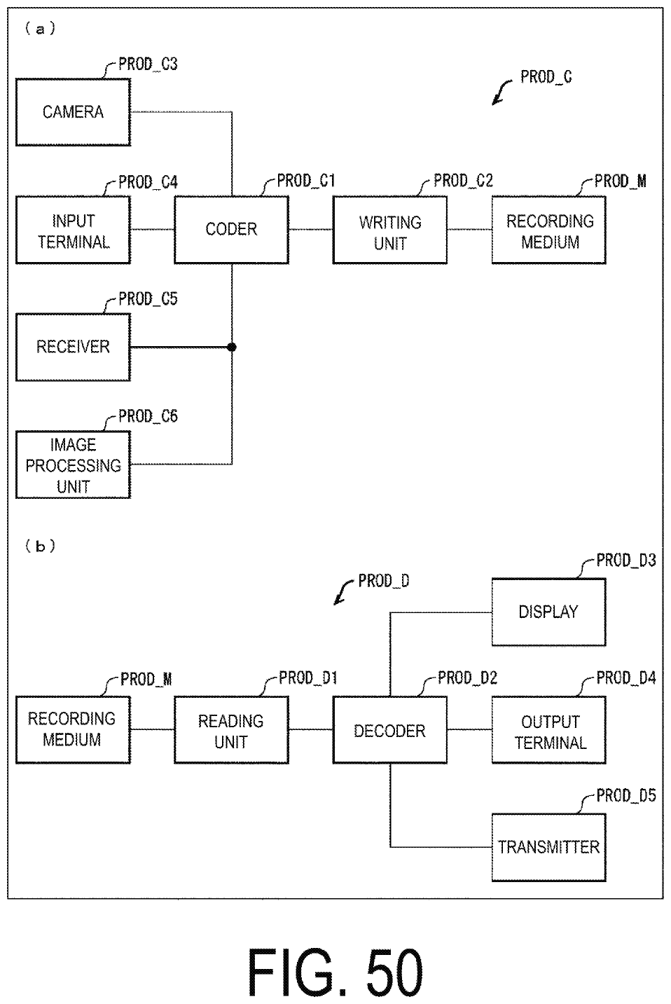

Next, referring to FIG. 50, it will be described that the above-mentioned video coding apparatus 11 and the video decoding apparatus 31 can be utilized for recording and regeneration of videos.

(a) of FIG. 50 is a block diagram illustrating a configuration of a recording apparatus PROD_C installed with the above-mentioned video coding apparatus 11. As illustrated in (a) of FIG. 50, the recording apparatus PROD_C includes a coder PROD_C1 which obtains coded data by coding a video, and a writing unit PROD_C2 which writes the coded data obtained by the coder PROD_C1 in a recording medium PROD_M. The above-mentioned video coding apparatus 11 is utilized as the coder PROD_C1.

Note that the recording medium PROD_M may be (1) a type built in the recording apparatus PROD_C such as Hard Disk Drive (HDD) or Solid State Drive (SSD), may be (2) a type connected to the recording apparatus PROD_C such as an SD memory card or a Universal Serial Bus (USB) flash memory, and may be (3) a type loaded in a drive apparatus (not illustrated) built in the recording apparatus PROD_C such as Digital Versaslice Disc (DVD) or Blu-ray Disc (BD: trade name).

The recording apparatus PROD_C may further include a camera PROD_C3 for imaging a video, an input terminal PROD_C4 to input the video from the outside, a receiver PROD_C5 to receive the video, and an image processing unit PROD_C6 which generates or processes images, as sources of supply of the video input into the coder PROD_C1. In (a) of FIG. 50, although the configuration that the recording apparatus PRODC includes these all is exemplified, a part may be omitted.

Note that the receiver PROD_C5 may receive a video which is not coded, or may receive coded data coded in a coding scheme for transmission different from a coding scheme for recording. In the latter case, a decoder (not illustrated) for transmission to decode coded data coded in a coding scheme for transmission may be interleaved between the receiver PROD_C5 and the coder PROD_C1.

Examples of such recording apparatus PROD_C include a DVD recorder, a BD recorder, a Hard Disk Drive (HDD) recorder, and the like (in this case, the input terminal PROD_C4 or the receiver PROD_C5 is the main source of supply of a video). A camcorder (in this case, the camera PROD_C3 is the main source of supply of a video), a personal computer (in this case, the receiver PROD_C5 or the image processing unit C6 is the main source of supply of a video), a smartphone (in this case, the camera PROD_C3 or the receiver PROD_C5 is the main source of supply of a video), or the like is an example of such recording apparatus PROD_C.

(b) of FIG. 50 is a block illustrating a configuration of a regeneration apparatus PROD_D installed with the above-mentioned video decoding apparatus 31. As illustrated in (b) of FIG. 50, the regeneration apparatus PROD_D includes a reading unit PROD_D1 which reads coded data written in the recording medium PROD_M, and a decoder PROD_D2 which obtains a video by decoding the coded data read by the reading unit PROD_D1. The above-mentioned video decoding apparatus 31 is utilized as the decoder PROD_D2.

Note that the recording medium PROD_M may be (1) a type built in the regeneration apparatus PROD_D such as HDD or SSD, may be (2) a type connected to the regeneration apparatus PROD_D such as an SD memory card or a USB flash memory, and may be (3) a type loaded in a drive apparatus (not illustrated) built in the regeneration apparatus PROD_D such as DVD or BD.

The regeneration apparatus PROD_D may further include a display PROD_D3 for displaying a video, an output terminal PROD_D4 to output the video to the outside, and a transmitter PROD_D5 which transmits the video, as the supply destination of the video output by the decoder PROD_D2. In (b) of FIG. 50, although the configuration that the regeneration apparatus PROD_D includes these all is exemplified, a part may be omitted.

Note that the transmitter PROD_D5 may transmit a video which is not coded, or may transmit coded data coded in a coding scheme for transmission different than a coding scheme for recording. In the latter case, a coder (not illustrated) to code a video in a coding scheme for transmission may be interleaved between the decoder PROD_D2 and the transmitter PROD_D5.

Examples of such regeneration apparatus PROD_D include a DVD player, a BD player, an HDD player, and the like (in this case, the output terminal PROD_D4 to which a television receiver, and the like is connected is the main supply target of the video). A television receiver (in this case, the display PROD_D3 is the main supply target of the video), a digital signage (also referred to as an electronic signboard or an electronic bulletin board, and the like, the display PROD_D3 or the transmitter PROD_D5 is the main supply target of the video), a desktop PC (in this case, the output terminal PROD_D4 or the transmitter PROD_D5 is the main supply target of the video), a laptop type or graphics tablet type PC (in this case, the display PROD_D3 or the transmitter PROD_D5 is the main supply target of the video), a smartphone (in this case, the display PROD_D3 or the transmitter PROD_D5 is the main supply target of the video), or the like is an example of such regeneration apparatus PROD_D.

Realization as Hardware and Realization as Software Each block of the above-mentioned video decoding apparatus 31 and the video coding apparatus 11 may be realized as a hardware by a logical circuit formed on an integrated circuit (IC chip), or may be realized as a software using a Central Processing Unit (CPU).

In the latter case, each apparatus includes a CPU performing a command of a program to implement each function, a Read Only Memory (ROM) stored in the program, a Random Access Memory (RAM) for developing the program, and a storage apparatus (recording medium) such as a memory for storing the program and various data, and the like. The purpose of the embodiments of the present invention can be achieved by supplying, to each of the apparatuses, the recording medium recording readably the program code (execution form program, intermediate code program, source program) of the control program of each of the apparatuses which is a software implementing the above-mentioned functions with a computer, and reading and performing the program code that the computer (or a CPU or a MPU) records in the recording medium.

For example, as the recording medium, a tape such as a magnetic tape or a cassette tape, a disc including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), a card such as an IC card (including a memory card)/an optical card, a semiconductor memory such as a mask ROM/Erasable Programmable Read-Only Memory (EPROM)/Electrically Erasable and Programmable Read-Only Memory (EEPROM: trade name)/a flash ROM, or a Logical circuits such as a Programmable logic device (PLD) or a Field Programmable Gate Array (FPGA) can be used.

Each of the apparatuses is configured connectably with a communication network, and the program code may be supplied through the communication network. This communication network may be able to transmit a program code, and is not specifically limited. For example, the Internet, the intranet, the extranet, Local Area Network (LAN), Integrated Services Digital Network (ISDN), Value-Added Network (VAN), a Community Antenna television/Cable Television (CATV) communication network, Virtual Private Network, telephone network, mobile communication network, satellite communication network, and the like are available. A transmission medium constituting this communication network may also be a medium which can transmit a program code, and is not limited to a particular configuration or a type. For example, a cable communication such as Institute of Electrical and Electronic Engineers (IEEE) 1394, a USB, a power line carrier, a cable TV line, a phone line, an Asymmetric Digital Subscriber Line (ADSL) line, and a radio communication such as infrared ray such as Infrared Data Association (IrDA) or a remote control, BlueTooth (trade name), IEEE 802.11 radio communication, High Data Rate (HDR), Near Field Communication (NFC), Digital Living Network Alliance (DLNA: trade name), a cellular telephone network, a satellite channel, a terrestrial digital broadcast network are available. Note that the embodiments of the present invention can be also realized in the form of computer data signals embedded in a carrier wave where the program code is embodied by electronic transmission.

The embodiments of the present invention are not limited to the above-mentioned embodiments, and various modifications are possible within the scope of the claims. Thus, embodiments obtained by combining technical means modified appropriately within the scope defined by claims are included in the technical scope of the present invention.

### INDUSTRIAL APPLICABILITY

The embodiments of the present invention can be preferably applied to a video decoding apparatus to decode coded data where image data is coded, and a video coding apparatus to generate coded data where image data is coded. The embodiments of the present invention can be preferably applied to a data structure of coded data generated by the video coding apparatus and referred to by the video decoding apparatus.

### REFERENCE SIGNS LIST

41 Video display apparatus
31 Video decoding apparatus
2002 Slice decoder
11 Video coding apparatus
2012 Slice coder

1-8. (canceled)

9. A decoding device for decoding a picture including a rectangular region, the decoding device comprising:
a prediction parameter decoding circuitry that decodes a flag in a sequence parameter set, wherein the flag specifies whether rectangular region information is present in the sequence parameter set; and
a motion compensation circuitry that derives padding locations,
wherein
the prediction parameter decoding circuitry decodes the rectangular region information, if a value of the flag is equal to one, and
the padding locations is derived by using top left coordinates and a width and a height of the rectangular region, if the value of the flag is equal to one.

10. The decoding device of claim 1, wherein the rectangular region information includes (i) a first syntax element specifying a number of rectangular region and (ii) a second syntax element specifying a size of the rectangular region.

11. A method for decoding a picture including a rectangular region, the method including:
decoding a flag in a sequence parameter set, wherein the flag specifies whether rectangular region information is present in the sequence parameter set;
decoding the rectangular region information, if a value of the flag is equal to one; and
deriving padding locations by using top left coordinates and a width and a height of the rectangular region, if the value of the flag is equal to one.

12. A coding device for coding a picture including a rectangular region, the coding device comprising:
a prediction parameter coding circuitry that codes a flag in a sequence parameter set, wherein the flag specifies whether rectangular region information is present in the sequence parameter set; and
a motion compensation circuitry that derives padding locations,
wherein
the prediction parameter coding circuitry codes the rectangular region information, if a value of the flag is equal to one, and
the padding locations is derived by using top left coordinates and a width and a height of the rectangular region, if the value of the flag is equal to one.
